(19) United States
(12) Patent Application Publication
(10) Pub. No.: US 2021/0198162 A1
(43) Pub. Date: Jul. 1, 2021

(54) OZONIZED BIOCHAR: PHOSPHORUS SUSTAINABILITY AND SAND SOILIZATION

(71) Applicant: James Weifu Lee, Chesapeake, VA (US)

(72) Inventor: James Weifu Lee, Chesapeake, VA (US)

(21) Appl. No.: 17/058,131

(22) PCT Filed: Jun. 21, 2019
(86) PCT No.: PCT/US2019/038491

§ 371 Date: Nov. 23, 2020

Related U.S. Application Data
(63) Continuation-in-part of application No. 16/104,892, filed on Aug. 18, 2018.
(60) Provisional application No. 62/689,223, filed on Jun. 24, 2018.

(51) Int. Cl. C05G 3/40; C05B 17/00; B01J 19/10; C09C 1/44; C05G 3/80

(52) U.S. Cl. CPC C05G 3/44; C05B 17/00; B01J 19/10; B01J 2219/0879; C05G 3/80; B01J 2219/00063; C09C 1/44

(57) ABSTRACT

The present invention discloses a systematic method for phosphorus sustainability, sand soilization and odor removal utilizing the phosphorus-unlocking and odor removing green chemistry of a surface-oxygenated biochar composition made through ozonization in combination with sonication. Surface-oxygenated biochar compositions and sonication-ozonization methods create advanced hydrophilic biochar materials having higher cation exchange capacity, optimized pH, improved wettability, and toxin free components. These sonicated and ozonized biochar compositions are used as filtration materials for clean water and air, as phosphorus solubilizing reagents to mix with phosphate rock materials to make a slow-releasing phosphate fertilizer, as biochar soil additives to help solubilize phosphorus and reduce phosphorus fertilizer additions required to achieve desired soil phosphorus activity, crop uptake, and yield goals, as sand soilization reagents by utilizing their liquid gel-forming activity in the spaces among sand particles to retain water and nutrients and hold the sand particles together, as plant growth stimulants by using the humic acids-like surface-oxygenated biochar substances at a proper ppm concentration and as carbon sequestration agents to help control climate change for energy and environmental sustainability on Earth.

### CROSS-REFERENCE TO RELATED APPLICATIONS

This application is the National Stage of International Application No. PCT/US2019/038491 filed on Jun. 21, 2019, which claims priority and benefit from U.S. patent application Ser. No. 16/104,892 filed on Aug. 18, 2018, which is a Continuation-In-Part of co-pending U.S. patent application Ser. No. 15/228,611 that claims priority and benefit from U.S. Provisional Application No. 62/201,870 filed on Aug. 6, 2015, which is incorporated herein by reference in its entirety. This application is also a Continuation-In-Part of co-pending U.S. patent application Ser. No. 16/104,892 filed on Aug. 18, 2018. The international Application No. PCT/US2019/038491 also claims the priority and benefit from U.S. Provisional Application No. 62/689,223 filed on Jun. 24, 2018.

### FIELD OF THE INVENTION

The present invention is directed to phosphorus sustainability, sand soilization and odor removal utilizing sonicated and ozonized biochar compositions and methods for creating surface-oxygenated biochar materials with higher cation exchange capacity that are also free of potential toxic components for use as phosphorus solubilization reagents, filtration materials, soil amendments and carbon sequestration agents to help control climate change for energy and environmental sustainability on Earth.

### BACKGROUND

Smokeless biomass pyrolysis with utilization of biochar as a soil amendment is a potentially significant approach for renewable energy production and for carbon sequestration at giga tons of carbon (GtC) scales. A central idea is that biochar, if produced cleanly and sustainably by pyrolysis of biomass wastes and used as a soil amendment, would “lock up” biomass carbon in a form that can persist in soils for hundreds to thousands of years, help to retain nutrients in soils and reduce the runoff of agricultural chemicals.

The capacity of carbon sequestration by application of biochar fertilizer in soils can be used in croplands, grasslands and a fraction of forest lands. The maximum capacity of carbon sequestration through biochar soil amendment in croplands alone is estimated to be about 428 GtC globally. This maximum capacity is estimated using the maximal amount of biochar carbon that could be cumulatively placed into soil while still beneficial to soil environment and plant growth and the arable land area suitable for biochar agricultural use.

Globally each year about 6.6 gigatons (Gt) of dry matter waste biomass (e.g., crop stovers, dead leaves, waste woods, and rice straws) are produced. Deployment of an advanced biomass pyrolysis technology can turn waste biomass into valuable biochar, bio-syngas, and biofuel products. Worldwide, this approach can produce a net reduction of greenhouse-gas emissions of about 1.8 Gt of CO₂—C equivalent emissions per year, which is about 12% of the current global anthropogenic emissions. Advanced biomass pyrolysis coupled with biochar soil amendment is unique among carbon sequestration strategies in that it can simultaneously offset gigatons of CO₂ emissions and build sustainability into agricultural systems. This is a unique “carbon-negative” bioenergy system approach, which on a life-cycle basis could not only reduce but also reverse human effects on climate change.

More scientific and technological development is needed before this approach can be considered for widespread commercial implementation. For example, a new generation of high-tech biochar materials with higher cation change capacity to retain soil nutrients is needed to serve as an effective soil amendment and carbon sequestration agent. Furthermore, biochar occasionally shows inhibitory effects on plant growth (Rondon et al., Biol. Fertil. Soils 43:699-708 (2007); Rillig et al., Applied Soil Ecology 45:238-242 (2010); Gundale, Thomas, DeLuca, Biol. Fertil. Soils 43:303-311(2007)).

Organic species including possible inhibitory and benign (or stimulatory) chemicals are produced as part of the biomass pyrolysis process. A number of organic compounds belonging to various chemical classes, including n-alkanoic acids, hydroxyl and acetoxy acids, benzoic acids, diols, triols, and phenols were recently identified in organic solvent extracts of biochar. Some of these biochar chemicals, including polycyclic aromatic hydrocarbons (PAHs), are potentially phytotoxic or biocidal, especially at high concentrations. More recently, using the techniques of electrospray ionization (ESI) coupled to Fourier transform ion cyclotron resonance mass spectrometry (FT-ICR-MS) with Kendrick mass defect analysis, it was determined that the most likely biochar toxin species contain carboxyl and hydroxyl homologous series and that the phytotoxicity of biochar substances is most likely due to degraded lignin-like species rich in oxygen containing functionalities, which is also part of the PAHs type of organic molecules (Smith et al., Environ. Sci. Technol. 47:13294-13302 (2013)). In addition, certain PAHs are suspected carcinogens. If biochar were to be globally used as a soil amendment and carbon sequestration agent at GtC scales, the release of potentially toxic compounds into soil and associated hydrologic systems might have unpredictable negative consequences in the environment. Therefore, it is essential to address some of these undesirable effects in order for biochar to be used as a soil amendment and carbon sequestration agent at gigaton scales. Any new technology that could produce an advanced biochar product that has high cation exchange capacity without any undesirable side effects is highly desirable for using biochar soil carbon sequestration to control climate change towards sustainability on Earth.

Recently, phosphorus sustainability was identified as a major issue for long-term agricultural and environmental sustainability on Earth. Currently, wet and thermal routes are the main methods used to manufacture phosphate fertilizers (Silva, Kulay (2003) Int J Life Cycle Ass 8 (4):209-214). The wet route typically requires the use of strong industrial acids such as sulfuric acid, nitric acid, and/or hydrochloric acid to solubilize phosphate from phosphate rock materials (Jiang et al (1990) Fert Res 26 (1-3):11-20; Fayiga, Nwoke (2016) Environ Rev 24 (4):403-415; Khan et al (2013) J Chem Soc Pakistan 35 (1):144-146; Skut et al (2010) Przem Chem 89 (4):534-539). The thermal route is represented by thermophosphate (Fageria, Santos (2008) Commun Soil Sci Plan 39 (5-6):873-889). Both routes are quite energy intensive and are viewed as not very environmentally friendly (Rutherford et al (1994) Sci Total Environ 149 (1-2):1-38; Potiriadis et al (2011) Radiat Prot Dosim 144 (1-4):668-671; Wu et al (2016) J Clean Prod 139:1298-1307; Silva, Kulay (2005). J Clean Prod 13:1321-1325). Therefore, environmentally friendly technologies that could solubilize phosphorus from insoluble phosphate materials such as hydroxyapatite without requiring the use of strong industrial acids such as hydrochloric acid would be valuable to addressing the phosphorus sustainability issue for long-term agricultural and environmental sustainability. An environmentally friendly technology that is biochar-based and can provide other beneficial applications such as “sand soilization” would be highly valuable to sustainable development on Earth.

### SUMMARY OF THE INVENTION

The present invention discloses a systematic method for phosphorus sustainability, sand soilization and odor removal utilizing the phosphorus-unlocking and odor removing green chemistry of a surface-oxygenated biochar composition made through ozonization in combination with sonication that is the method comprising: treating a biochar source composition with sonication and an ozone-containing gas stream in a biochar sonication-ozonization treatment reactor system using a sonication-ozonization-enabled biochar-surface oxygenation operational process, wherein treating the source biochar composition comprises: a) contacting the source biochar with the ozone-containing gas stream; b) enabling biochar-surface oxygenation; c) destroying a potential biochar toxin; d) producing a surface-oxygenated biochar composition having enhanced cation exchange capacity; e) producing a special surface-oxygenated biochar composition for phosphorus solubilization from insoluble phosphate materials for producing phosphate fertilizers without using strong industrial acids; f) producing a special surface-oxygenated biochar paste composition for sands soilization; and g) producing a special surface-oxygenated biochar composition having an enhanced filtration property as exemplified in methylene blue adsorption capability for removing at least one contaminant from a medium selected from the group consisting of water and air including odor removal.

Exemplary embodiments are directed to improved methods employing the techniques of sonication and ozonization for producing surface-oxygenated biochar compositions. These sonicated and/or ozonized biochar compositions including surface-oxygenated biochar paste products are used for a number of innovative applications including: 1) as filtration materials for clean water and air including odor removal; 2) as phosphorus solubilizing reagents to mix with phosphate rock materials such as hydroxyapatite or fluorapatite to make a slow-releasing phosphate fertilizer; 3) as biochar soil additives to help solubilize phosphorus from the insoluble phosphate materials found in certain soils, reducing phosphorus fertilizer additions required to achieve desired soil phosphorus activity, crop uptake, and yield goals; 4) as sand soilization reagents by utilizing their liquid gel-forming activity in the spaces among sand particles to better retain water and nutrients and hold the sand particles together; 5) as plant growth stimulants by using the surface-oxygenated biochar humic acids-like substances at proper concentrations; and 6) as carbon sequestration agents to help control climate change for energy and environmental sustainability on Earth.

According to exemplary embodiments, an ozonization-based method is employed as a post-production biochar-surface oxygenation process to improve biochar properties. The ozonization-enabled biochar surface oxygenation process creates a new generation of advanced hydrophilic and clean biochar materials with higher cation exchange capacity, optimized pH and optimized hydrophilicity, and that are free of undesirable potential toxic components, which represents a significant technological improvement. Exemplary embodiments use a single ozonization-enabled biochar surface oxygenation process to achieve at least one of four improvements in the resulting biochar, i.e., enhanced biochar cation exchange capacity, reduced alkaline biochar pH, improved biochar wettability and destruction of potential biochar toxins. Exemplary embodiments can be practiced in a distributed manner at certain biochar-production facilities, biochar-utilizing farm sites, and other industrial sites to convert tons of conventional biochar materials into surface-oxygenated biochar products for use as soil amendment and other industrial applications.

According to exemplary embodiments, a method for production of an ozonized biochar composition includes reacting a biochar source with an ozone-containing gas stream in a biochar ozonization treatment reactor system using an ozonization-enabled biochar-surface oxygenation operational process. The biochar source is contacted with ozone to (a) enable biochar-surface oxygenation; (b) destruct potential biochar toxins; and (c) produce an ozonized biochar composition having optimal characteristics or an optimal group of characteristics. These characteristics are selected from the group consisting of enhanced cation exchange capacity (CEC), optimal pH value, optimal carboxyl content, optimal hydrophilicity and wettability, optimal water-holding field capacity, optimal oxygen-to-carbon molar ratio, surface area, composition, nutrient contents, biochar particle size, uniformity, and any combination thereof.

Exemplary embodiments are also directed to a method for producing an ozonized biochar material having a super high cation-exchanging property with CEC value over 50 cmol/kg, 100 cmol/kg, 150 cmol/kg and as high as about 200 cmol/kg. The cation-exchanging ability of a biochar is predominantly dependent on the density of cation-exchanging groups, mainly carboxyl (—COOH) groups on biochar surface.

In one embodiment, a biochar source is reacted with an injected ozone (O₃)-containing stream in a controlled manner such that the biochar source homogeneously acquires carboxy-containing cation-exchanging groups in a post-production biochar-surface oxygenation process that creates carboxyl groups on biochar surfaces even at ambient pressure and temperature. This controlled ozone treatment creates additional oxygen-containing functional groups including, but not limited to, carbonyl (biochar C═O), hydroxyl (—OH) and carboxyl (—COOH) groups, improves biochar surface hydrophilicity and CEC and simultaneously destructs potential toxins.

Exemplary embodiments are also directed to a biochar ozonization treatment reactor system having an air inlet pump or valve, an ozone generator system, an ozone air inlet or tube passing through the biochar ozonization reactor wall near its bottom, an ozone air space at the bottom of the reactor, a porous metal plate, a biochar ozonization reactor chamber space above the porous metal plate, a biochar inlet passing through the biochar ozonization reactor wall at the upper part of the reactor, an ozonized biochar outlet passing through the reactor wall at the lower part of the reactor, a tail gas vent valve and filter at the top of the reactor, a flexible tail gas recycling tube equipped with its filter and valve and pump and valve connecting from the tail gas vent tube to the air inlet, a heat-smoke-sensing sprinkler system passing through the biochar ozonization reactor wall at the upper part of the reactor, and a flexible inlet and outlet valve at the bottom of the reactor.

In one embodiment, the biochar ozonization treatment reactor system comprises an O₂/CO₂ air inlet pump or valve, an ozone generator system, an ozone air inlet or tube passing through the biochar ozonization reactor wall near its bottom, an ozone O₃/CO₂ air space at the bottom of the reactor, a W-conical-shaped porous metal plate, a biochar ozonization reactor chamber space above the porous metal plate, a biochar inlet passing through the biochar ozonization reactor wall at the upper part of the reactor, an O₃/CO₂ gas flowing from O₃/CO₂ air space at the bottom through the W-conical-shaped porous metal plate and the biochar materials toward the upper part of the reactor, an ozonized biochar outlet passing through the reactor wall at the lower part of the reactor, tail gas vent valve and filter at the top of the reactor, a flexible tail gas recycling tube equipped with its filter and valve and pump and valve connecting from the tail gas vent tube to the air inlet, a heat-smoke-sensing sprinkler system equipped with water inlet and water spray system at the upper part of the reactor, an optional water level and flexible water inlet and outlet valve at the bottom of the reactor, a recycling water pump with a flexible water recycling tube connected with the flexible water inlet and outlet at the reactor bottom and the water inlet at the heat-smoke-sensing sprinkler system.

Exemplary embodiments are directed to a double-wall coolant-jacketed ozone gas biochar reactor system having a heat-conducting reactor inner wall, a reactor outer wall, a coolant chamber space formed between the inner wall and outer wall, a coolant inlet connected with the coolant chamber space at the bottom part of the reactor, a hot coolant outlet connected with the coolant chamber space at the top part of the reactor, an O₂/CO₂ air inlet pump and valve, an ozone generator system, an ozone air inlet or tube passing through the biochar ozonization reactor wall near its bottom, an ozone O₃/CO₂ air space at the bottom of the reactor, an inverted-V conical-shaped porous metal plate, a biochar ozonization reactor chamber space above the porous metal plate, a hot biochar inlet passing through the biochar ozonization reactor wall at the upper part of the reactor, an O₃/CO₂ gas flowing from O₃/CO₂ air space at the bottom through the conical-shaped porous metal plate and the biochar materials toward the upper part of the reactor, an ozonized biochar outlet passing through the reactor wall at the lower part of the reactor, a tail gas vent valve and filter at the top of the reactor, a flexible tail gas recycling tube equipped with its filter and valve, and pump and valve connected from the tail gas vent tube to the air inlet, a heat-smoke-sensing sprinkler system equipped with water inlet and water spray system at the upper part of the reactor, an optional water level and flexible water inlet and outlet valve at the bottom of the reactor.

In one embodiment, the biochar ozonization treatment reactor system is constructed from special ozone-compatible materials selected from the group consisting of stainless steel, titanium, silicone, glass, polytetrafluoroethylene (PTFE), a perfluoroelastomer polymer, polyether ether ketone (PEEK), polychlorotrifluoroethylene (PCTFE), chlorinated polyvinyl chloride (CPVC), a silicon cast iron, chromium and molybdenum alloy, filled PTFE gasket material, a nickel, molybdenum, chromium and iron alloy, polycarbonate, polyurethane, polyvinylidene difluoride (PVDF), butyl, a heat- and chemical-resistant ethylene acrylic elastomer, a synthetic rubber and fluoropolymer elastomer, ethylene-propylene, a thermoplastic vulcanizate (TPV), flexible polyethylene tubing, commercially available as Flexelene from Eldon James Corporation of Denver, Colo., fluorosilicone, aluminum, copper, and combinations thereof.

Exemplary embodiments are directed to an ozone-enabled biochar-surface oxygenation operational process that is a wet-moisture biochar ozonization treatment operational process that includes the following process steps that may be operated in combination with the use of hydrogen peroxide: a) Loading biochar materials into the reactor through the biochar inlet; b) Monitoring and adjusting (as necessary) biochar temperature; c) Monitoring biochar water content and relative humidity in the reactor, d) Based on the required biochar water content and relative humidity, properly adding water into biochar materials by use of a heat-smoke-sensing sprinkler system with water inlet and water spray system at the upper part of the reactor, and/or introducing at least one of water, steam and water vapor by use of a flexible water inlet and outlet valve and optional water level for vapor and moisture generation at the bottom of the reactor; e) Pumping an oxygen-containing source gas stream such as ambient air oxygen through the ozone generator system to generate ozone; f) Feeding ozone-containing gas stream into the reactor chamber space through the porous metal plate above the ozone air space by controlling the air pump fan speed; g) As necessary, using the flexible inlet and outlet valve at the bottom of the reactor to introduce additional stream or vapor or other gas component(s) of choice into the treating gas stream to manipulate the biochar ozonization process; h) As necessary, using the flexible tail gas recycling tube with its filter and valve and pump and valve to re-use part and/or all of the tail gas for the process; i) Allowing sufficient time for the ozone-containing stream to flow/diffuse through and interact with biochar particles while controlling and monitoring the treatment conditions such as reactor temperature and gas-stream flow rate; j) As necessary, discharging the residual ozonized liquid at the bottom of the reactor through a flexible water inlet and outlet or recycling the residual ozonized liquid stream through a recycling water pump with a flexible water recycling tube connected with the flexible water inlet and outlet and the water inlet to re-use the liquid for the biochar ozonization process; k) Harvesting the ozonized biochar products through the ozonized biochar outlet by use of gravity (with minimal energy cost); and k) repeating steps a) through j) for a plurality of operational cycles to achieve more desirable results.

In one embodiment, the biochar-surface oxygenation and destruction of toxins are accomplished simultaneously by use of an O₃-containing gas stream flowing through the biochar ozonization treatment reactor at ambient pressure and temperature with minimal cost.

In another embodiment, the optimized biochar pH value is accomplished through the formation of acidic carboxyl groups at biochar surfaces and by the formation and adsorption of nitrogen oxides/nitric acid during a biochar ozonization process in the presence of N₂.

According to yet another embodiment, the ozonized biochar composition has a cation exchange capacity of at least about 200% of that of the untreated biochar and is free of biochar toxins; and the surface-oxygenated biochar compositions can absorb the offensive odor from manures significantly better than conventional biochar, using a green chemistry where surface-oxygenated biochar absorbs the ammonia (NH₃) gas odor through its reaction with the biochar molecular carboxylic acid (Biochar-COOH) to form ammonium carboxylate on ozonized biochar surface (Biochar-COONH₄).

Exemplary embodiments are directed to ozonized biochar compositions having a given, exceptional, or optimal set of characteristics, such as enhanced cation exchange capacity, optimal pH value, optimal carboxyl content, optimal hydrophilicity and wettability, optimal water-holding field capacity, optimal oxygen-to-carbon molar ratio, surface area, composition, nutrient contents, biochar particle size, zero toxin content, and/or uniformity in any of these or other characteristics. Exemplary embodiments of methods disclosed herein are suitable for producing these types of advanced hydrophilic biochar products with higher cation exchange capacity and free of potential toxic components, which can be used in many practical applications such as the use of the ozonized biochars as filtration materials and as a biochar soil amendment and carbon sequestration agent.

According to one of the exemplary embodiments, a method for industrial production of surface-oxygenated biochar composition through ozonization in combination with sonication is the method that comprises treating a biochar source with sonication and an ozone-containing gas stream in a biochar sonication-ozonization treatment reactor system using a sonication-ozonization-enabled biochar-surface oxygenation operational process; wherein the treating of the biochar source comprises: a) contacting the biochar source with the ozone-containing gas stream; b) enabling biochar-surface oxygenation; c) destroying a potential biochar toxin; d) producing a surface-oxygenated biochar composition having enhanced cation exchange capacity; e) producing a special surface-oxygenated biochar composition for solubilizing phosphorus from insoluble phosphate materials for producing phosphate fertilizers without using strong industrial acids; f) producing a special surface-oxygenated biochar paste composition for sand soilization; and g) producing a special surface-oxygenated biochar composition having an enhanced filtration property as exemplified in methylene blue adsorption capability for removing at least one contaminant from a medium selected from the group consisting of water and air.

According to one of the exemplary embodiments, the biochar sonication-ozonization treatment reactor system is a sonication-enhanced biochar ozonization treatment reactor system comprising: a sonication control unit which comprises an input end in contact with ultrasonic transducer and a sonication output head in contact with liquid in a biochar ozonization reactor chamber space, a heat-conducting reactor inner wall, a reactor outer wall, a coolant chamber space formed between the inner wall and outer wall, a coolant inlet connected with the coolant chamber space at the bottom part of the reactor, a hot coolant outlet connected with the coolant chamber space at the top part of the reactor, an O₂ air inlet pump and valve, an ozone generator system, an ozone air inlet and tube passing through the biochar ozonization reactor out wall and inner wall near its bottom, an ozone O₃/water space at the bottom of the reactor, a porous metal plate, a biochar sonication-ozonization reactor chamber space above the porous metal plate, a biochar inlet passing through the biochar ozonization reactor double walls at the upper part of the reactor, an O₃ bubble flowing from the O₃/water space at the bottom through the porous metal plate and the biochar materials toward the upper part of the reactor, a tail gas vent valve and filter, a flexible tail gas recycling tube equipped with its filter and valve, a pump and valve connected from the tail gas vent tube to the air inlet, a heat-smoke-sensing sprinkler system equipped with water inlet, a water liquid level at the upper part of the reactor, an ozonized biochar outlet passing through the reactor double walls at the lower part of the reactor, and a flexible water inlet and outlet valve at the bottom of the reactor.

According to one of the exemplary embodiments, the sonication-ozonization-enabled biochar-surface oxygenation operational process comprises a liquid biochar sonication-ozonization treatment operational process that comprises the following process steps that may be operated in combination with the use of hydrogen peroxide: a) loading biochar materials into a reactor through a biochar inlet; b) monitoring and adjusting biochar temperature; c) monitoring biochar water content and liquid level in the reactor; d) based on a required biochar water content and liquid level, adding at least one of water, steam and vapor into the biochar materials using at least one of a heat-smoke-sensing sprinkler system with a water inlet and water spray system located at a top of the reactor and a flexible water inlet and outlet valve at a bottom of the reactor; e) performing sonication using the sonication control unit which comprises an input end in contact with ultrasonic transducer and a sonication output head in contact with liquid in a biochar ozonization reactor chamber space; f) pumping an oxygen-containing source gas stream through an ozone generator system to generate ozone; g) feeding ozone-containing gas stream into a reactor chamber space through a porous metal plate above an ozone air space by controlling an air pump fan speed; h) using a flexible inlet and outlet valve at the bottom of the reactor to introduce additional gas components into the treating gas stream to manipulate the biochar ozonization process; i) using a flexible tail gas recycling tube having a filter and valve and pump and valve to re-use at least part of tail gas; j) allowing sufficient time for the ozone-containing stream to diffuse through and interact with biochar particles while controlling and monitoring treatment conditions; k) discharging residual ozonized liquid at the bottom of the reactor through a flexible water inlet and outlet; and 1) harvesting the ozonized biochar products through an ozonized biochar outlet using gravity.

According to one of the exemplary embodiments, the sonication enhances biochar ozonization process through at least one of the following mechanisms: 1) Sonication force may physically loose up and/or break up biochar materials such as exfoliating graphite-type biochar materials (including graphite and/or graphite oxides) to produce graphene-type of biochar molecules such as fragmented graphene and graphene oxides; 2) Sonication process enhances mixing and mass transfer of ozone gas with liquid water and biochar particles; and 3) Ultra sonication at a frequency of above 15 kHz producing reactive oxygen radical, hydroxyl and peroxyl radicals from the sonochemistry of O₂-dissolved water that may also enhance biochar surface oxygenation.

According to one of the exemplary embodiments, the surface-oxygenated biochar composition is a biochar paste product that comprises humic-substances-like surface-oxygenated biochar materials that are selected from the group consisting of surface-oxygenated biochar particles, surface-oxygenated biochar-derived organic matters, surface-oxygenated amorphous carbon particles, surface-oxygenated graphite particles, partially oxygenated graphene, partially oxygenated graphene-like molecules, partially oxygenated graphene molecular fragments, partially oxygenated linear hydrocarbons, partially oxygenated aromatic compounds, partially oxygenated polycyclic aromatic hydrocarbons, dissolved organic carbons including organic acids, and combinations thereof.

According to one of the exemplary embodiments, the surface-oxygenated biochar composition may be used to solubilize phosphorous from insoluble phosphate materials such as hydroxyapatite or fluorapatite for phosphorous sustainability by at least one of the following “green chemistry” molecular mechanisms: a) The effect of protons from the organic acid groups of ozonized biochar which can kick phosphate out of the insoluble phosphate materials, resulting in solubilized phosphate; b) The effect of calcium complexation with the deprotonated biochar carboxylate groups that takes calcium away and thus thermodynamically favors the release of phosphate from the insoluble calcium phosphate materials; c) the anion exchange of the deprotonated biochar dissolved organic carboxylate groups (organic anions) with the phosphate in the insoluble phosphate materials favors the release of phosphate from the insoluble phosphate materials; and d) combinations thereof.

According to one of the various embodiments, the surface-oxygenated biochar composition may help to enhance phosphorus availability for plant uptake by helping phosphorus solubilization from insoluble soil phosphate mineral phases comprising at least one of the “insoluble” phosphate materials selected from the group consisting of soil phosphate rock particles and mineral minerals (mostly apatites: Ca₁₀X(PO₄)₆, where X=F⁻, Cl⁻, OH⁻ or CO₃²⁻) from parent rocks; the various precipitated Ca-phosphates including Ca(H₂PO₄)₂.H₂O (monocalcium phosphate), CaHPO₄.2H₂O (dicalcium phosphate dihydrate=brushite), CaHPO₄ (dicalcium phosphate=monetite), Ca₈H₂(PO₄)₆.5H₂O (octacalcium phosphate), Ca₅(PO₄)₃OH (hydroxyapatite), and Ca₅(PO₄)₃F (fluoroapatite); precipitated Al- and Fe-phosphates including variscite (AlPO₄.2H₂O), strengite (FePO₄.2H₂O), and vivianite [(Fe₃(PO₄)₂.8H₂O)]; and combinations thereof.

According to one of the exemplary embodiments, wherein the surface-oxygenated biochar compositions including the biochar paste product may be used for sands soilization by their liquid gel-forming activity in the spaces among sand particles that can retain water and nutrients and hold the sand particles together through at least one of the following noncovalent interactions: 1) the ionic (Coulombic) interactions that are the electrostatic interactions between charged species; 2) the hydrogen bond effects of the surface-oxygenated biochar molecular species with water and sands; 3) the π-π interactions between aromatic structures; and 4) the van der Waals interactions among sands and surface-oxygenated biochar molecular species with water.

According to one of the exemplary embodiments, the surface-oxygenated biochar compositions contain certain amounts of beneficial humic acids-like substances including certain partially oxygenated dissolved organic carbons (DOC) that can stimulate green plant growth when used at a proper DOC concentration selected from the group consisting of: 0.1 ppm, 0.2 ppm, 0.5 ppm, 1 ppm, 2 ppm, 3 ppm, 5 ppm, 8 ppm 10 ppm, 12 ppm, 15 ppm, 20 ppm, 25 ppm, 30 ppm, 40 ppm, 50 ppm, 100 ppm, 200 ppm, 500 ppm, 1000 ppm or a concentration within a particular range bounded by any two of the foregoing values.

Advantages of the materials, methods, and devices described herein are set forth herein and may be learned by practice of the aspects described below. Both the foregoing general description and the following detailed description are exemplary and explanatory only and are not restrictive.

### BRIEF DESCRIPTION OF FIGURES

FIG. 1 illustrates, from left to right, 10 g biochar from pyrolysis of cornstover, 10 g soil, and 10 g mixture of biochar (10% W) and soil (90% W). The soil sample is a surface soil from 0-15 cm deep at the University of Tennessee's Research and Education Center, Milan, Tenn., USA (358560N latitude, 888430W longitude), which is also known as the Carbon Sequestration in Terrestrial Ecosystems site (CSiTE) supported by the U.S. Department of Energy.

FIG. 2 is a process schematic for post-production biochar ozonization to create oxygen-containing functional groups on biochar surfaces.

FIG. 3 is a schematic representation of an embodiment of the biochar ozonization treatment reactor system with a flat porous metal plate using an air ozone generator system, a biochar inlet and a heat-smoke-sensing sprinkler system at the upper part of the reactor, flexible tail gas circulating loop, and a biochar outlet at the bottom part of the reactor for harvesting ozonized biochar by use of gravity.

FIG. 4 is a schematic representation of an embodiment of the biochar ozonization treatment reactor system with a conical shaped porous metal plate using an O₂/CO₂ air inlet, a flexible tail gas circulating loop, a biochar inlet and a heat-smoke-sensing sprinkler system with water spray at the upper part of the reactor, a flexible water inlet and outlet at the bottom of the reactor, and an biochar outlet at the bottom part of the reactor for harvesting ozonized biochar by use of gravity.

FIG. 5 is a schematic representation of an embodiment of the biochar ozonization treatment reactor system with a W-conical shaped porous metal plate using an O₂/CO₂ air inlet, a flexible tail gas circulating loop, a recycling water pump connected from a flexible water inlet and outlet at the bottom of the reactor to a heat-smoke-sensing sprinkler system with water spray at the upper part of the reactor, and an biochar outlet at the bottom part of the reactor for harvesting ozonized biochar by use of gravity.

FIG. 6 is a schematic representation of an embodiment of the biochar ozonization treatment reactor system with a V-conical shaped porous metal plate using an air inlet, an ozone generator, a flexible tail gas circulating loop, a flexible inlet and outlet at the bottom of the reactor, a heat-smoke-sensing sprinkler system and a biochar inlet at the upper part of the reactor, and an biochar outlet at the bottom part of the reactor for harvesting ozonized biochar by use of gravity.

FIG. 7 is a schematic representation of an embodiment of the double-wall-coolant-jacketed biochar ozonization treatment reactor system with coolant inlet and hot coolant outlet, using an inverted-V-conical shaped porous metal plate, an O₂/CO₂ air inlet, an ozone generator, a flexible tail gas circulating loop, a flexible water inlet and outlet at the bottom of the reactor, a heat-smoke-sensing sprinkler system and a hot biochar inlet at the upper part of the reactor, and an biochar outlet at the bottom part of the reactor for harvesting ozonized biochar by use of gravity.

FIG. 8 is a schematic representation of an embodiment of the double-wall-coolant-jacketed biochar liquid-ozonization treatment reactor system with coolant inlet and hot coolant outlet, using a flat porous metal plate, a water liquid fully immersing biochar material at the upper part of the reactor, an O₂ air inlet, an ozone generator, a flexible tail gas circulating loop, a O₃/water space and a flexible water inlet and outlet at the bottom of the reactor, a heat-smoke-sensing sprinkler system and a hot biochar inlet at the upper part of the reactor, and an biochar outlet at the bottom part of the reactor for harvesting ozonized biochar by use of gravity.

FIG. 9 is a graph illustrating Fourier Transformed Infrared-Attenuated Total Reflectance (FTIR-ATR) spectra of biochar samples treated with ozone for 30 min, 60 min and 90 min in comparison with that of untreated biochar.

FIG. 10 is a graph illustrating Raman spectra of biochar samples treated with ozone for 60 min in comparison with that of untreated biochar.

FIG. 11 is a schematic representation of an embodiment of the sonication-enhanced biochar ozonization treatment reactor system comprises a sonication control unit that comprises an input end in contact with ultrasonic transducer, and a sonication output head in contact with liquid in a biochar sonication-ozonization reactor chamber space.

FIG. 12 is a photograph showing an example of the black viscos biochar paste product in a white jar, which was produced from the biochar liquid sonication-ozonization process.

FIG. 13a presents the ion chromatography showing the phosphate peak from the mixture of wet-ozonized biochar and non-ozonized biochar, their respective filtrate and the hydroxyapatite. The phosphate peak appeared at 15.6-16.0 min. The height of the phosphate peak from the mixture with the ozonized biochar was significantly higher compared to that with the non-ozonized biochar. The data represented here were from the sample collected after 30 minutes of incubation time.

FIG. 13b shows an example of solubilized phosphorus (P) concentrations measured in the liquid phase after 30 minutes, 2 days, and 2 weeks of hydroxyapatite water incubation with non-ozonized biochar, wet-ozonized biochar, dry-ozonized biochar, and without any biochar (hydroxyapatite with Milli-Q water only).

FIG. 14a presents the Ion Chromatograms of B-Soil phosphorus solubilization assay showing the phosphate peak from a 14-day incubation treatment of wet-ozonized Biochar+B-Soil+Water (solid line) in comparison with control-1 (dashed line): Biochar+B-Soil+Water; and control-2 (dotted line): B-Soil+Water.

FIG. 14b presents the Ion Chromatograms of P-Soil phosphorus solubilization assay showing the phosphate peak from a 14-day incubation treatment of wet-ozonized Biochar+P-Soil+Water (solid line) in comparison with control-1 (dashed line): Biochar+P-Soil+Water; and control-2 (dotted line): P-Soil+Water.

FIG. 15 presents a photograph showing flocculation of liquid filtrate DOC from the wet-ozonized P400 90W biochar by adding 2.5 mM CaCl₂;

FIG. 16a shows 10 g of sands mixed with 4 ml of water solution containing wet-ozonized biochar dissolved organic carbon (DOC, 940 ppm) compounds and 25 mM CaCl₂ in a plate after 5 hours leaving on laboratory bench with room air stays together when the plate was inclined.

FIG. 16b shows 10 g of sands mixed with 4 ml of water in a plate after 5 hours leaving on laboratory bench with room air falls apart when the plate was inclined.

FIG. 17a presents an example of the liquid filtrates collected from the un-hydrolyzed corn stover residue. On the left (darker brown) is 50 mL filtrate resulted from washing 3 g of non-ozonized un-hydrolyzed corn stover residue. Its DOC concentration was measured to be 2440 ppm; On the right (yellow) is 50 mL filtrate collected from the wet-ozone treatment of 3 g of un-hydrolyzed corn stover residue. The DOC concentration in the filtrate of the wet-ozonized un-hydrolyzed corn stover residue was measured to be 2928 ppm.

FIG. 17b shows the plates in which the silicon dioxide particles were mixed with the filtrate from the un-hydrolyzed corn stover residue. In each of the plates, 10 g of sands was mixed with 3 mL of the respective liquid. A: non-ozonized filtrate. C: non-ozonized filtrate with 2.5 mM of calcium. B: wet ozonized filtrate. D: wet-ozonized filtrate with 2.5 mM calcium. Control 1: sand mixed with 3 mL of milli-Q water. Control 2: sand mixed with 3 mL of milli-Q water with 2.5 mM calcium. After mixing, the plates were left on a laboratory bench at room temperature overnight. The plates were then slowly tilted to 45 degrees and then to 90 degrees. All treated sand piles did not fall apart except that Controls 1 and 2 collapsed after being tilted at 45 degrees and 90 degrees, respectively.

FIG. 17c shows the plates in which the silicon dioxide sands were mixed with the un-hydrolyzed corn stover residue and the filtrate from the un-hydrolyzed corn stover residue. E: 9 g of sands mixed with 1 g of the non-ozonized un-hydrolyzed corn stover residue and 4 mL of the filtrate from the non-ozonized un-hydrolyzed corn stover residue; F: similar to E except that the non-ozonized filtrate contained 2.5 mM of calcium; G: 9 g of sands mixed with 1 g of the ozonized un-hydrolyzed corn stover residue and 4 mL of the filtrate from the wet ozonized un-hydrolyzed corn stover residue. H: similar to G except that the wet-ozonized filtrate contained 2.5 mM of calcium. Control 1: 10 g sand mixed with 3 mL of milli-Q water. Control 2: 10 g sand mixed with 3 mL of milli-Q water with 2.5 mM of calcium. After mixture, the plates were left at room temperature overnight. The plates were then slowly tilted to 45 degrees and then to 90 degrees. All treated sand piles did not fall apart except that Controls 1 and 2 collapsed after being tilted at 45 degrees and 90 degrees, respectively.

FIG. 18a presents an example of liquid culture growth curves of cyanobacteria Synechococcus elongatus PCC 7942 measured as chlorophyll Absorbance at 680 nm when incubated in multi-well bioassay plates with dissolved organic carbon (DOC) of wet-ozonized P500 biochar filtrates. The growth assay showed that the use of wet-ozonized P500 biochar filtrates at a DOC concentration levels of 2 ppm, 7.5 ppm, and/or 10 ppm can be beneficial to cyanobacteria culture growth.

FIG. 18b presents an example of liquid culture growth curves of Synechococcus elongatus PCC 7942 measured as chlorophyll Absorbance at 680 nm when incubated in multi-well bioassay plates with 0 ppm, 10 ppm, 25 ppm, and 75 ppm of dissolved organic carbon (DOC) of the hydrochar (HTC) liquid from a hydrothermal conversion process using un-hydrolyzed corn stover residues. The assay showed that the use of HTC liquid at a DOC concentration of 10 and 25 ppm can stimulate cyanobacteria growth.

FIG. 19 presents bioassay results demonstrating that the surface-oxygenated biochar compositions contain certain amounts of beneficial humic acids-like substances including certain partially oxygenated dissolved organic carbons (DOC) that can stimulate higher plant crop seed germination and seedling elongation (growth) such as Sorghum, Lepidium, and Sinapis when used at a proper DOC concentration such as 75 ppm and 150 ppm.

FIG. 20 presents an example for the production of dissolved organic carbon (DOC) matters measured as the concentration (ppm) of DOC from Pine 400 biochar through sonication (15S=15 minutes of sonication), dry ozonization (90D=dry ozone treated biochar for 90 minutes), wet ozonization (90W=wet ozone treated biochar for 90 minutes), and sonication in combination with wet ozonization (15S+90 W=15 minutes of sonication and 90 minutes wet ozone treated biochar).

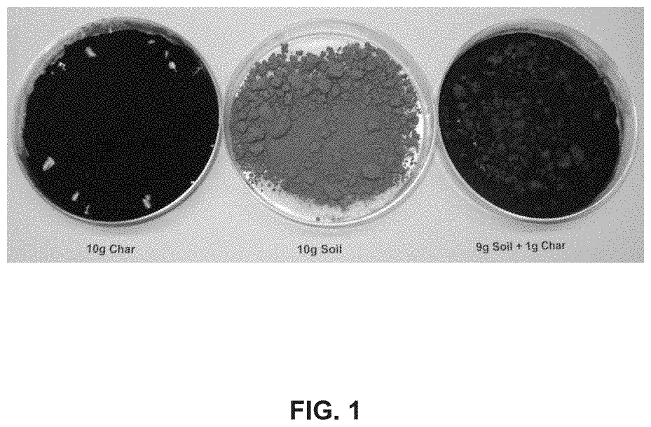

### DETAILED DESCRIPTION

Described herein are a series of improved methods for phosphorus sustainability, sand soilization and odor removal utilizing the phosphorus-unlocking and odor removing green chemistry of surface-oxygenated biochar compositions made with special sonication-ozonization methods for creating advanced hydrophilic biochar materials that are provided with higher cation exchange capacity, optimized pH, improved wettability, and free of potential toxic components. These sonicated and/or ozonized biochar compositions including surface-oxygenated biochar paste products are used for a number of innovative applications including: 1) as filtration materials for clean water and air such as pig manure odor smell removal; 2) as phosphorus solubilizing reagents to mix with phosphate rock materials such as hydroxyapatite or fluorapatite to make a slow-releasing phosphate fertilizer; 3) as biochar soil additives to help solubilize phosphorus (to make it available for plant growth) from the insoluble phosphate materials existed already in certain soils and thus reduce phosphorus fertilizer additions required to achieve desired soil phosphorus activity, crop uptake, and yield goals; 4) as sand soilization reagent by utilizing their liquid gel-forming activity in the spaces among sand particles to retain water and nutrients and hold the sand particles together; 5) as plant growth stimulants by using the humic acids-like surface-oxygenated biochar substances at a proper concentration; and 6) as carbon sequestration agents to help control climate change for energy and environmental sustainability on Earth.

Exemplary embodiments are directed to a systematic method for producing and utilizing a surface-oxygenated biochar composition through ozonization in combination with sonication, the method comprising: treating a biochar source composition with sonication and an ozone-containing gas stream in a biochar sonication-ozonization treatment reactor system using a sonication-ozonization-enabled biochar-surface oxygenation operational process, wherein treating the source biochar composition comprises: a) contacting the source biochar with the ozone-containing gas stream; b) enabling biochar-surface oxygenation; c) destroying a potential biochar toxin; d) producing a surface-oxygenated biochar composition having enhanced cation exchange capacity; e) producing a special surface-oxygenated biochar composition for phosphorus solubilization from insoluble phosphate materials for producing phosphate fertilizers without using strong industrial acids; f) producing a special surface-oxygenated biochar paste composition for sands soilization; and g) producing a special surface-oxygenated biochar composition having an enhanced filtration property as exemplified in methylene blue adsorption capability for removing at least one contaminant from a medium selected from the group consisting of water and air including odor removal.

According to one of the various embodiments, ozonized biochar compositions with unique properties for use as soil amendment or soil additives and as filtration materials, for example, for industrial filtration applications. The methods described herein apply a series of ozone-enhanced biochar-surface oxygenation and cleaning processes to create a new generation of clean biochar materials with super high cation exchange capacity over 50 cmol/kg, 100 cmol/kg, 150 cmol/kg and as high as about 200 cmol/kg. These clean biochar materials are free of undesirable and potentially toxic substances and represent a major technological improvement. The ozonization chemistry and technologies are employed as a post-production biochar-surface oxygenation process to convert biochar compositions to unique ozonized compositions. Various aspects and embodiments of the methods herein are disclosed below.

According to one of the various embodiments, biochar materials with high surface area may be advantageous to interact with ozone molecules for biochar surface oxygenation to create super high cation exchange capacity. Therefore, it is a preferred practice for certain biochar ozonization process to use source biochar material with high specific surface area (SSA), as commonly determined by BET analysis. Typically, the BET surface areas of source biochar feedstocks for certain biochar ozonization process are selected a group consisting of 0.5, 1, 2, 3, 4, 5, 10, 15, 20, 25, 30, 35, 40, 45, 50, 55, 60, 70, 80, 90, 100, 120, 150, 200, 250, 300, 350, 400, 450, 500, 550, 600, 650, 700, or 800 m²/g, or an SSA value within a range bounded by any two of the foregoing values.

According to one of the various embodiments, a method for industrial production of an ozonized biochar composition involves reacting a biochar source with an ozone-containing gas stream in a special biochar ozonization treatment reactor system using a specific ozone-enabled biochar-surface oxygenation operational process. The method utilizes a biochar ozonization treatment reactor system, and the biochar ozonization treatment reactor system in combination with the use of hydrogen peroxide. In one embodiment, the biochar source is contacted with ozone to (a) enable biochar-surface oxygenation; (b) destruct a potential biochar toxin; (c) produce an ozonized biochar composition having an optimal set of characteristics selected from the group consisting of enhanced cation exchange capacity, optimal pH value, optimal carboxyl content, optimal hydrophilicity and wettability, optimal water-holding field capacity, optimal oxygen-to-carbon molar ratio, surface area, composition, nutrient contents, biochar particle size, uniformity, and any combination thereof; and (d) produce a special ozonized biochar composition having an enhanced filtration property for removing at least one contaminant from a medium selected from the group consisting of water and air.

One exemplary embodiment is directed to a method for producing an ozonized biochar material possessing a higher cation-exchanging property. The cation-exchanging ability of a biochar is known to be predominantly dependent on the density of cation-exchanging groups mainly carboxyl (—COOH) groups in the biochar.

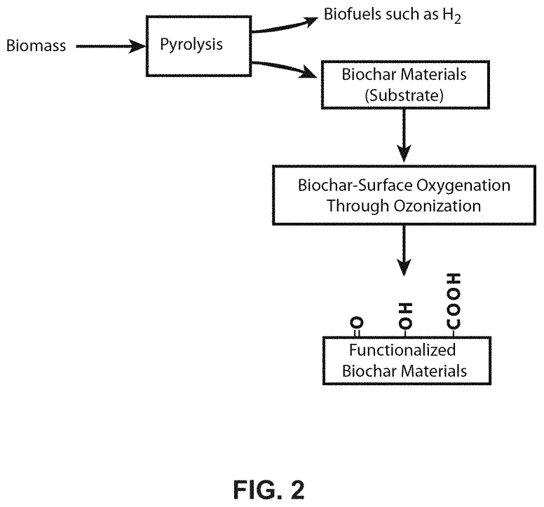

Referring to FIG. 2, an exemplary embodiment of a process is illustrated for reacting a biochar source with an injected ozone (O₃) stream, which is a ozonizing agent useful herein, in a controlled manner such that the biochar source homogeneously acquires carboxy-containing cation-exchanging groups in a post-production biochar-surface oxygenation process that can create carboxyl groups on biochar surfaces even at ambient pressure and temperature. As shown in FIG. 2, a suitable biomass is subject to a pyrolysis process that results in biofuels such a H₂ and biochar materials, i.e., substrate. The process then provides proper utilization of ozone treatment to achieve implantation of oxygen atoms into the biochar materials and thus creating additional oxygen-containing functional groups, such as hydroxyl and carboxyl groups, on the resulting functionalized biochar surfaces to improve biochar surface hydrophilicity and CEC and to eliminate potential toxins. Therefore, ozonization of biochar creates oxygen-containing functional groups including (but not limited to) carbonyl (biochar C═O), hydroxyl (—OH) and carboxyl (—COOH) groups on the functionalized biochar materials. The carboxyl groups in pH neutral water are mostly deprotonated to form negatively charged species, which may represent the cation binding and exchanging sites on the biochar surfaces.

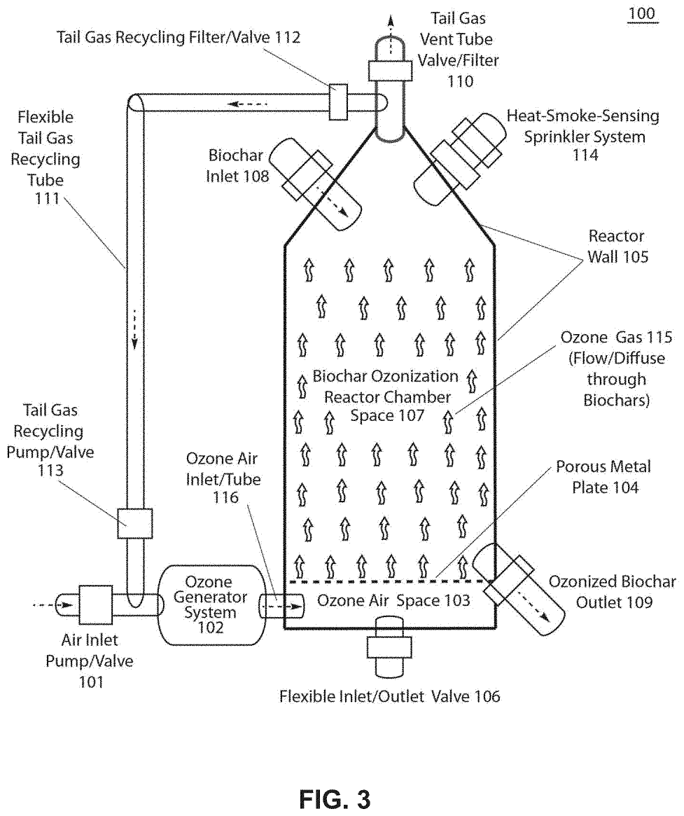

Referring to FIG. 3, in one embodiment, an exemplary embodiment of a biochar ozonization treatment reactor system 100 is illustrated. The biochar ozonization treatment reactor system 100 is a controlled ozone gas biochar reactor system that comprises: an air inlet pump and valve 101, an ozone generator system 102, an ozone air inlet and tube 116 passing through the biochar ozonization reactor wall 105 near its bottom, an ozone air space 103 at the bottom of the reactor, a porous metal plate 104 on top of the ozone air space, a biochar ozonization reactor chamber space 107 above the porous metal plate 104, a biochar inlet 108 passing through the biochar ozonization reactor wall 105 at the upper part of the reactor, an ozonized biochar outlet 109 passing through the reactor wall at the lower part of the reactor, a tail gas vent valve and filter 110 at the top of the reactor, a flexible tail gas recycling tube 111 equipped with its filter and valve 112 and pump and valve 113 connecting from the tail gas vent tube 110 to the air inlet 101, a heat-smoke-sensing sprinkler system 114 passing through the biochar ozonization reactor wall 105 at the upper part of the reactor, and a flexible inlet and outlet valve 106 at the bottom of the reactor.

Ozone is known to crack rubber and certain elastomers that have C═C double bonds. Cast iron, Steel (Mild, High-strength low-alloy (HSLA)), Zinc, Magnesium, Polypropylene and Nylon are also sensitive to ozone corrosion. Those types of ozone-sensitive materials are not recommended for use in building the reactor and associated parts and joints that may be in contact with ozone. It is a preferred practice to use special ozone-compatible materials that can tolerate the reactive ozone in constructing the ozone biochar reactor system including the associated parts and joints that will be in contact with ozone. According to one of the various embodiments, the ozone-compatible materials for use in the construction of the reactor system are selected from the group consisting of stainless steel, titanium, silicone, glass, polytetrafluoroethylene (PTFE) (commercially available as Teflon® from Chemours of Wilmington, Del.), a perfluoroelastomer polymer (commercially available as Chemraz® from Greene Tweed of Kulpsville, Pa.), polyether ether ketone (PEEK), polychlorotrifluoroethylene (PCTFE) (commercially available as Kel-F® from 3M Corporation of St. Paul, Minn.), chlorinated polyvinyl chloride (CPVC), a silicon cast iron, chromium and molybdenum alloy (commercially available as Durachlor-51 from Duriron Company of Dayton, Ohio), filled PTFE gasket material (commercially available as Durlon® 9000 from Gasket Resources Inc. of Downingtown, Pa.), a nickel, molybdenum, chromium and iron alloy (commercially available as Hastelloy-C™ from All Metals and Forge Group of Fairfield, N.J.), polycarbonate, polyurethane, polyvinylidene difluoride (PVDF) (commercially available as Kynar® from Arkema Inc. of King of Prussia, Pa.), butyl, a heat- and chemical-resistant ethylene acrylic elastomer (commercially available as Vamac® from E. I. du Pont de Nemours and Company of Wilmington, Del.), a synthetic rubber and fluoropolymer elastomer (commercially available as Viton® from DuPont Performance Elastomers L.L.C. of Wilmington, Del.), ethylene-propylene, a thermoplastic vulcanizate (TPV) (commercially available as Santoprene™ from ExxonMobil Chemical of Spring, Tex.), flexible polyethylene tubing (commercially available as Flexelene from Eldon James Corporation of Denver, Colo.), fluorosilicone, aluminum, copper, and combinations thereof.

Ozone is an inorganic trioxygen molecule with the chemical formula O₃, and is a pale blue gas with a distinctively pungent smell. Suitable methods for ozone generation include, but are not limited to, the corona discharge method, the cold plasma method, ultraviolet light ozone generation, and electrolytic ozone generation.

In one embodiment, an ozone generator utilizing the corona discharge method with a corona discharge tube is employed as the ozone generator system 102 in the biochar ozonization treatment reactor system 100 illustrated in FIG. 3, or in any of the illustrated reactor embodiments utilizing an ozone generator system. The corona discharge tube-based ozone generators are cost-effective and do not require an oxygen source other than the ambient air to produce ozone concentrations of 3-6%. Use of an oxygen concentrator in combination with the corona discharge ozone generator increases the ozone concentrations produced. In addition, the corona discharge tube-based ozone generators also produce nitrogen oxides from the air (21% O₂ and 79% N₂) as a by-product, which in the presence of water and vapor can form nitric acid that may be absorbed, to some degree, by biochar materials. Certain conventional biochar materials, in particular those made from high-temperature pyrolysis or gasification processes, typically have an alkaline pH ranging from about pH 8.5 up to about pH 12. The adsorption of nitrogen oxides/nitric acid may beneficially reduce the alkaline pH of biochar. To enhance this feature, air (21% O₂ and 79% N₂) is used through the ozone generator system 102 to create both ozone and nitrogen oxides with moisture to treat dry biochars or wet biochars. When desired, at least one of water and steam is optionally introduced into the biochar ozonization reactor through a flexible inlet and outlet valve 106 at the bottom of the reactor.

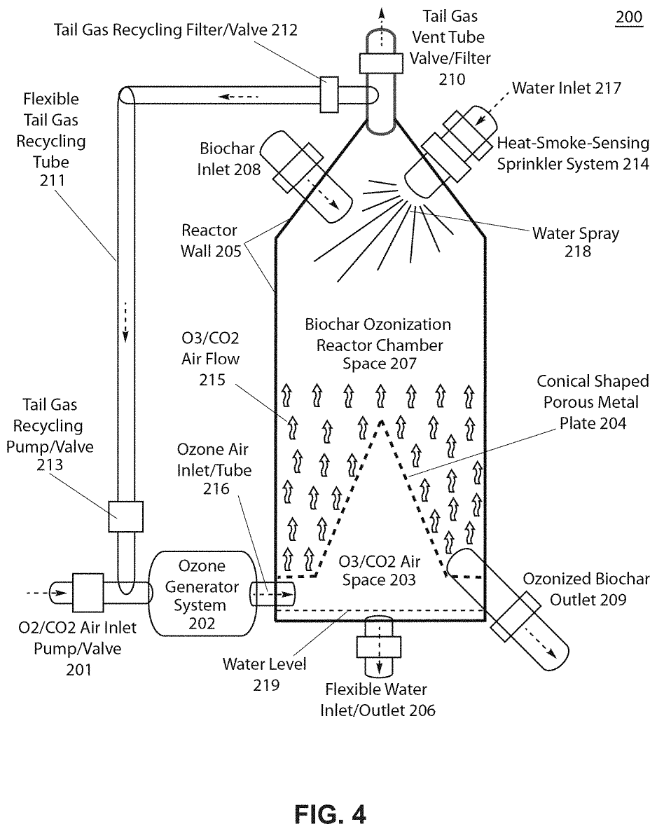

Referring now to FIG. 4, another exemplary embodiment of a biochar ozonization treatment reactor system 200 is illustrated in which water is optionally introduced into the biochar ozonization reactor through a heat-smoke-sensing sprinkler system 214 equipped with water inlet 217 and water spray 218 system at the upper part of the reactor for a “wet biochar” treatment process. In addition to the nitrogen oxides and nitric acid adsorption, the formation of carboxyl groups on biochar surfaces through ozonization also reduces the alkaline biochar pH. Consequently, the air ozonization process results in a nitric nutrient-enriched biochar product with a better pH value more desirable for use as an agricultural soil amendment or additive.

According to one embodiment, when desired, the nitrogen oxides and nitric acid formation and adsorption is reduced by use of an air dryer that reduces or eliminates nitric acid formation by removing water vapor, increasing overall ozone production. Use of an oxygen concentrator further increases the ozone production and further reduces the risk of nitric acid formation by removing not only the water vapor, but also the bulk of the nitrogen. Alternatively, at least one of pure oxygen and a mixed oxygen gas such as O₂/CO₂ gas mixtures (that are completely devoid of N₂) are used to generate ozone for the biochar treatment process.

According to one embodiment, an ozone generator based on the cold plasma method is utilized as the ozone generator system 102 in the biochar ozonization treatment reactor system 100 illustrated in FIG. 3 or in any illustrated embodiment of the reactor system utilizing an ozone generator system. In the cold plasma method, pure oxygen gas is exposed to plasma created by dielectric barrier discharge. The diatomic oxygen is split into single atoms, which then recombine in triplets to form ozone. Cold plasma machines utilize pure oxygen as the input source and produce a maximum concentration of about 5% ozone.

According to one embodiment, the regime of applied ozone concentrations ranges from about 1% to about 5% in air and from about 6% to about 14% in oxygen for older generation methods. New electrolytic methods achieve up about 20% to about 30% dissolved ozone concentrations in output water for biochar treatment.

In operating the ozone biochar treatment reactor system process as provided by the reactor embodiments of one or more of FIGS. 3, 4, 5, 6 and 7, biochar materials are loaded through the inlet 108, 208, 308, 408, 508 into the reactor chamber space 107, 207, 307, 407, 507 above the porous metal plate 104, 204, 30, 404, 504 for ozonization treatment. The temperature of biochar materials is monitored and adjusted as necessary or desired. The biochar water content and relative humidity in the reactor are monitored and adjusted as necessary or desired. If or when “wet biochar ozonization” is necessary or desired, water is added into the biochar materials by use of a heat-smoke-sensing sprinkler system 214 with water inlet 217 and water spray 218 system at the upper part of the reactor, or at least one of water and steam is introduced by use of a flexible water inlet and outlet valve 206 and optional water level 219 at the bottom of the reactor (FIG. 4). Ozone gas is generated from air oxygen through an ozone generator system 102, 202, 302, 402, 502 and fed into the ozone air space 103, 203, 303, 403, 503 at the bottom of the reactor. If or when “dry biochar ozonization” is necessary or desired, a dry treating gas stream is used without any water or steam in the reactor. When ready, the ozone gas 115, 215, 315, 415, 515 stream passing through the porous metal plate 104, 204, 304, 404, 504 flows and diffuses through the biochar materials upwards. As the ozone gas encounters the biochar surfaces during this process, it reacts with certain biochar surface atoms, forming oxygen-containing functional groups on biochar surfaces as illustrated, for example, in FIG. 2.

The most significant reactions of ozone with organic matter are based on the cleavage of the carbon double bond, which acts as a nucleophile having excess electrons. For example, the injected ozone (O₃) air stream can, to some extent, lead to the formation of carbonyl and carboxyl groups on biochar surfaces, by reacting with the C═C double bonds (aromatic carbons) of biochar materials at ambient pressure and temperature:

Biochar-CH═CH-Biochar+O₃→Biochar-COH+Biochar-COOH [1]

In this aspect, the ozonized biochar product will: 1) become more hydrophilic since both carbonyl and carboxyl groups can attract water molecules; and 2) have higher cation exchange capacity since the carboxyl groups readily deprotonate in water and result in more negative charge (Biochar-COO⁻) on the ozonized biochar surfaces:

Biochar-COOH→Biochar-COO⁻+H⁺ [2]

According to one embodiment, the sources of oxygen gas to generate ozone through the ozone generator system are selected from the group consisting of ambient air oxygen, pure oxygen gas, mixed oxygen and carbon dioxide gas, mixed oxygen and nitrogen gas, residual oxygen-containing flue gas, and combination thereof. Use of pure oxygen gas through the ozone generator can create higher concentration of ozone in the gas stream so that the biochar ozonization reactions are enhanced. Preferably, use of pure oxygen system is limited to well-controlled smaller reactors to ensure operational safety. For better safety and economic considerations, use of ambient air oxygen to generate ozone for biochar ozonization is preferred.

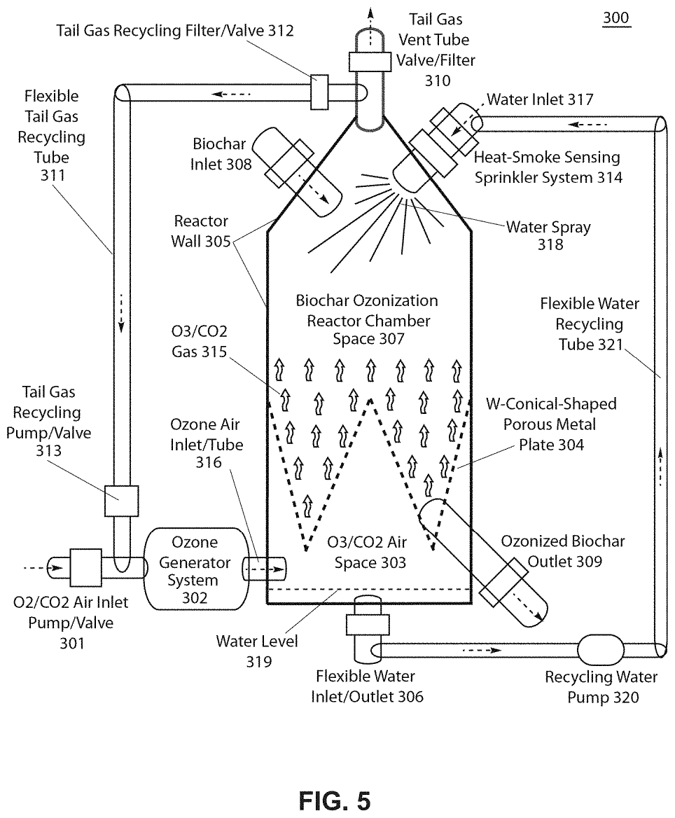

Biochar can also be quite reactive and can ignite itself; therefore, as shown in FIG. 3, a well-equipped heat-smoke-sensing sprinkler system 114 is utilized to extinguish any potential fire with a water spray within the reactor. Liquid water can be injected into the reactor through the use of a flexible inlet and outlet valve 106 at the bottom of the reactor. When necessary, liquid water can also be discharged from the reactor through the use of the flexible inlet and outlet valve 106 or recycled using a recycling water pump 320 with a flexible water recycling tube 321 connected with the flexible water inlet and outlet 306 and the water inlet 317 to re-use the liquid through water spray 318 as shown in FIG. 5. A potential biochar reactor fire can be stopped also by shutting off any air oxygen supply to the reactor such as by closing the air inlet valve 101 (FIG. 3).

In an experimental study utilizing embodiments of the systems and methods in accordance with the present invention, the biochar ozonization process reactions were somewhat exothermic. Therefore, it is preferred to control the biochar ozonization process speed and heat dissipation so that the temperature of the biochar ozonization reactor can be maintained near the ambient temperature. In one embodiment, the reactor wall is preferably made of metals such as stainless steel that tolerate ozone and dissipate heat as necessary or desired.

According to one embodiment, the biochar ozonization process speed is controlled by adjusting compositions including the ozone concentration and the feeding rate and compositions of the treating gas stream. Use of the flexible inlet and outlet valve 106 at the bottom of the reactor enables the introduction of steam and other gases of choice into the ozone-treating gas stream to achieve a more desirable result. Use of the flexible tail gas recycling tube 111 with its filter and valve 112 and pump and valve 113 provides the option to re-use part or all of the tail gas in the process. For example, when ambient air oxygen (typically containing about 21% O₂ and 79% N₂) is used to generate ozone for the biochar ozonization process, the tail gas is released through the vent or re-used through the flexible tail gas recycling tube 111 with its filter and valve 112 and pump and valve 113 if the tail gas still contains ozone and/or other gas components that may have a value for re-use. When the biochar is desirably ozonized, the ozonized biochar product is harvested through the use of ozonized biochar outlet 109 at the lower part of the reactor by use of gravity as illustrated in FIG. 3.

Therefore, according to one embodiment, a dry biochar ozonization treatment operational process includes the following specific process steps: a) Loading biochar materials into the reactor through the biochar inlet; b) Monitoring and adjusting (if/when necessary) biochar temperature, c) Monitoring and adjusting (if/when necessary) biochar water content and relative humidity in the reactor, d) Pumping dry oxygen-containing source gas such as ambient air oxygen with an air dryer through the ozone generator system to generate ozone; e) Feeding dry ozone-containing gas stream into the reactor chamber space through the porous metal plate above the ozone air space by controlling the air pump fan speed without using any water; f) If/when necessary, using the flexible inlet and outlet valve at the bottom of the reactor to introduce other gas component(s) of choice into the treating gas stream to manipulate the biochar ozonization process; g) If/when necessary, using the flexible tail gas recycling tube with its filter and valve and pump and valve to re-use part and/or all of the tail gas for the process; h) Allowing sufficient time for the ozone-containing stream to flow/diffuse through and interact with biochar particles while controlling and monitoring the treatment conditions such as reactor temperature and gas-stream flow rate; i) Harvesting the ozonized biochar products through the ozonized biochar outlet by use of gravity (with minimal energy cost); and j) repeating steps a) through i) for a plurality of operational cycles to achieve more desirable results.

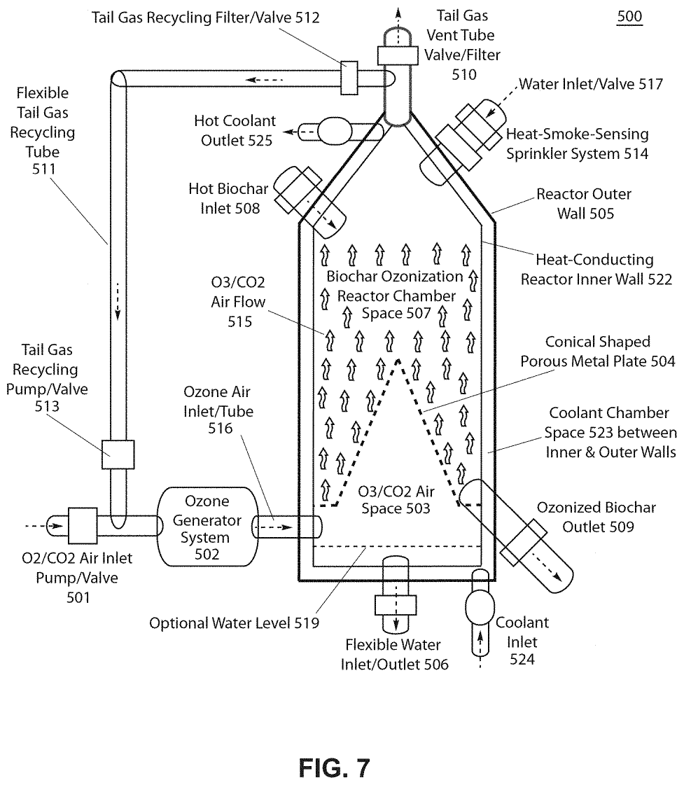

In one embodiment, an exemplary processes in accordance with the present invention uses the biochar ozonization treatment process system for a plurality or series of operational cycles to achieve more desirable results. Any one of the steps a) through j) of this process can be adjusted or modified as desired for certain specific operational conditions. For example, as shown in FIG. 7, when a hot biochar source 508 from at least one of a biomass pyrolysis and gasification reactor is used with this treatment process, the biochar temperature monitoring and adjusting step of b) is modified by adding additional steps of using a double-wall coolant-jacketed ozone gas biochar reactor system, 505 (reactor outer wall), 522 (reactor inner wall), 523 (coolant chamber space), 524 (coolant inlet), 525 (hot coolant outlet) with a coolant to cool down hot biochar and to utilize the waste heat energy through a heat exchange system to preheat and/or to dry biomass. Any one of the steps a) through i) of the process of the present invention can be applied in whole or in part and in any adjusted combination for enhanced biochar-surface oxygenation in accordance of this invention.

Referring to FIG. 4, in one embodiment, a biochar ozonization treatment reactor system 200 is illustrated. The biochar ozonization treatment reactor system 200 is a controlled ozone gas biochar reactor system that comprises: an O₂/CO₂ air inlet pump and valve 201, an ozone generator system 202, an ozone air inlet and tube 216 passing through the biochar ozonization reactor wall 205 near its bottom, an O₃/CO₂ air space 203 at the bottom of the reactor, a conical-shaped porous metal plate 204, a biochar ozonization reactor chamber space 207 above the porous metal plate 204, a biochar inlet 208 passing through the biochar ozonization reactor wall 205 at the upper part of the reactor, an O₃/CO₂ air flow 215 from the O₃/CO₂ air space 203 at the bottom through the conical-shaped porous metal plate and the biochar materials toward the upper part of the reactor, an ozonized biochar outlet 209 passing through the reactor wall at the lower part of the reactor, a tail gas vent valve and filter 210 at the top of the reactor, a flexible tail gas recycling tube 211 equipped with its filter and valve 212 and a pump and valve 213 connecting from the tail gas vent tube 210 to the air inlet 201, a heat-smoke-sensing sprinkler system 214 equipped with water inlet 217 and water spray or atomizer 218 system at the upper part of the reactor, and a flexible water inlet and outlet valve 206 and optional water level 218 at the bottom of the reactor. Note, the term “O₃/CO₂ air” here throughout the specification means “O₃ and/or CO₂ air” that represents “O₃, O₃ and CO₂, or CO₂ air”.

This biochar ozonization treatment reactor system 200 illustrated in FIG. 4 is similar to the system illustrated in FIG. 3 with the exception of the following additional features. The embodiment of FIG. 4, employs a conical-shaped porous metal plate 204 that provides more surface area for the ozone containing gas stream to pass through into the biochar ozonization reactor chamber space 207 for better efficiency. In addition, water inlet 217 and water spray 218 are used to optionally add water into the materials to optimize the biochar ozonization process and to prevent any possible biochar fire or combustion. The embodiment of FIG. 4 utilizes an optional water level 219 and flexible water inlet and outlet 206 to provide moisture for the O₃/CO₂ air space and to either discharge or to collect and reuse the liquid.

Referring to FIG. 5, another embodiment of a biochar ozonization treatment reactor system 300 is illustrated. The biochar ozonization treatment reactor system 300 is a controlled ozone gas biochar reactor system that includes and O₂/CO₂ air inlet pump and valve 301, an ozone generator system 302, an ozone air inlet and tube 316 passing through the biochar ozonization reactor wall 305 near its bottom, an ozone O₃/CO₂ air space 303 at the bottom of the reactor, a W-conical-shaped porous metal plate 304, a biochar ozonization reactor chamber space 307 above the porous metal plate 304, a biochar inlet 308 passing through the biochar ozonization reactor wall 305 at the upper part of the reactor, an O₃/CO₂ gas 315 flowing from O₃/CO₂ air space 303 at the bottom through the W-conical-shaped porous metal plate and the biochar materials toward the upper part of the reactor, an ozonized biochar outlet 309 passing through the reactor wall at the lower part of the reactor, a tail gas vent valve and filter 310 at the top of the reactor, a flexible tail gas recycling tube 311 equipped with its filter and valve 312 and pump and valve 313 connecting from the tail gas vent tube 310 to the air inlet 301, a heat-smoke-sensing sprinkler system 314 equipped with water inlet 317 and water spray 318 system at the upper part of the reactor, an optional water level 319 and flexible water inlet and outlet valve 306 at the bottom of the reactor, a recycling water pump 320 with a flexible water recycling tube 321 connected with the flexible water inlet and outlet 306 and the water inlet 317.

This embodiment of the biochar ozonization treatment reactor system 300 illustrated in FIG. 5 is similar to the embodiment of FIG. 4 with the exception of the following additional features. The embodiment of FIG. 5 employs a W-shaped or a W-conical-shaped porous metal plate 304 that provides even greater surface area for the ozone containing gas stream to pass through into the biochar ozonization reactor chamber space 307 for better efficiency. This embodiment also utilizes a recycling water pump 320 with a flexible water recycling tube 321 connected with the flexible water inlet and outlet 306 and the water inlet 317 to re-use the liquid for the biochar ozonization process.

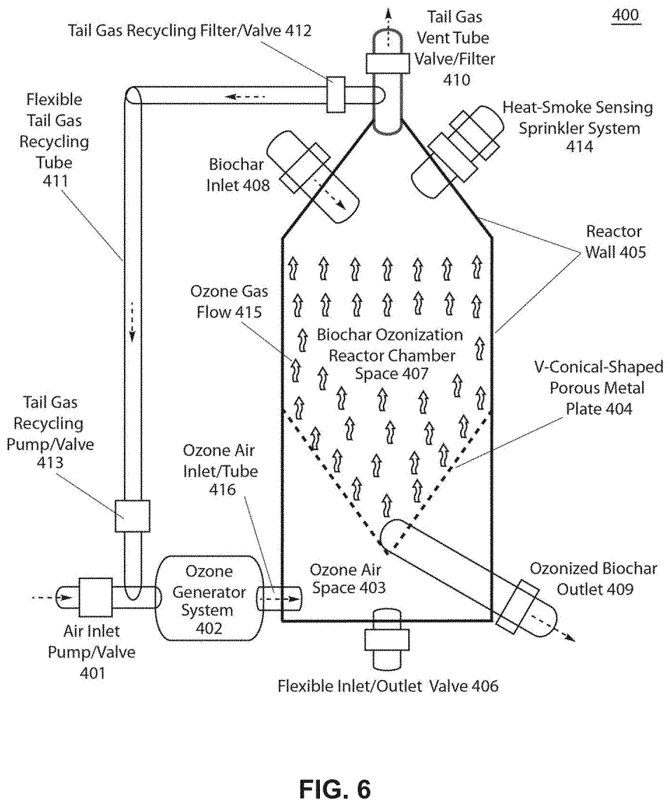

Referring to FIG. 6, another embodiment of a biochar ozonization treatment reactor system 400 is illustrated. This biochar ozonization treatment reactor system 400 is a controlled ozone gas biochar reactor system that includes an air inlet pump and valve 401, an ozone generator system 402, an ozone air inlet and tube 416 passing through the biochar ozonization reactor wall 405 near its bottom, an ozone air space 403 at the bottom of the reactor, a V-shaped or V-conical-shaped porous metal plate 404, a biochar ozonization reactor chamber space 407 above the porous metal plate 404, a biochar inlet 408 passing through the biochar ozonization reactor wall 405 at the upper part of the reactor, an ozone gas 415 flowing from ozone air space 403 at the bottom through the V-conical-shaped porous metal plate and the biochar materials toward the upper part of the reactor, an ozonized biochar outlet 409 passing through the reactor wall at the lower part of the reactor, a tail gas vent valve and filter 410 at the top of the reactor, a flexible tail gas recycling tube 411 equipped with its filter and valve 412 and pump and valve 413 connecting from the tail gas vent tube 410 to the O₂/CO₂ air inlet 401, a heat-smoke-sensing sprinkler system 414 at the upper part of the reactor, and a flexible inlet and outlet valve 406 at the bottom of the reactor.

The embodiment of the biochar ozonization treatment reactor system 400 illustrated in FIG. 6 is similar to the embodiment illustrated in FIG. 3. However, this embodiment utilizes a V-conical-shaped porous metal plate 404 that provides greater surface area for the ozone containing gas stream to pass through into the biochar ozonization reactor chamber space 407. This shaped porous metal plate also provides a convenient way for improved harvest of the treated biochar products through the ozonized biochar outlet 409 by use of gravity with minimal energy consumption.

Referring to FIG. 7, another embodiment of a biochar ozonization treatment reactor system 500 is illustrated. This is a double-wall coolant-jacketed ozone gas biochar reactor system that includes a heat-conducting reactor inner wall 522, a reactor outer wall 505, a coolant chamber space 523 formed between the inner wall 522 and outer wall 505, a coolant inlet 524 connected with the coolant chamber space at the bottom part of the reactor, a hot coolant outlet 525 connected with the coolant chamber space at the top part of the reactor, an O₂/CO₂ air inlet pump and valve 501, an ozone generator system 552, an ozone air inlet and tube 516 passing through the biochar ozonization reactor outer wall 505 and inner wall 522 near its bottom, an ozone O₃/CO₂ air space 503 at the bottom of the reactor, an inverted-V conical-shaped porous metal plate 504, a biochar ozonization reactor chamber space 507 above the porous metal plate 504, a hot biochar inlet 508 passing through the biochar ozonization reactor double walls at the upper part of the reactor, an O₃/CO₂ gas 515 flowing from the O₃/CO₂ air space 503 at the bottom through the conical-shaped porous metal plate and the biochar materials toward the upper part of the reactor, an ozonized biochar outlet 509 passing through the reactor double walls at the lower part of the reactor, a tail gas vent valve and filter 510 at the top of the reactor, a flexible tail gas recycling tube 511 equipped with its filter and valve 512 and pump and valve 513 connected from the tail gas vent tube 510 to the air inlet 501, a heat-smoke-sensing sprinkler system 514 equipped with a water inlet 517 and a water spray system at the upper part of the reactor, an optional water level 519 and a flexible water inlet and outlet valve 506 at the bottom of the reactor.

The embodiment of the biochar ozonization treatment reactor system 500 of FIG. 7 is similar to the embodiment illustrated in FIG. 6, with the following additional features. The embodiment of FIG. 7 employs a double-wall coolant-jacketed ozone gas biochar reactor system to enable cooling of hot biochar by use of a coolant and the outputting of hot coolant for waste heat energy recovery and utilization such as the utilization of waste heat through a heat exchange system to preheat or to dry biomass. This embodiment also utilizes an inverted-V-conical-shaped porous metal plate 504 that facilitates cooling of the biochar materials within the double-wall coolant-jacketed reactor. In addition, this embodiment utilizes well-controlled O₃ concentration levels under a CO₂ (and/or N₂) atmosphere to prevent any possible biochar combustion especially during the loading of hot biochars from a biomass pyrolysis or gasification reactor.

The coolant utilized in this embodiment is a fluid that flows through or around a biochar reactor to prevent its overheating, transferring the heat produced by the biochar reactor to other devices that utilize the waste heat to pre-heat or dry biomass or to dissipate the heat. Suitable coolants have a high thermal capacity, low viscosity and are low-cost. In addition, the coolants are preferably non-toxic and chemically inert, neither causing nor promoting corrosion of the cooling system. Suitable coolants are selected from the group consisting of water, antifreeze liquid, polyalkylene glycol, oils, mineral oils, silicone oils such as polydimethylsiloxane, fluorocarbon oils, transformer (insulating) oil, refrigerants, and combination thereof.

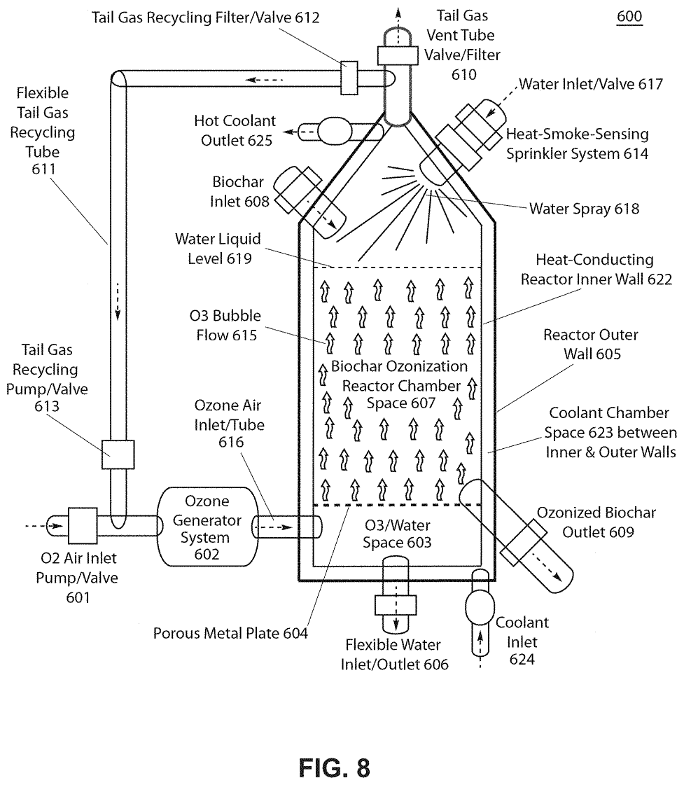

Referring to FIG. 8, another embodiment of a biochar liquid-ozonization treatment reactor system 600 is illustrated. This embodiment of a biochar ozonization treatment reactor system 600 is a double-wall coolant-jacketed ozone gas biochar reactor system that includes a heat-conducting reactor inner wall 622, a reactor outer wall 605, a coolant chamber space 623 formed between the inner wall 622 and outer wall 605, a coolant inlet 624 connected with the coolant chamber space at the bottom part of the reactor, a hot coolant outlet 625 connected with the coolant chamber space at the top part of the reactor, an O₂ air inlet pump and valve 601, an ozone generator system 652, an ozone air inlet and tube 616 passing through the biochar ozonization reactor out wall 605 and inner wall 622 near its bottom, an ozone O₃/water space 603 at the bottom of the reactor, a porous metal plate 604, a biochar ozonization reactor chamber space 607 above the porous metal plate 604, a biochar inlet 508 passing through the biochar ozonization reactor double walls at the upper part of the reactor, an O₃ bubble 615 flowing from the O₃/water space 603 at the bottom through the porous metal plate and the biochar materials toward the upper part of the reactor, a tail gas vent valve and filter 610 at the top of the reactor, a flexible tail gas recycling tube 611 equipped with its filter and valve 612 and a pump and valve 613 connected from the tail gas vent tube 610 to the air inlet 601, a heat-smoke-sensing sprinkler system 614 equipped with water inlet 617 and water spray 618 system, a water liquid level 619 at the upper part of the reactor, an ozonized biochar outlet 609 passing through the reactor double walls at the lower part of the reactor, and a flexible water inlet and outlet valve 606 at the bottom of the reactor.

The biochar ozonization treatment reactor system 600 embodiment of FIG. 8 is similar to the embodiment illustrated in FIG. 7 with the following additional features. The embodiment of FIG. 8 uses a water liquid level 619 that completely immerses biochar materials, and this embodiment takes the advantage of a flat porous metal plate 604 that holds biochar materials and allows O₃ gas to bubble through.

In another embodiment, the feeding of an O₃-containing gas stream is performed preferably with nearly 30% or above 1% of O₃ under a pressure of from about 1 to about 30 atmospheres (atm). The O₃-containing gas stream can be an O₃/water steam stream, an O₃—CO₂/water steam stream, an O₃-O₂-CO₂/water steam stream, an O₃-O₂—CO₂—N₂/water steam stream, an artificial gas mixture stream including an O₃—CO₂ mixture, an oxygen (O₂)-ozone (O₃) mixture, an O₃-O₂—CO₂ mixture, an O₃-nitrogen (N₂) mixture, an O₃-O₂—CO₂—N₂ mixture, an O₃—CO₂—N₂ mixture, an O₃-argon mixture, an O₃-helium mixture, and any combination thereof. According to one embodiment, one of the O₃-containing gas streams listed above is selectively applied in combination with a liquid water spray 218 (FIG. 4) into biochar materials to perform “wet biochar ozonization” to achieve more desirable results. Liquid water mediates the biochar ozonization process in a number of ways, for example, by extracting water-soluble biochar substances including the dissolvable organic content (DOC) that may contain the potential phytotoxins to react with the ozone (see equation [3] below) in the liquid phase to make the biochar product cleaner. The residual ozonized liquid may be discharged at the bottom of the reactor through the flexible water inlet and outlet 206. Alternatively, the residual ozonized liquid stream is recycled through the use of a recycling water pump 320 with a flexible water recycling tube 321 connected with the flexible water inlet and outlet 306 and the water inlet 317 to re-use the liquid for the biochar ozonization process as illustrated, for example, in FIG. 5.

According to one embodiment, a wet-moisture biochar ozonization treatment operational process includes the following process steps that are performed in combination with the use of hydrogen peroxide: a) Loading biochar materials into the reactor through the biochar inlet; b) Monitoring and adjusting (if/when necessary) biochar temperature; c) Monitoring biochar water content and relative humidity in the reactor, d) Based on the required biochar water content and relative humidity, properly adding water into the biochar materials by use of a heat-smoke-sensing sprinkler system with water inlet and water spray system at the upper part of the reactor, and/or introducing water and/or steam/vapor by use of a flexible water inlet and outlet valve and optional water level for vapor/moisture generation at the bottom of the reactor (FIG. 5); e) Pumping an oxygen-containing source gas stream such as ambient air oxygen through the ozone generator system to generate ozone; f) Feeding ozone-containing gas stream into the reactor chamber space through the porous metal plate above the ozone air space by controlling the air pump fan speed; g) If/when necessary, using the flexible inlet and outlet valve at the bottom of the reactor to introduce additional stream/vapor and/or other gas component(s) of choice into the treating gas stream to manipulate the biochar ozonization process; h) If/when necessary, using the flexible tail gas recycling tube with its filter/valve and pump/valve to re-use at least part or all of the tail gas for the process; i) Allowing sufficient time for the ozone-containing stream to flow and to diffuse through and interact with biochar particles while controlling and monitoring the treatment conditions such as reactor temperature and gas-stream flow rate; i) If/when necessary, discharging the residual ozonized liquid at the bottom of the reactor through a flexible water inlet and outlet or recycling the residual ozonized liquid stream through a recycling water pump with a flexible water recycling tube connected with the flexible water inlet/outlet and the water inlet to re-use the liquid for the biochar ozonization process as illustrated in, for example, FIG. 5; j) Harvesting the ozonized biochar products through the ozonized biochar outlet by use of gravity (with minimal energy cost); and k) repeating steps a) through j) for a plurality of operational cycles to achieve more desirable results.

In one embodiment, an exemplary process in accordance with the present invention uses the wet biochar ozonization treatment process system for a plurality or series of operational cycles to achieve more desirable results. Any one of the steps a) through k) of the processes as described herein can be adjusted or modified as desired for certain specific operational conditions. For example, as shown in FIG. 7, when a hot biochar source from a biomass pyrolysis and/or gasification reactor is used with this treatment process, the biochar temperature monitoring and adjusting step of b) is modified by adding additional steps of using a double-wall coolant-jacketed ozone gas biochar reactor system with a coolant to cool down hot biochar and to utilize the waste heat energy through a heat exchange system to preheat and/or to dry biomass. Any one of the steps a) through k) of the embodiments of process of the present invention are described herein can be applied in whole or in part and in any adjusted combination for enhanced biochar-surface oxygenation in accordance of this invention.

According to one of the various embodiments, the biochar ozonization treatment process is operated in combination with the use of hydrogen peroxide (H₂O₂). Suitable overall amounts of hydrogen peroxide include, but are not limited to, about 1, 3, 10, 20, and 30% w/w treatments of H₂O₂ with or without the use of ozone. Typically, biochar treated with H₂O₂ show an increase in CEC. This increase in CEC is attributed to an increase in the presence of acidic oxygen functional groups on the surface of the biochar materials. Furthermore, H₂O₂ treatment causes an overall drop in biochar's capacity for the removal of methylene blue from solution, likely resulting from the weakening of π-π dispersive forces brought about by the introduction of oxygen functionality, which disrupts the overall aromatic structure of the biochar sample. The use of hydrogen peroxide (H₂O₂) is beneficial especially in combination with the wet biochar ozonization reactor process as illustrated, for example, in FIG. 8.

According to one embodiment, the wet biochar ozonization treatment process is operated with biochar completely immersed in liquid water as shown, for example, in FIG. 8. An ozone-treating gas stream, for example, O3/air, is bubbled from the bottom of the reactor through the biochar materials. The presence of excess liquid water allows the biochar particles to move up and down as the bubbling ozone-treating gas stream passes through them, which effectively extracts any water soluble substances such as biochar toxins, other dissolved organic compounds (DOC), and ash salt. Some of the O₃ gas can dissolve into the liquid water where it can destruct DOC including the potential biochar toxins while oxygenating the surfaces of biochar particles. As shown, for example, in FIG. 8, the water liquid is discharged through the flexible water inlet and outlet 606 and replenished through a water spray 618 at the upper part of the reactor for continued ozonization and cleaning of the biochar materials until the desired results are achieved. Therefore, use of this biochar liquid ozonization treatment process creates an ultraclean ozonized specialty biochar product used for special industrial applications such as making air and water filters to clean air and water. Suitable applications for these filters include, for are not limited to, home applications, and office and industrial applications in addition to biochar soil applications.

The feeding of an O₃-containing gas stream either with or without the use of water spray as shown, for example, in FIGS. 4, 5 and 6 is performed in either a continuous or a pulsed mode to optimize the operation effects when desirable. In another embodiment, the O₃-containing gas stream cleans the biochar materials so that small organic molecules (typically at a molecular mass of about 500 Dalton or smaller) are removed from the biochar products by ozone's reactions with the small aromatic organic molecules. It was recently identified in Smith, Buzan, Lee 2013 ACS Sustainable Chem. Eng. 2013, 1, 118-126 that a certain biochar phytotoxic effect is due to types of small organic molecules including certain polycyclic aromatic hydrocarbons (PAHs) at a molecular mass of about 500 Dalton (Da) or smaller that are co-produced during biomass pyrolysis. The potential biochar toxins (which as tested at a dissolved organic carbon (DOC) concentration of about 75 mg per liter with blue-green alga are toxic to plant cells) are typically soluble organic matter that include residual pyrolysis bio-oils, small organic molecules at a molecular mass of about 500 Dalton (Da) or smaller that are co-produced during biomass pyrolysis, polycyclic aromatic hydrocarbons, degraded lignin-like species rich in oxygen containing functionalities, phenolic type of phytotoxins that are now known to contain at least one carboxyl group per toxin molecule, and combinations thereof. Note, the term “degraded lignin-like species” here and throughout the specification means “degraded lignin species and/or polycyclic aromatic species with structure similar to lignin.”

According to one embodiment, the ozone (O₃) treatment destructs potential biochar toxins by selectively attacking their C═C double bounds such as the double bonds in phenolic-type and/or polycyclic aromatic hydrocarbons (R—CH═CH—R) as shown in the following process reaction.

R—CH═CH-R+O₃→R-COH+R-COOH [3]

In this example, the potential biochar toxins (R—CH═CH—R) are destructed by the ozonization reaction, forming R—COH and R—COOH species, which are typically benign. Therefore, the biochar ozonization treatment also cleans the biochar products by targeted destruction of potential biochar toxins that contain C═C double bonds, in addition to enhancing biochar-surface oxygenation for better hydrophilicity and cation exchange capacity value. Therefore, the post-production biochar surface-oxygenation-treatment process with ozone can be used, as shown, for example, in FIG. 6, to convert tons of conventional biochar materials currently available in the market quickly to clean hydrophilic products free of biochar toxin or with minimized potential biochar toxins. As used herein, “free of biochar toxin” means that the content of the potential biochar toxin (if any) is reduced to such a lower level to eliminate any toxic effect to algal culture growth when tested with a standard concentration of biochar water-extracted substances measured as 0.189 grams of dissolved organic carbon (DOC) per liter.

In contrast to the highly uncontrolled biochar production processes known in the art, exemplary embodiments of systems and methods produces a substantially uniform (i.e., substantially homogeneous) surface-oxygenated biochar. By being “substantially uniform”, the resulting biochar contains an absence of regions of non-oxygenated biochar (as commonly found in biochar material formed under uncontrolled conditions, such as in open pits) in the surface-oxygenated biochar. Preferably, a substantially uniform surface-oxygenated biochar possesses different macroscopic regions, e.g., of at least about 100 μm², 1 mm², 10 mm², or 1 cm² in size, that vary by no more than about 10%, 5%, 2%, 1%, 0.5%, or 0.1% in at least one characteristic, such as CEC, oxygen to carbon molar ratio, and surface area. The substantial uniformity of the surface-oxygenated biochar advantageously provides a user with a biochar material that provides a consistent result when distributed into soil, either packaged or in the ground. Furthermore, a substantial uniformity of the surface-oxygenated biochar ensures that a tested characteristic of the biochar is indicative of the entire batch of biochar.

In one embodiment, a substantially uniform biochar is obtained by an effective level of mixing of the biochar during the surface-oxygenation process. For example, in one embodiment, the biochar is agitated, shaken, or stirred either manually or mechanically during the ozonization and purging process. In another embodiment, the biochar is reacted with ozone in a reactor containing a tumbling mechanism such that the biochar is tumbled during the ozonization reaction.

Suitable biochar sources for use in embodiments of the systems and methods described herein include any biochar material that could benefit by the ozonization process of the inventive method. The biochar source could be, for example, a byproduct of a pyrolysis or gasification process, a material acquired from a biochar deposit and natural coal materials, for example, from coal mines. In one embodiment, the biochar is plant-derived, i.e., derived from cellulosic biomass or vegetation. Suitable biomass materials include, but are not limited to, cornstover, e.g., the leaves, husks, stalks, or cobs of corn plants, grasses, e.g., switchgrass, miscanthus, wheat straw, rice straw, barley straw, alfalfa, bamboo and hemp, sugarcane, hull or shell material, e.g., peanut, rice, and walnut hulls, any woody biomasses including dead trees such as dead pine and dead oak, Douglas fir, woodchips, saw dust, waste cardboard, paper or wood pulp, algae, aquatic plants, food waste, spent mushroom substrate, chicken litters, heifer and cow manure, horse manure, pig manure, agricultural waste, and forest waste. In one embodiment, the biomass material is in its native form, i.e., unmodified except for natural degradation processes, before being converted to biochar. In another embodiment, the biomass material is modified by, for example, adulteration with a non-biomass material, e.g., plastic- or rubber-based materials, or by physical modification, e.g., mashing, grinding, compacting, blending, heating, steaming, bleaching, nitrogenating, oxygenating, or sulfurating, before being converted to biochar.

The one or more surface-oxygenation agents considered herein are ozone and ozone-related compounds or materials known in the art that tend to be reactive by imparting oxygen-containing functional groups into organic materials (including any of the O₂ plasma, CO₂ plasma, and CO plasma that have been disclosed before). An example of a surface-oxygenating agent is O₃ in the gas form in addition to the O₃/water vapor stream, O₃/water liquid, O₃/water liquid-peroxide (H₂O₂), and O₃/carbonated water liquid form. As mentioned before, the O₃ gas may also be in the form of an artificial gas mixture, such as an O₃-oxygen (O₂)-carbon dioxide (CO₂), O₃—CO₂, O₃—CO₂-peroxide (H₂O₂), O₃—CO₂—CO (carbon monoxide), O₃-O₂-nitrogen (N₂), O₃-O₂—CO₂-argon, O₃-O₂—CO₂-helium, or O₃-O₂-CO₂—CO mixture. An artificial gas mixture can be advantageous for the purposes of the invention in that the level of O₃ can be precisely controlled, thereby further controlling the pyrolysis and ozonization reactions to optimize the density and kind of oxygen-containing functional groups in the biochar. For example, in different embodiments, it may be preferred to use an O₃—CO₂-containing gas mixture having at least, less than, or about, for example, 0.1%, 0.5%, 1%, 2%, 3%, 5%, 7%, 10%,15%, 20%, 30%, 40%, 50%, 60%, 70%, 75%, 80%, 85%, 90%, 95%, or 99% by the volume of O₃, or a range bounded by any two of the foregoing values.

In another embodiment, the biochar source can be treated with O₃ for “oxygen-implantation” onto the surfaces of the biochar materials as shown in Equation 1 above. The O₃ treatment increases the O:C molar ratios or carboxyl groups at biochar surfaces. The cation exchange capacity increases with the O:C ratio of the biochar materials. Accordingly, use of O₃ treatment can enable molecular re-engineering of biochar materials to impart unique surface properties such as the cation exchange capacity, without affecting the bulk properties of the biochar.

Preferably, the O₃ treatment is conducted at low or ambient temperature, e.g., from about 15° C. to about 30° C. The O₃ treatment process entails subjecting the biochar at ambient pressure to a source of O₃-containing gas or liquid. The O₃ is typically produced by pumping at least one of pure O₂ and ambient air (containing about 21% O₂ and 79% N₂) through an ozone generator system that utilizes a special electric field under which O₂ is converted into O₃, which is then fed into the biochar ozone treatment reactor. The particular O₃ generating and feeding conditions depend on several factors including the type of ozone generators, gas composition, power source capability and characteristics, operating pressure and temperature, the degree of ozonization required, and characteristics of the particular biochar being treated, i.e., its susceptibility or resistance to oxygenation. Depending on several factors including those mentioned above, the biochar can be exposed to the ozone treatment for at least about 0.1, 0.2, 0.5, 1, 1.5, 2, 2.5, 3, 4, or 5 minutes and up to 6, 8, 10, 12, 15, 20, 30, 40, 50, 60, 90 or 180 minutes. Although the biochar can be ozone treated within a temperature range of about 15° C. to about 30° C., a lower temperature, e.g., less than 15° C., or a higher temperature, e.g., greater than about 30° C., such as 40° C., 50° C., 60° C., 70° C., 80° C., 90° C., 100° C., 110° C., 120° C., 130° C., 140° C., 150° C., 160° C., 170° C., 180° C., 190° C., 200° C., 210° C., 220° C., 230° C., 240° C., 250° C., 260° C., 270° C., 280° C., 290° C., and 300° C., 350° C., 400° C., or a range bounded by any two of the foregoing values, may also be used under controlled conditions where the possibility of combustion is adequately suppressed in the presence of at least one of CO₂, water and steam with limited availability of O₂/O₃.

As shown in FIG. 7, extremely hot biochar can be loaded into the biochar ozonization treatment reactor system 500 that employs a double-wall coolant-jacketed ozone gas biochar reactor system to enable cooling of hot biochar by use of a coolant and outputting hot coolant for the waste heat energy recovery and utilization such as the utilization of waste heat through a heat exchange system to preheat or to dry biomass. This system also takes advantage of an inverted-V-conical-shaped porous metal plate 504 that facilitates cooling of the biochar materials within the double-wall coolant-jacketed reactor. It utilizes controlled O₃ concentration levels under a CO₂ (and/or N₂) atmosphere to prevent possible biochar combustion especially during the loading of hot biochars from a biomass pyrolysis or gasification reactor. Therefore, this biochar ozonization system 500 (FIG. 7) may be integrated with an existing biomass pyrolysis or gasification reactor to produce advanced hydrophilic biochar products.

According to one of the various embodiments, after extremely hot biochar is loaded into the biochar ozonization treatment reactor system 500 (FIG. 7) and before starting the ozonization process, the hot biochar is cooled down to a temperature below about 120° C. in the double-wall coolant-jacketed reactor system to recover the heat from hot biochar to generate hot coolant output for waste heat utilization through a heat exchange system to dry biomass and/or biochar products. This operational feature results in not only better energy efficiency through utilization of biochar waste heat but also lowering the potential biochar fire risks when in contact with the ozone-containing gas treatment stream.

According to one embodiment, the biochar ozonization treatment reactor process is operated at a pressure selected from the group consisting of ambient pressure, 0.1 atm, 0.2, 0.5, 1, 1.5, 2, 3, 4, 5, 6, 7, 8, 10, 15, 20, 25, 30, 50 or 100 atm or a range bounded by any two of the foregoing values.

Not wishing to be bound by theory, the organic contaminants, i.e., potential toxins, adsorbed on biochar surfaces are removed by oxygenation chemical reactions with highly reactive O₃. At the same time, certain O₃-enabled oxygenation chemical reactions promote surface carboxylation and sometimes hydroxylation (possibly forming carboxyl COOH groups and hydroxyl OH on the biochar carbon surfaces), which increases surface wettability and cation exchange capacity (CEC). Both the surface wettability and CEC are important properties for biochar soil applications to better retain water and nutrients for improved soil fertility as well as reduction of agricultural chemical runoff.

In one embodiment, ozone is reacted with biochar in a closed system, i.e., a closed container, to ensure that the intended amount of ozonization reactants as measured, and no less and no more, is reacted with the biochar. When an ozonizing gas or liquid (or a solution thereof) is used, a selected volume of the gas or liquid corresponding to a calculated weight or moles of the ozone can be charged into the closed container (reactor) along with the biochar source and the contents homogeneously mixed or blended under conditions suitable for ozonization of the biochar to take place. For example, the temperature of the mixed reactants in the container can be controlled along with proper agitation until the ozone gas or liquid flows and diffuses fully through the biochar materials to promote its reaction with the biochar in a uniform, i.e., homogeneous, manner.

In one embodiment, the moisture level in the ozone treatment reactor can be suitably adjusted, for example, to a humidity level of about, at least, or no more than 1%, 2%, 5%, 10%, 15, 20%, 25%, 30%, 35%, 40%, 45%, 50%, 55%, 60%, 65%, 70%, 75%, 80%, 85%, 90%, 95%, or 100%, or a humidity level within a range bounded by any two of these values.

In another embodiment, ozonization/carboxylation of biochar materials is attained by conducting the ozonization/carboxylation reactions in an open or closed container and by rapidly quenching hot biochar with O₃/CO₂-containing water (FIG. 7). The extremely hot and reacting biochar from a biomass pyrolysis or gasification reactor can be quenched by, for example, contacting the reacting biochar with an excessive amount of O₃/CO₂-containing water such as O₃/CO₂/carbonated water, and/or an inert substance, preferably when the biochar material is still hot, e.g., at a temperature of at least about 800° C., 750° C., 700° C., 650° C. 600° C. 550° C. 500° C., 450° C., 400° C., 350° C., 300° C., 250° C., 200° C., 150° C., 100° C., 50° C., or within a range bounded by any two of these values, as produced from a biomass-to-biochar process. The inert substance can be, for example, carbonates, bicarbonate or a form of biomass (e.g., soil, plant-material, or the like). An excessive amount of O₃/CO₂/carbonated water, O₃/water liquid, O₃/water liquid-peroxide (H₂O₂), O₃/carbonated water liquid, O₃/carbonated water liquid-peroxide (H₂O₂), and/or O₃/carbonates/inert substance is an amount that preferably covers all of the reacting biochar, or alternatively, functions as a bulk surface shield of the biochar, with the result that the ozonization/carboxylation process is facilitated due to the addition of the excess O₃/CO₂ to the hot biochar preferably at a pressure higher than the ambient atmospheric pressure in the reactor as shown in FIG. 7. If an elevated temperature is being used in the ozonization/carboxylation process, the quenching step also has the effect of rapidly reducing the temperature of the biochar.

The methods described herein can also include one or more preliminary steps for producing biochar, i.e., the biochar source or “produced biochar”, from biomass before the biochar is oxygenated/carboxylated. The biomass-to-biochar process can be conducted within any suitable time frame before the produced biochar is oxygenated/carboxylated.

In one embodiment, a biomass-to-biochar process is conducted in a non-integrated manner with the biochar ozonization process as shown, for example, in FIG. 6. In the non-integrated process, biochar produced by a biomass-to-biochar process is transported to a separate location where the biochar ozonization process is conducted. The transport process generally results in the cooling of the biochar to ambient temperature conditions, e.g., 15-40° C., before ozonization occurs. Typically, the produced biochar is packaged and/or stored in the non-integrated process before ozonization of the biochar.

In another embodiment, a biomass-to-biochar process is conducted in an integrated manner with a biochar ozonization process. In the integrated process, biochar produced by a biomass-to-biochar process is treated in situ using the double-wall coolant-jacketed ozone gas biochar reactor system 500 (FIG. 7) when the biochar is still very hot. For example, in the integrated embodiment, freshly produced biochar can have a temperature of, for example, about or at least 700° C., 650° C., 600° C., 550° C., 500° C., 450° C., 450° C., 400° C., 350° C., 300° C., 250° C., 200° C., 150° C., 100° C., or 50° C., or a temperature within a range bounded by any two of these values, before being subjected to the ozonization/carboxylation process. If desired, the freshly produced biochar can be subjected to additional cooling and/or heating to adjust and/or maintain its temperature before the ozonization step.

The biochar ozonization process can be integrated with, for example, a biomass-to-fuel process, such as a low temperature or high temperature pyrolysis/gasification process. In such processes, typically about 40%, 50%, or 60% of the biomass carbon is converted into biochar while the remaining 60%, 50%, or 40% of carbon is converted to fuel (syngas and bio-oils). Furthermore, since it has been found that lower temperature pyrolysis processes generally yield a biochar material with even more improved fertilizer retention properties, in one embodiment, the biochar ozonization process is integrated with a biomass pyrolysis/gasification process conducted at a temperature of about 800° C., 750° C., 700° C., 650° C., 600° C., 550° C., 500° C., 450° C., 400° C., 350° C., or 300° C. or a temperature within a range bounded by any two of these values.

According to one of the various embodiments, the biochar ozonization process is integrated with a biomass pyrolysis process operated at a temperature of about 500° C. to produce a clean hydrophilic biochar product with higher CEC value and minimized potential biochar toxins. Biochar produced from biomass pyrolysis process at around 500° C. is typically already quite clean (with minimized potential biochar toxins); however, its CEC value is often very low due to the loss of its carboxyl groups at such a high pyrolysis temperature (500° C.). In this case, the use of the biochar ozonization process enables creation of oxygen-containing functional groups on biochar surfaces at ambient temperature under ambient pressure, resulting in a better hydrophilic biochar product with higher CEC value and minimized potential toxins.

In one embodiment, an integrated process is configured as a batch process wherein separate batches of produced biochar are ozonized at different times. In another embodiment, the integrated process is configured as a continuous process wherein biochar produced by the biomass-to-biochar process is continuously subjected to an ozonization process as it is produced. For example, produced biochar can be continuously transported either manually or by an automated conveyor mechanism through a biochar ozonization zone. The automated conveyor mechanism can be, for example, a conveyor belt, a gravity-fed mechanism, or an air pressure mechanism.

In another aspect, the ozonized biochar produced herein has a particular, exceptional, or optimal set of characteristics, such as a particular, exceptional, or optimal cation exchange capacity, optimal pH value, optimal carboxyl content, optimal hydrophilicity and wettability, optimal water-holding field capacity, optimal oxygen-to-carbon molar ratio, surface area, nutrient contents, biochar particle size, composition, zero toxin content, and/or uniformity in any of these or other characteristics. The methods described herein are particularly suitable for producing these types of advanced hydrophilic biochars.

According to one of the various embodiments, the biochar ozonization treatment process has a feature that significantly increases the CEC value of biochars often by more than a factor of 2. For example, the biochar ozonization treatment can improve the CEC value of a biochar from its initial value of 80 mmol/kg to as high as 230 mmol/kg after an ozone treatment.

In one embodiment, the CEC of the ozonized biochar is at least moderate, e.g., about or at least 100, 110, 120, 130, 140, 150, 160, 170, 180, 190, 200, 210, 220, 230, 240 mmol/kg, or within a particular range bounded by any two of the foregoing values. In another embodiment, the CEC of the ozonized biochar is atypically or exceptionally high, e.g., about or at least 250, 300, 350, 400, 450, 500, 550, 600, 650, 700, 750, 800, 850, 900, 950, 1000, 1100, 1200, 1300, 1400, 1500 mmol/kg, or within a particular range bounded by any two of the foregoing values. In another embodiment, the CEC of the ozonized biochar is within a range having a minimum value selected from any of the exemplary moderate CEC values given above and a maximum value selected from any of the exemplary atypically high CEC values given above (for example, 100-1000 mmol/kg or 200-1200 mmol/kg). Preferably, the CEC value is substantially uniform throughout the biochar material.

The density of carboxy-containing cation-exchanging groups is typically proportional to the measured oxygen-to-carbon molar ratio of the biochar, wherein the higher the oxygen-to-carbon molar ratio, the greater the density of cation-exchanging groups in the biochar. In different embodiments, the oxygen-to-carbon molar ratio of the ozonized biochar surface is at least 0.1:1, 0.15:1, 0.2:1, 0.25:1, 0.3:1, 0.35:1, 0.4:1, 0.45:1, 0.50:1, 0.60:1, 0.70:1, or within a range bounded by any two of the foregoing ratios. Preferably, the ozonized biochar contains a substantially uniform density of the carboxy-containing cation-exchanging groups and a substantially uniform oxygen-to-carbon molar ratio throughout the biochar surface material.

According to another embodiment, the ozone-enabled molecular implantation of oxygen atoms into biochar carbon materials can be used also as a mechanism to remove potential biochar toxins through molecular structural destruction by the ozone-assisted implantation of oxygen atoms into the toxic organic molecules such as phenolic-type phytotoxins and polycyclic aromatic hydrocarbons (PAHs). Therefore, the destruction of potential biochar toxins, the enhancement of biochar cation exchange capacity and hydrophilicity, and the optimization of biochar pH are accomplished simultaneously through the ozone-enabled oxygenation into both the potential toxin molecules and biochar surfaces.

The ozonized biochar can have any suitable specific surface area (SSA), as commonly determined by BET analysis. In different embodiments, the ozonized biochar has an SSA value of about, or at least, or no more than 0.1, 0.5, 1, 2, 3, 4, 5, 10, 15, 20, 25, 30, 35, 40, 45, 50, 55, 60, 65, 80, 100, 200, 400, 600, or 800 m²/g, or an SSA value within a range bounded by any two of the foregoing values.

The ozonized biochar can also have any suitable charge density. In different embodiments, the ozonized biochar has a surface charge density of about, or at least, or no more than 1, 2, 3, 4, 5, 10, 15, 20, 25, 30, 35, 40, 45, 50, 55, 60, 65, 70, 75, 80, 85, 90, 95, 100, 110, or 120 mmol/m², or a charge density within a range bounded by any two of the foregoing values.

According to one of the various embodiments, use of a biochar ozonization process can achieve biochar-surface oxygenation to significantly functionalize biochar surface properties such as its cation exchange value and pH without significantly affecting some of the biochar bulk properties such as the biochar core carbon stability and elemental compositions. This feature is explained by the understanding that the biochar surface atomic layer that is accessible to ozone represents only a very small fraction of the total biochar mass. Therefore, a significant biochar-surface oxygenation by ozonization may not significantly alter the bulk properties of the biochar core carbon materials, which is desirable in maintaining biochar carbon stability for biochar soil amendment and carbon sequestration applications.

According to one of the various embodiments, the ozonized biochar can also have any suitable carbon, nitrogen, oxygen, hydrogen, phosphorous, calcium, sulfur, ash, and volatile matter content. The carbon content can be about, at least, or no more than, for example, 20, 25, 30, 35, 40, 45, 50, 55, 60, 65, 70, 75, 80, 85, 90, or 95 mole percent, or within a particular range therein. The nitrogen content can be about, at least, or no more than, for example, 0.1, 0.25, 0.5, 0.75, 1.0, 1.25, 1.5, 1.75, 2.0, 2.25, 2.5, 2.75, 3.0, 3.25, 3.5, 3.75, 4.0, 4.5, 5.0, 6.0, 7.0, or 8.0 mole percent, or within a particular range therein. The oxygen content can be about, at least, or no more than, for example, 1, 2, 5, 10, 15, 20, 25, or 30 mole percent, or within a particular range therein. The hydrogen content can be about, at least, or no more than, for example, 1, 2, 5, 10, 15, 20, 25, or 30 mole percent, or within a particular range therein. The phosphorus or calcium content can independently be about, at least, or no more than, for example, 5, 10, 25, 50, 100, 500, 1000, 5000, 7500, 10000, 15000, 20000, or 25000 mg/kg, or within a particular range therein. The sulfur content can be about, at least, or no more than, for example, 50, 100, 200, 300, 400, 500, 600, 700, 800, 900, 1000, 1500, or 2000 ppm, or within a particular range therein. The ash content can be about, at least, or no more than, for example, 1, 2.5, 5, 10, 15, 20, 30, 40, 50, 60, or 70%, or within a particular range therein. The volatile matter content can be about, at least, or no more than, for example, 1, 2.5, 5, 10, 15, 20, 25, 30, 35, or 40%, or within a particular range therein.

The ozonized biochar can also have any suitable particle size. In various embodiments, the ozonized biochar can have a particle size of about, at least, or no more than, for example, 50, 100, 250, 500, 750, 1000, 1500, 2000, 2500, 3000, 3500, 4000, 4500, or 5000 μm, or a particle size within a particular range bounded by any two of the foregoing values. In certain applications, e.g., to ensure the biochar materials are resistant to becoming airborne in windy and/or arid regions, larger biochar particle sizes, such as 6000, 7000, 8000, 9000, 10,000, 20,000, 30,000, 40,000, 50,000 μm, or higher (for example, up to 100,000 μm), or a particle size within a particular range bounded by any two of the foregoing values, may be preferred. The biochar materials may also be in the form of an agglomeration, compaction, or fusion of biochar particles, e.g., pellets or cakes, for this type of application as well. The size of the pellets or cakes can correspond, for example, to any of the larger particle sizes given above.

The term “particle size” as used above for a particular value can mean a precise or substantially monodispersed particle size, e.g., within ±0-5% of the value, or a more dispersed particle size, e.g., greater than 5% and up to, for example, about 50% or 100% of the value. In addition, the biochar particles may have a size distribution that is monomodal, bimodal, or higher modal. The term “particle size” may also refer to an average particle size. If desired, the particle size of the ozonized biochar can be appropriately modified by techniques known in the art. For example, the biochar particles may be ground, agglomerated, or sieved by any of the techniques known in the art. Furthermore, when the particles or pellets are substantially or completely spherical, the above exemplary particle or pellet sizes refer to the diameter of the particles or pellets. For particles or pellets that are non-spherical, e.g., elliptical, cylindrical, rod-like, plate-like, disc-like, rectangular, pyramidal, or amorphous, the above exemplary particle or pellet sizes can refer to at least one, two, or three of the dimensional axes of the particles or pellets.

The ozonized biochar can also have any suitable pore size. In various embodiments, the ozonized biochar can have a pore size of about, at least, or no more than, for example, 0.5, 1, 1.5, 2, 2.5, 3, 3.5, 4, 4.5, 5, 6, 7, 8, 9, 10, 20, 30, 40, 50, 100, 250, 500, 750, 1000, 1500, 2000, 2500, 5000, 6000, 7000, 8000, 9000, 10,000, 20,000, 30,000, 40,000, 50,000, 60,000, 70,000, 80,000, 90,000 or 100,000 nm, or a pore size within a particular range bounded by any two of the foregoing values.

The ozonized biochar can also have any suitable pH value. Some of the conventional biochar materials, for example, those made from high-temperature pyrolysis or gasification processes, typically have an alkaline pH ranged from about pH 8.5 up to about pH 12, which are not ideal for use in many regions such as those in the western regions of the United States where the soil pH is already above pH 8.0. According to one of the various embodiments, use of the ozonization treatment can reduce the pH value of biochar through the formation of acidic carboxyl groups at biochar surfaces and/or by the formation and adsorption of nitrogen oxides/nitric acid during a biochar ozonization process in the presence of N₂. In various embodiments, depending on biochar ash contents, the ozonized biochar can have an optimized pH value of about, at least, or no more than, for example, 3, 3.5, 4, 4.5, 5, 6, 7, 8, 9, 10, 11, or a pH value within a particular range bounded by any two of the foregoing values.

The ozonized biochar, such as produced by the method described above, may also be admixed, i.e., enriched, with one or more soil-fertilizing compounds or materials for use as a fertilizing biochar soil amendment or additive and carbon sequestration agent. The soil-fertilizing compounds or materials can be, for example, nitrogen-based, e.g., ammonium-based, carbonate-based, e.g., CaCO₃, phosphate-based, e.g., the known phosphate minerals, such as in rock phosphate or triple superphosphate, and potassium-based, e.g., KCl. In one embodiment, the one or more soil-fertilizing compounds or materials include at least one nitrogen-containing, for example, NH₄⁺-containing, compound or material. Some examples of nitrogen-containing fertilizing compounds or materials include, for example, (NH₄)₂CO₃, NH₄HCO₃, NH₄NO₃, (NH₄)₂SO₄, (NH₂)₂CO, biuret, triazine-based materials, e.g., melamine or cyanuric acid, urea-formaldehyde resin, and polyamine or polyimine polymers. The fertilizer material may be inorganic, as above, or alternatively, organic. Some examples of organic fertilizer materials include peat moss, manure, insect material, seaweed, sewage, and guano. The biochar material can be treated by any of the methods known in the art in order to combine the biochar material with a fertilizer. In a particular embodiment, the biochar material is treated with a gas stream of hydrated ammonia to saturate the biochar material. The biochar material may also be coated with fertilizer compounds or materials. The coating may also be suitably modified or optimized as known in the art to adjust the rate of release of one or more fertilizer compounds or materials into soil. In another embodiment, one or more of the above generic or specific soil-fertilizing compounds or materials are excluded from the ozonized biochar composition.

In another embodiment, the invention is directed to a soil formulation containing, at a minimum, soil admixed with the biochar composition described above. The soil can be of any type and composition. For example, the soil can have any of the numerous and diverse proportions of clay, sand, and silt. The sand, silt, and clay components can be independently present in an amount ranging from substantially absent, i.e., zero weight percent or in trace amounts, up to about 100 weight percent, e.g., exactly 100% or at least 98 or 99%. In different embodiments, one or more of the sand, silt, and clay components are in an amount of, independently, about, at least, or no more than, for example, 0.1, 0.5, 1, 2, 5, 10, 15, 20, 25, 30, 35, 40, 45, 50, 55, 60, 65, 70, 75, 80, 85, 90, or 95 weight percent of the total weight of the soil absent the biochar. The soil may also preferably have one or more of the sand, silt, and clay components present in an amount within a range bounded by any two of the foregoing exemplary weight percentages. The soil can also contain any amount of humus and humic substances, i.e., organic matter, humic acid, fulvic acid, cellulose, lignin, peat, or other such component, in any of the exemplary amounts or ranges given above.

According to another embodiment, an ozonized biochar can remove certain industrial organic molecules such as methylene blue dye 5 times better than the untreated biochar.

According to one of the various embodiments, the ozonized biochar can be used as filtration materials to remove various cations and pollutants from fluid streams including water and air. This embodiment is also directed to the use of certain ozonized biochar materials for other environmental or industrial applications such as the formulation and production of ozonized biochar columns or filters for filtration of fluids, including, for example, water, air and other solvents. During the filtration process, various cations and/or pollutants in the medium such as water and air will be in contact with the ozonized biochars in the columns and filters thereby are removed through cation exchange binding and/or physical chemistry adsorption on the ozonized biochar materials. In many cases, the used biochar columns and filters can be readily disposed by combustion cleanly back to air CO₂ and H₂O. For certain biochar columns and filters after used in removal of certain heavy metal ions such as, for example, Cu²⁺, they can also be combusted to retain their adsorbed heavy metal content in a relatively small amount of the resultant ash that can also be readily disposed by other proper ways as well. In other aspects, the biochar materials may be disposed by burying into soil at certain proper locations consistent with the practices of both waste disposal and biochar carbon sequestration. Since the biomass-derived and ozonized biochar materials are completely renewable, the use of ozonized biochar materials for filtration applications disclosed herein is another sustainable green-clean technology to remove various cations and pollutants in waters and air. Accordingly, ozonized biochar columns and filters may be used to remove various cations, contaminants, and pollutants selected from the group consisting of ammonium (NH₄⁺), Li⁺, Ba²⁺, Fe²⁺, Fe³⁺, Cu⁺, Cu²⁺, Cd²⁺, Cs⁺, Sr²⁺, Ni²⁺, Zn²⁺, Cr³⁺, Pb²⁺, Hg²⁺, other metal ions including uranium ions, plutonium ions, osmium ions, platinum ions, gold ions, iridium ions, ruthenium ions, rhodium ions, cobalt ions, titanium ions, thallium ions, tin ions, indium ions, gallium ions, germanium species and germanium compounds, arsenic species and arsenic compounds, selenium species and selenium compounds, and organic and/or inorganic molecules including certain pollutants in waters, air and other environmental and industrial media as well.

Biochar Ozonization in Combination with Sonication

The present invention here further comprises an improved method for industrial production and utilization of surface-oxygenated biochar composition through ozonization in combination with sonication. The improved method comprises at least one of the following steps: 1) treating a biochar source with sonication and an ozone-containing gas stream in a biochar sonication-ozonization treatment reactor system using a sonication-ozonization-enabled biochar-surface oxygenation operational process, wherein treating the biochar source comprises: 2) contacting the biochar source with the ozone-containing gas stream; 3) enabling biochar-surface oxygenation; 3) destroying a potential biochar toxin; 5) producing a surface-oxygenated biochar composition having enhanced cation exchange capacity; 6) producing a special surface-oxygenated biochar composition for solubilizing phosphorus from insoluble phosphate materials for producing phosphate fertilizers without using strong industrial acids; 7) producing a special surface-oxygenated biochar paste composition for sand soilization; and 8) producing a special surface-oxygenated biochar composition having an enhanced filtration property as exemplified in methylene blue adsorption capability for removing at least one contaminant from a medium selected from the group consisting of water and air including odor removal.

According to one of the various embodiments, the biochar source composition comprises a carbon product or recalcitrant biomass material selected from the group consisting of charcoals from a slow biomass pyrolysis process, charcoals from a fast biomass pyrolysis process, biochar from flash pyrolysis (typically, 815-871° C., residence time about 30 seconds) of biomass, charcoals from a biomass gasification (typically, >700° C.) process, hydrochars from a biomass hydrothermal carbonization process, a material acquired from a biochar deposit, natural coal materials, lignin residues, lignin cellulosic materials, carboxymethyl cellulose, un-hydrolyzed biomass residues such as un-hydrolyzed corn stover residues, recalcitrant biomasses, and a combination thereof.

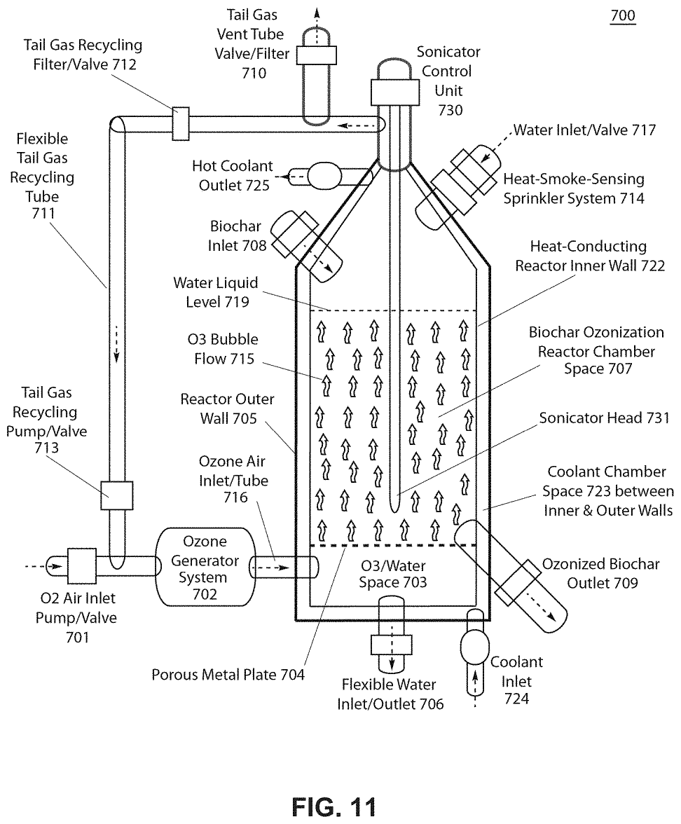

According to one of the various embodiments, biochar ozonization is performed in combination with sonication. Referring to FIG. 11, this embodiment of a sonication-enhanced biochar ozonization treatment reactor system 700 comprises a sonication control unit 730 which comprises an input end in contact with ultrasonic transducer and a sonication output head 731 in contact with liquid in a biochar ozonization reactor chamber space 707, a heat-conducting reactor inner wall 722, a reactor outer wall 705, a coolant chamber space 723 formed between the inner wall 722 and outer wall 705, a coolant inlet 724 connected with the coolant chamber space at the bottom part of the reactor, a hot coolant outlet 725 connected with the coolant chamber space at the top part of the reactor, an O₂ air inlet pump and valve 701, an ozone generator system 752, an ozone air inlet and tube 716 passing through the biochar sonication-ozonization reactor out wall 705 and inner wall 722 near its bottom, an ozone O₃/water space 703 at the bottom of the reactor, a porous metal plate 704, a biochar sonication-ozonization reactor chamber space 707 above the porous metal plate 704, a biochar inlet 708 passing through the biochar ozonization reactor double walls at the upper part of the reactor, an O₃ bubble 715 flowing from the O₃/water space 703 at the bottom through the porous metal plate and the biochar materials toward the upper part of the reactor, a tail gas vent valve and filter 710, a flexible tail gas recycling tube 711 equipped with its filter and valve 712, a pump and valve 713 connected from the tail gas vent tube 710 to the air inlet 701, a heat-smoke-sensing sprinkler system 714 equipped with water inlet 717, a water liquid level 719 at the upper part of the reactor, an ozonized biochar outlet 709 passing through the reactor double walls at the lower part of the reactor, and a flexible water inlet and outlet valve 706 at the bottom of the reactor.

According to one of the various embodiments, the sonication-ozonization-enabled biochar-surface oxygenation system (FIG. 11) operational process comprises a liquid biochar sonication-ozonization treatment operational process with the following process steps that may be operated in combination with the use of hydrogen peroxide: a) loading biochar materials into a reactor through a biochar inlet; b) monitoring and adjusting biochar temperature; c) monitoring biochar water content and liquid level in the reactor; d) based on a required biochar water content and liquid level, adding at least one of water, steam and vapor into the biochar materials using at least one of a heat-smoke-sensing sprinkler system with a water inlet and water spray system located at a top of the reactor and a flexible water inlet and outlet valve at a bottom of the reactor; e) performing sonication using the sonication control unit which comprises an input end in contact with ultrasonic transducer and a sonication output head in contact with liquid in a biochar ozonization reactor chamber space; f) pumping an oxygen-containing source gas stream through an ozone generator system to generate ozone; g) feeding ozone-containing gas stream into a reactor chamber space through a porous metal plate above an ozone air space by controlling an air pump fan speed; h) using a flexible inlet and outlet valve at the bottom of the reactor to introduce additional gas components into the treating gas stream to manipulate the biochar ozonization process; i) using a flexible tail gas recycling tube having a filter and valve and pump and valve to re-use at least part of tail gas; j) allowing sufficient time for the ozone-containing stream to diffuse through and interact with biochar particles while controlling and monitoring treatment conditions to oxygenate biochar surfaces and destroy potential biochar toxins by using ozone to react with C═C double bonds of biochar and its potential toxins; k) discharging residual ozonized liquid at the bottom of the reactor through a flexible water inlet and outlet; 1) harvesting the ozonized biochar products through an ozonized biochar outlet using gravity.

According to one of the various embodiments, an exemplary process of the sonication-ozonization-enabled biochar-surface oxygenation system (FIG. 11) uses the steps a) through l) of the liquid biochar sonication-ozonization treatment operational process for a plurality or series of operational cycles to achieve more desirable results in accordance of the present invention. Any one of the steps a) through l) of this process can be adjusted or modified as desired for certain specific operational conditions. For example, as shown in FIG. 11, after the steps of performing sonication-ozonization e) through j), these steps may be repeated for a number of times to ensure the biochar feedstocks are fully sonicated and ozonized before k) discharging and l) harvesting. Any one of the steps a) through l) of the process can be applied in whole or in part and in any adjusted combination for production of the desired surface-oxygenated biochar compositions including biochar paste products, which may be valuable to a number of innovative applications such as phosphorous solubilization from “insoluble” phosphate materials and/or sand soilization for agricultural and environmental sustainability.

According to one of the various embodiments, treating the source biochar composition with sonication comprises using a sonication control unit comprising an input end in contact with an ultrasonic transducer and a sonication output head in communication with the ultrasonic transducer and disposed in the volume of liquid to expose the biochar composition to ultrasonic frequencies.

According to one of the various embodiments, sonication enhances biochar ozonization process through at least one of the following three mechanisms: 1) Sonication force may physically loose up and/or break up biochar materials such as exfoliating graphite-type biochar materials (including graphite and/or graphite oxides) to produce biochar-derived organic matters such as the graphene-types of biochar molecules such as fragmented graphene and graphene oxides; 2) Sonication process enhances mixing and mass transfer of ozone gas with liquid water and biochar particles; and 3) Ultra sonication at a frequency of above 15 kHz producing reactive oxygen radical, hydroxyl and peroxyl radicals from the sonochemistry of O₂-dissolved water that may also enhance biochar surface oxygenation.

According to one of the various embodiments, ozonization of fragmented graphene and graphene oxides generates partially oxygenated poly aromatic carbon molecules similar to humic acids. Therefore, the sonication-enhanced biochar ozonization process can convert conventional biochar materials into “humic-acids-like” substances and/or biochar paste materials. For an example, the humic-acids-like substances that are produced from this process are partially oxygenated graphene-like molecules and/or partially oxygenated graphene molecular fragments. The biochar “humic-acids-like substances” here are defined as surface-oxygenated biochar derived organic matters that are similar to humic acids in their structures and functions.

According to one of the various embodiments, in addition to biochar surface oxygenation, the processing technology of surface-oxygenation through ozonization in combination with sonication may be applied also to other recalcitrant biomass materials selected from the group consisting of lignin residues, lignin cellulosic materials, carboxymethyl cellulose, un-hydrolyzed biomass residues such as un-hydrolyzed corn stover residues, recalcitrant biomass residues, and combinations thereof.

According to one of the various embodiments, the sonication-ozonization process can be used to treat many different carbon materials including but not limited to hydrochar, slow-pyrolysis biochar, fast pyrolysis biochar, and gasification char.

According to one of the various embodiments, the liquid sonication of biochar materials produces a biochar paste, which is a black viscous fluid of the sonicated fine (mostly sub-millimeter) surface-oxygenated amorphous carbon particles and biochar molecular species including dissolved organic molecular carbons and organic acids in the presence of water. The biochar paste may be ozonized to generate partially oxygenated biochar molecules including biochar molecular carboxylic acids. Again, the sonication-enhanced biochar ozonization process can convert tons of conventional biochar materials into surface-oxygenated biochar-derived organic matters including “humic acids like” substances and/or biochar paste materials that can be immediately applied into soil for agriculture and environmental sustainability.

According to one of the various embodiments, the surface-oxygenated biochar composition produced from the biochar sonication-ozonization reactor process (FIG. 11) is a biochar paste product which comprises surface-oxygenated biochar-derived organic matters including humic-like substances that are selected from the group consisting of surface-oxygenated biochar particles, surface-oxygenated amorphous carbon particles, surface-oxygenated graphite particles, partially oxygenated graphene, partially oxygenated graphene-like molecules, partially oxygenated graphene molecular fragments, partially oxygenated linear hydrocarbons, partially oxygenated aromatic compounds, partially oxygenated polycyclic aromatic hydrocarbons, dissolved organic carbons including organic acids, and combinations thereof.

According to one of the various embodiments, a significant beneficial feature of the surface-oxygenated biochar paste product is that it is a highly functionalized biochar molecular material which is much more powerful than the conventional biochar for agricultural application. A conventional biochar material in the current market is typically a solid carbon material with a grain size in a range from a few mm to tens of mm, which often has a quite limited cation exchange capacity often not much higher than that of a typical soil. Consequently, it often requires more than ten tons of conventional biochar materials per acre for use as soil amendment since most of the conventional biochar materials as solid carbon grains just sitting there in soil with quite limited functionality to improving soil fertility properties. On the other hand, the sonicated surface-oxygenated biochar paste product as a highly functionalized biochar molecular material can provide much more functionality per carbon mass to improve soil fertility properties. Therefore, the sonicated biochar paste product with fine (mostly sub-millimeter) surface-oxygenated amorphous carbon particles and dissolved organic molecular carbons can significantly reduce the required amount of biochar carbon usage per acre by more than a factor of ten while providing better benefits for sustainable agricultural productivity. This can translate to a significant cost reduction while providing better benefits for the end users such as farmers. For example, the surface-oxygenated biochar paste product liquid is used as part of irrigation into the crop root zones so that it needs less a ton of biochar carbon material per acre to help solubilizing phosphorus from the “insoluble” phosphate material in certain soils for crop to uptake (see more details on surface oxygenated biochar for phosphorous sustainability below).

### Surface Oxygenated Biochar for Phosphorous Sustainability

Phosphorus sustainability has recently been identified as one of the major issues for long-term agricultural and environmental sustainability on Earth. Conventionally, the wet and thermal routes are the main ways to manufacture phosphate fertilizers. The wet route typically requires the use of strong industrial acids such as sulfuric acid, nitric acid, and/or hydrochloric acid to solubilize phosphate from phosphate rock materials such as hydroxyapatite: Ca₁₀(PO₄)₆(OH)₂ and fluorapatite: Ca₅(PO₄)₃F. The thermal route is represented by thermophosphate. Both routes are quite energy intensive and not very environmentally friendly. Any environmentally friendly technology that could solubilize phosphorus from insoluble phosphate materials such as hydroxyapatite without requiring the use of strong industrial acids such as hydrochloric acid would be valuable to addressing the phosphorus sustainability issue for long-term agricultural and environmental sustainability. The present invention here discloses a method on using the green chemistry with ozonized biochar to provide a novel approach to solubilize phosphorus from calcium phosphate rock materials and/or insoluble soil phosphate mineral phases, which may lead to a new technological pathway for producing phosphate fertilizers or making phosphorus available in soils for crop plants to uptake without using strong industrial acids.

According to one of the various embodiments, ozonized biochar (Biochar-COOH) may be used to help solubilize phosphate from “insoluble” phosphate rock materials such as hydroxyapatite, Ca₁₀(PO₄)₆(OH)₂, through a phosphorous solubilization reaction such as:

Ca₁₀(PO₄)₆(OH)₂+Biochar-COOH→HPO₄²⁻+Ca₉(PO₄)₅(OH)₂⁺+Biochar-(COOCa)⁺ [4]

For example, this inventive concept has now been experimentally demonstrated: Incubation of hydroxyapatite (0.5 g) in 20 ml water with 1 g of ozonized biochar (Biochar-COOH) for 2 days under ambient pressure and temperature conditions resulted in a solubilized phosphate concentration as high as 272±9 mg/L (equivalent to the phosphorus (P) concentration of 88.7±2.9 ppm or mg P/L), while that of the control mixture of hydroxyapatite and water was 25±1 mg/L (8.2±0.3 mg P/L). The incubation of hydroxyapatite and water with the non-ozonized conventional biochar resulted in a solubilized phosphate concentration of 42±9 mg/L (13.7±2.9 mg P/L).

According to one of the various embodiments, the surface-oxygenated biochar composition may be used to solubilize phosphorous from “insoluble” phosphate materials such as hydroxyapatite or fluorapatite for phosphorous sustainability by at least one of the following “green chemistry” molecular mechanisms of unlocking phosphorus from insoluble phosphate materials selected from the group consisting of: a) Protonic effect including the effect of protons from the organic acid groups such as carboxylic acids of ozonized biochar on “insoluble” phosphate rock materials, which for example can kick phosphate out of the hydroxyapatite structure resulting in solubilized phosphate; b) Cation exchange including the effect of calcium complexation with the deprotonated biochar carboxylate groups (such as Biochar-(COOCa)⁺ and/or Biochar-(COO)₂Ca)) on biochar surfaces and/or biochar molecules and its associated dissolved organic acids that takes calcium away from the “insoluble” phosphate rock materials such as hydroxyapatite structure and thus thermodynamically favors the release of phosphate from the “insoluble” phosphate rock materials; c) Anion exchange including the effect of anions such as the deprotonated biochar carboxylate groups and its associated dissolved organic acids in exchange with the phosphate (anion) of the insoluble phosphate materials thus thermodynamically favors its phosphorus release; and d) combinations thereof.

According to one of the various embodiments, the surface-oxygenated biochar composition may help solubilizing phosphorus from at least one of the “insoluble” phosphate rock materials that comprise: ground soft rock phosphate, Ca₁₀(PO₄)₆(OH)₂ (hydroxyapatite), Ca₅(PO₄)₃F (fluorapatite), and phosphorite (also known as phosphate rock or rock phosphate) which typically is a non-detrital sedimentary rock which contains high amounts of phosphate minerals such as the peloidal phosphorite (Phosphoria Formation, Simplot Mine, Idaho) and the fossiliferous peloidal phosphorite (Yunnan Province, China). The phosphate content of phosphorite (or grade of phosphate rock) varies greatly, from 4% to 20% phosphorus pentoxide (P₂O₅). Marketed phosphate rock is enriched (“beneficiated”) to at least 28%, often more than 30% P₂O₅. This is achieved typically through washing, screening, de-liming, magnetic separation or flotation.

According to one of the various embodiments, the surface-oxygenated biochar composition may be used to mix with phosphate rock powders and/or ground soft rock phosphate to make slow-releasing phosphorus and calcium fertilizers with surface-oxygenated biochar; wherein the content of phosphate rock powders in the mixture of phosphate rock powers and surface-oxygenated biochar composition can be about, at least, or no more than, for example, 0.00001%, 0.00005%, 0.0001%, 0.0005%, 0.001%, 0.005%, 0.01%, 0.05%, 0.1%, 0.2%, 0.5%, 1%, 2%, 3%, 4%, 5%, 6%, 7%, 8%, 9%, 10%, 12%, 15%, 20%, 25%, 30%, 35%, 40%, 45%, 50%, 55%, 60%, 65%, 70%, 75%, 80%, 85%, 90%, 95%, or 99% weight percent, or within a particular range therein.

According to one of the various embodiments, the approach of ozonized biochar for phosphorous sustainability works better than the conventional technology such as the use of strong industrial acids such as chloric acid (HCl) because of the following three reasons. 1) Production and use of ozonized biochar derived from waste biomass represents a renewable green-chemistry process; whereas production and use of strong industrial acids such as HCl is energy intensive and highly hazardous (corrosive); 2) The use of strong industrial acids such as chloric acid (HCl) does not provide the benefit of calcium complexation with an organic acid ligand (deprotonated biochar carboxylate group) on biochar surfaces and/or biochar molecules; And 3) strong industrial acids such as chloric acid (HCl) are so corrosive that typically are not environmentally friendly to use in agriculture soil environment whereas ozonized biochar (Biochar-COOH) that carries gentle carboxyl acid groups are more suitable to agriculture soil application.

Furthermore, many agricultural soils naturally contain significant amounts of “insoluble” phosphate materials which crop plants commonly cannot utilize. The green chemistry of phosphorus solubilization with surface-oxygenated biochar might also have practical implications to “unlock” phosphorus from some of these “insoluble” phosphate materials in soils and thus reduce phosphorus fertilizer additions required to achieve desired soil phosphorus activity, crop uptake, and yield goals. The present invention on phosphorus solubilization with surface-oxygenated biochar disclosed here has practical implications in achieving phosphorus sustainability and as well as biochar-associated benefits such as helping better retaining soil nutrients and carbon sequestration for agricultural and environmental sustainability.

According to one of the various embodiments, the “insoluble” phosphate materials in soils include (but are not limited to): phosphorus containing minerals (mostly apatites: Ca₁₀X(PO₄)₆, where X=F⁻, Cl⁻, OH⁻ or CO₃²⁻) from parent rocks; the various precipitated Ca-phosphates, such as Ca(H₂PO4)₂.H₂O (monocalcium phosphate), CaHPO₄.2H₂O (dicalcium phosphate dihydrate=brushite), CaHPO₄ (dicalcium phosphate=monetite), Ca₈H₂(PO₄)₆.5H₂O (octacalcium phosphate), Ca₅(PO₄)₃OH (hydroxyapatite), and Ca₅(PO₄)₃F (fluoroapatite); and precipitated Al- and Fe-phosphates such as variscite (AlPO₄.2H₂O), strengite (FePO₄.2H₂O), and vivianite [(Fe₃(PO₄)₂.8H₂O)].

According to one of the various embodiments, the surface-oxygenated biochar composition may be applied into the root zone of agricultural soils to help unlock phosphorus from the “insoluble” phosphate material there for crop to uptake with a number of application techniques selected from the group consisting of: 1) mixing surface-oxygenated biochar with soils under wet and calm (non-windy) conditions during plowing of a field and/or tillage practices; 2) mixing and/or coating certain seeds such as wheat, soybean, and peanuts with certain surface-oxygenated biochar composition so that the seeds and surface-oxygenated biochar composition are co-inserted into soil during sowing; 3) placing surface-oxygenated biochar composition into soil during planting of seedlings; 4) using surface-oxygenated biochar paste and/or liquid as an irrigation into the crop root zones; and 5) combinations thereof.

According to one of the various embodiments, the content of the applied surface-oxygenated biochar composition in a soil mixture can be about, at least, or no more than, for example, 0.00001%, 0.00005%, 0.0001%, 0.0005%, 0.001%, 0.002%, 0.005%, 0.01%, 0.02%, 0.05%, 0.1%, 0.15%, 0.2%, 0.3%, 0.4%, 0.5%, 0.6%, 0.7%, 0.8%, 0.8%, 0.9%, 1%, 1.5%, 2%, 2.5%, 3%, 3.5%, 5%, 6%, 7%, 8%, 9%, 10%, 11%, 12%, 13%, 14%, 15%, 16%, 18%, 20%, 25%, 30%, 35%, 40%, 45%, 50%, 55%, 60%, 65%, 70%, 75%, 80%, 85%, 90%, 95%, or 99% weight percent, or within a particular range therein.

According to one of the various embodiments, the surface-oxygenated biochar composition may help to enhance phosphorus availability for plant uptake by unlocking phosphorus with surface-oxygenated biochar-enabled phosphorus solubilization from the soil insoluble phosphate mineral phases comprising at least one of the “insoluble” phosphate materials selected from the group consisting of soil phosphate rock particles and mineral minerals (mostly apatites: Ca₁₀X(PO₄)₆, where X=F⁻, Cl⁻, OH⁻ or CO₃²⁻) from parent rocks; the various precipitated Ca-phosphates including Ca(H₂PO₄)₂.H₂O (monocalcium phosphate), CaHPO₄.2H₂O (dicalcium phosphate dihydrate=brushite), CaHPO₄ (dicalcium phosphate=monetite), Ca₈H₂(PO₄)₆.5H₂O (octacalcium phosphate), Ca₅(PO₄)₃OH (hydroxyapatite), and Ca₅(PO₄)₃F (fluoroapatite); precipitated Al- and Fe-phosphates including variscite (AlPO₄.2H₂O), strengite (FePO₄.2H₂O), and vivianite [(Fe₃(PO₄)₂.8H₂O)]; and combinations thereof.

According to one of the various embodiments, in highly weathered acidic soils rich in Al- and Fe-oxides (e.g., Ferralsols that pre-dominate in subtropical and tropical regions), inorganic phosphorus (Pᵢ) is strongly sorbed onto the edges of silicate clay minerals and to pedogenic Al- and Fe-oxides. Over time, the inorganic phosphorus sorption may become gradually stronger by a slow diffusion of phosphate into micropores forming “occluded P” or even transitions to precipitated Al- and Fe-phosphates. This process, contributing to the low efficiency of fertilizer P in low pH soils, may be partly avoided or reversed by application of surface-oxygenated biochar composition and its dissolved organic carbons including biochar organic acids, low molecular organic anions and higher molecular organic anions such as anions of surface-oxygenated biochar derived fulvic and humic-like acids that can compete with phosphate anions through anion exchange for positively charged binding sites thus favoring phosphorus release. Chelating biochar organic anions may also contribute to the phosphate desorption.

According to one of the various embodiments, phosphorus solubilization in certain acidic soils is accomplished through anion exchange by mixing the soils with surface-oxygenated biochar paste product which comprises surface-oxygenated biochar-derived organic anions such as humic-like substances that are selected from the group consisting of surface-oxygenated biochar particles, surface-oxygenated biochar-derived organic matters, surface-oxygenated amorphous carbon particles, surface-oxygenated graphite particles, partially oxygenated graphene, partially oxygenated graphene-like molecules, partially oxygenated graphene molecular fragments, partially oxygenated linear hydrocarbons, partially oxygenated aromatic compounds, partially oxygenated polycyclic aromatic hydrocarbons, dissolved organic carbons including organic acids, and combinations thereof.

Therefore, according to one of the various embodiments, phosphorus solubilization may be accomplished by application of the surface-oxygenated biochar composition in various soils including certain alkaline soils, pH neutral soils and acidic soils through the effect selected from the group consisting of the protonic effect, cation exchange, anion exchange and combinations thereof.

According to one of the various embodiments, the application of surface-oxygenated biochar composition by mixing with certain soils can result in a solubilized phosphorus concentration that is, at least, 100% higher than the critical P concentration of 0.15 ppm, which is the P concentration in soil solution that is required for crop plant growth (Matula 2011 Plant Soil and Environment, 57(7): p. 307-314).

### Surface-Oxygenated Biochar Composition for Desert Sand Soilization

According to one of the various embodiments, the surface-oxygenated biochar paste materials including the “humic acids like” substances produced from the sonication-enhanced biochar ozonization process can be used to convert desert sands into useful soil, which can help better retain water and nutrients. Sand (silica, silicon dioxide) particles typically have negative surface charges. The principal mechanism by which sand (silica) surfaces acquire a negative charge is the dissociation (deprotonation) of silanol groups:

Sand-SiOH→Sand-SiO⁻+H⁺ [5]

Use of “humic acids like” surface-oxygenated biochar organic molecular species that have at least two carboxyl groups per molecule (⁻COO—R—COO⁻) in combination with other biomass materials selected from the group consisting of lignin cellulosic materials, carboxymethyl cellulose, un-hydrolyzed biomass residues such as un-hydrolyzed cornstover residues, lignin residues, recalcitrant biomass residues, humic substances, and combinations thereof; and in combination with certain cations selected from the group consisting of Ca²⁺, Mg²⁺, Fe²⁺, and Fe³⁺ can form a type of ionic cross-linking structures that may create a type of jelly state to better retain water and nutrients and hold sand particles together:

2Sand-SiO⁻+⁻COO—R-COO⁻+Ca²⁺→Sand-SiO.Ca.COO—R—COO.Ca.SiO-Sand [6]

Consequently, the surface-oxygenated biochar paste products may act like a gelator or a liquid gel-forming material in the spaces among sand particles that can help to retain much more water (and nutrients) and hold sand particles together, resulting in a novel “sand soilization” effect. The liquid gel-forming activity of surface-oxygenated biochar paste compositions in the spaces among sand particles can retain water and nutrients and hold the sand particles together through at least one of the noncovalent interactions selected from the group consisting of: 1) the ionic (Coulombic) interactions that are the electrostatic interactions between charged species as shown in equation 5 above for example; 2) the hydrogen bond effects of the surface-oxygenated biochar molecular species with water and sands; 3) the π-π interactions between aromatic structures; and 4) the van der Waals interactions among sands and surface-oxygenated biochar molecular species with water.

Therefore, the surface-oxygenated biochar compositions including the biochar paste product may be used for sand soilization by their liquid gel-forming activity in the spaces among sand particles that can retain water and nutrients and hold the sand particles together through at least one of the following noncovalent interactions: 1) the ionic (Coulombic) interactions that are the electrostatic interactions between charged species; 2) the hydrogen bond effects of the surface-oxygenated biochar molecular species with water and sands; 3) the π-π interactions between aromatic structures; and 4) the van der Waals interactions among sands and surface-oxygenated biochar molecular species with water.

According to one of the various embodiments, the surface-oxygenated biochar compositions including the biochar paste product typically has high cation exchange capacity which is the key property that is central to help retain soil water and nutrients. Therefore, the use of surface-oxygenated biochar compositions in mixing with sands for sand soilization also help to better retain water and plant nutrients is fundamentally important to agricultural and environmental sustainability. This “sand soilization” effect, which helps in retaining water and holding sand particles together, may be used as a way to reduce the likelihood of sands becoming airborne with winds and thus may be used also as a way to help minimize desert sand storms.

According to one of the various embodiments, divalent cation solutions such as CaCl₂ and/or MgCl₂ solution may be used to spray on the surface of sands to anchor the sands and/or soils with and/or without surface-oxygenated biochar paste compositions depending on the consideration of specific environmental conditions.

According to one of the various embodiments, the surface-oxygenated biochar compositions-enhanced sand soilization has a special characteristic that the mixture of sands and surface-oxygenated biochar materials retains much more water and nutrients and hold the sand particles together so that the sands will less likely become airborne with winds than the control sands. As demonstrated experimentally, the surface-oxygenated biochar composition treated sands retain water for much longer time than the control sands so that the surface-oxygenated biochar treated sands will less likely to flow with gravity than the control sands when the sand plates are tilted up to 90 degrees.

According to one of the various embodiments, the content of surface-oxygenated biochar composition in the sands mixture for sand soilization can be about, at least, or no more than, for example, 0.00001%, 0.00005%, 0.0001%, 0.0005%, 0.001%, 0.002%, 0.005%, 0.01%, 0.02%, 0.05%, 0.1%, 0.15%, 0.2%, 0.3%, 0.4%, 0.5%, 0.6%, 0.7%, 0.8%, 0.8%, 0.9%, 1%, 1.5%, 2%, 2.5%, 3%, 3.5%, 5%, 6%, 7%, 8%, 9%, 10%, 11%, 12%, 13%, 14%, 15%, 16%, 18%, 20%, 25%, 30%, 35%, 40%, 45%, 50%, 55%, 60%, 65%, 70%, 75%, 80%, 85%, 90%, 95%, or 99% weight percent, or within a particular range therein.

According to one of the various embodiments, the surface-oxygenated biochar compositions comprise certain amounts of beneficial humic acids-like substances including certain partially oxygenated dissolved organic carbons (DOC) that can stimulate green plant growth when used at a proper DOC concentration selected from the group consisting of: 0.1 ppm, 0.2 ppm, 0.5 ppm, 1 ppm, 2 ppm, 3 ppm, 5 ppm, 8 ppm 10 ppm, 12 ppm, 15 ppm, 20 ppm, 25 ppm, 30 ppm, 40 ppm, 50 ppm, 100 ppm, 200 ppm, 500 ppm, 1000 ppm or a DOC concentration within a particular range bounded by any two of the foregoing values.

According to one of the various embodiments, the surface-oxygenated biochar compositions may be used to reduce and/or remove the offensive odor associated with manure applications and to reduce agriculture chemical runoff. The surface-oxygenated biochar compositions can absorb the offensive odor from manures significantly better than conventional biochar. For example, surface-oxygenated biochar can absorb the ammonia (NH₃) gas odor through its reaction with the biochar molecular carboxylic acid (Biochar-COOH) to form ammonium carboxylate on ozonized biochar surface (Biochar-COONH₄). The surface-oxygenated biochar compositions can be used to reduce the offensive odor associated with manures selected from the group consisting of pig manure, cow manure, buffalo manure, sheep manure, horse manure, donkey manure, camel manure, chicken manure, duke manure, goose manure, turkey manure, human manure, and dog manure, zoo animal manures, and combinations thereof.

According to one of the various embodiments, when the biochar-producing thermal biomass carbonization process is finished, the raw biochar pieces are often too large for practical use so that they are resized at a crushing and screening workstation. The output produces typically five sizes: Chip (size 1″ to 3 mm), Medium (grain size: 3 mm to US Standard 25 mesh (0.71 mm)), Small (25 mesh (0.71 mm) to 50 mesh (0.300 mm)), Powder (50 mesh (0.300 mm) and under), and Fine Power (140 mesh (0.105 mm) and under). Technically, any of these biochar particle sizes may be used in a biochar-surface oxygenation process through sonication and ozonization. Biochar liquid ozonization in combination with sonication can produce liquid biochar paste with fine surface-oxygenated amorphous carbon particles (sizes well below 0.105 mm) plus significant amounts of dissolved organic carbons (DOC) in the presence of water. Each of these biochar products may have its own uses as listed in the Table 1a below.

TABLE 1a
Surface-oxygenated biochar product and particle size clasifications and their potential applications

| | Biochar product/size classifications | | | | | |
|---|---|---|---|---|---|---|
| | | | | Powder | Fine Power | |
| | Chip | Medium | Small | (0.300 mm | (0.105 mm | Paste |
| | (size 1″ | (3 mm to | (0.71 mm | and under | and under | (<0.105 mm, |
| Applications | to 3 mm) | 25 mesh) | to 50 mesh) | 50 mesh) | 140 mesh) | DOC + water) |
| Sand soilization | Yes | Yes | Yes | Yes | Yes | Yes |
| Phosphorus solubilization | Yes | Yes | Yes | Yes | Yes | Yes |
| Carbon sequestration | Yes | Yes | Yes | Yes | Yes | Yes |
| Direct placement into soil | Yes | Yes | Yes | Yes | Yes | Yes |
| Top-dressed on soil or grass | | Yes | | | | |
| Air seeder insertion into soil | | | Yes | | | |
| Coating seeds | | Yes | Yes | Yes | Yes | Yes |
| Suspended in water spray | | | | Yes | Yes | Yes |
| Drip irrigation systems | | | | Yes | Yes | Yes |
| Ag irrigation systems | | | | Yes | Yes | Yes |
| Suspended in water | | | | Yes | Yes | Yes |
| for soil injection | | | | | | |
| Biochar filters for | Yes | Yes | Yes | Yes | Yes | Yes |
| clean air or water | | | | | | |
| Reducing the odor | Yes | Yes | Yes | Yes | Yes | Yes |
| associated with manures | | | | | | |
| Microbe carriers | Yes | Yes | Yes | Yes | Yes | Yes |
| Plant growth | Yes | Yes | Yes | Yes | Yes | Yes |
| stimulation | | | | | | |

### EXAMPLES

The following examples illustrate methods and systems for making biochar in accordance with exemplary embodiments of the present invention and also provide an analysis of improved properties of the resulting biochar. These examples are purely exemplary and are not intended to limit the scope of the present invention. Efforts have been made to ensure accuracy with respect to numbers (e.g., amounts, temperatures, etc.), but some errors and deviations should be accounted for. Unless indicated otherwise, parts are parts by weight, temperature is in ° C. or is at ambient temperature, and pressure is at or near atmospheric, or in atmospheric pressure units (atm).

### Example 1: Ozone Treatment Reducing Biochar pH

Table 1b shows the changed in pH of the biochar samples brought about by treatment with ozone. Overall there is a dramatic decrease in the pH of the biochar samples from untreated at 7.30±0.39 to the sample treated with 90 minutes of ozone at 5.28±0.33. This sharp decrease in pH results from, for example, the addition of acidic functional groups, primarily carboxyl groups on the surface of the biochar. The trend of the drop in pH illustrates a relationship between treatment time and increasing acidity of the biochar samples. This drop in pH is an important characteristic when considering using biochar as a soil amendment. Therefore, exemplary embodiments for ozone treatment of biochar can be used to adjust or to “tune” biochar pH to a desired value for a given soil.

TABLE 1b
Summary data for pH, CEC, and Methylene blue adsorption.

| | | | Methylene Blue |
|---|---|---|---|
| Sample | pH | CEC mmol/kg | Adsorption mg/g |
| Untreated | 7.30 ± 0.39 | 153.9 ± 15.9 | 1.79 ± 0.18 |
| 30 Min O₃ | 5.46 ± 0.40 | 302.6 ± 32.3 | 9.22 ± 0.18 |
| 60 Min O₃ | 5.33 ± 0.28 | 310.3 ± 24.4 | 9.45 ± 0.07 |
| 90 Min O₃ | 5.28 ± 0.33 | 326.9 ± 25.1 | 9.35 ± 0.04 |
| Ref. Soil | N/A | 131.8 ± 9.6 | N/A |

### Example 2: Ozone Treatment Enhancing Biochar Cation Exchange Capacity by a Factor of More than 2 Times

Table 1b also illustrates a significant increase in the measured CEC values of biochar processed in accordance with exemplary embodiments of the ozone treatment. The untreated biochar sample had a CEC of 153.9±15.9, and the sample treated with 90 minutes of ozone had a value of 326.9±25.1 (in units of mmol/kg biochar). In the illustrated example, there is only a small difference between the 30, 60, and 90 minute ozone treated samples, which is potentially due to a saturation of the sites available for alteration by ozone treatment. The increase in CEC is due to an increase in oxygen functionality, as discussed, for example, in Lee et al., Environ. Sci. Technol. 44:7970-7974 (2010) and Matthew et al., Journal of Environmental Management, 146:303-308(2014). Specifically, cation exchange capacity correlates to the availability of oxygen function groups, predominately carboxylic acid groups which carry a negative charge in basic and neutral solutions, making them electrostatically attracted to cations. Table 1 also lists the CEC value of a reference soil sample of 131.8±9.6. From this, it is clear that even untreated biochar has a higher CEC, and treated samples more than double the native CEC of the reference soil sample.

### Example 3: Ozone Treatment Improving Biochar Methylene Blue Adsorption Capability by a Factor of More than 5 Times

Methylene blue adsorption capacity was measured to evaluate the viability of the biochar for dye-contaminant removal in water systems. As shown in Table 1b, there is a dramatic increase in methylene blue removal capacity resulting from ozone treatment, with the untreated biochar sample only removing 1.79±0.18 mg dye/kg biochar while the 90 minute ozone treated sample removed 9.35±0.04. This significant increase shows the usefulness of ozone treatment when considering biochar amendment for use in contaminated water systems. It is believed that the increase in methylene blue adsorption capacity results from the increase of oxygen functionality on the surface of the biochar, which makes the biochar overall more negatively charged. Methylene blue is natively positive in solution, and therefore is more electrostatically attracted to biochar that has been treated with ozone.

### Example 4: Elemental Analysis Measurement Showing Biochar Bulk Properties Such as Elemental Composition not Significantly Altered by Ozonization

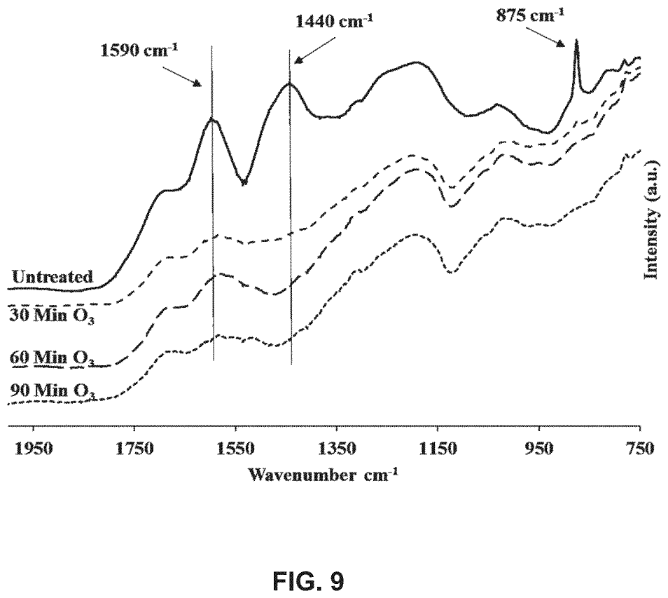

Elemental analysis measures the bulk composition of the biochar and is useful in determining the degree of change brought about by ozone treatments. Overall, there is not a dramatic change through the use of ozone treatments as shown in Table 2, However, there is a clear drop in carbon content from the untreated sample (73.90%±0.06) and the 30 minute ozone treated sample (66.76%±2.77). Additionally, there appears to be an increase in oxygen content of the biochar samples as measured by the difference from the untreated (22.78%) to the 30 minute ozone treated sample (30.07). This data correlates well with the concurrent drop in pH of these samples, as well as the increase in CEC, both owing the change in their properties due to an increase in oxygen functionality. The drop in carbon content across all samples also reveals that ozone treatments selectively attack the carbon bonds in the biochar, which is also shown in the FTIR-ATR data in FIG. 9. It should be noted that there is not a great change between the untreated and the 90 minute treated sample in terms of carbon content, owing to the inherent stability of the biochar itself.

TABLE 2
Elemental analysis of treated and untreated
biochar samples by percentage of C, H, and N

| Treatment Type | % C | % H | % N | Balance |
|---|---|---|---|---|
| Untreated | 73.90 ± 0.06 | 3.32 ± 0.06 | <0.5 | 22.78 |
| 30 Min O₃ | 66.76 ± 2.77 | 3.17 ± 0.45 | <0.5 | 30.07 |
| 60 Min O₃ | 71.70 ± 0.27 | 3.35 ± 0.07 | <0.5 | 24.95 |
| 90 Min O₃ | 71.31 ± 0.30 | 3.34 ± 0.04 | <0.5 | 25.35 |

### Example 5: Application of Hydrogen Peroxide Treatment for Biochar-Surface Oxygenation

In this example, biochar was produced from pinewood biomass by pyrolysis at a highest treatment temperature (HTT) of 400° C. This biochar was then treated with varying concentrations of a H₂O₂ solution (1, 3, 10, 20, 30% w/w) for a partial oxygenation study. The biochar samples, both treated and untreated, were then tested with a cation exchange capacity (CEC) assay, Fourier Transformed Infrared Resonance (FT-IR), elemental analysis, field water-retention capacity assay, pH assay, and analyzed for their capacity to remove methylene blue from solution. As shown in Table 3, the results demonstrate that higher H₂O₂ concentration treatments led to higher CEC due to the addition of acidic oxygen functional groups on the surface of the biochar, which also corresponds to the resultant lowering of the pH of the biochar with respect to the H₂O₂ treatment. Furthermore, it shows that the biochar methylene blue adsorption decreased with higher H₂O₂ concentration treatments. This is believed to be due to the addition of oxygen groups onto the aromatic ring structure of the biochar which in turn weakens the overall dispersive forces of π-π interactions that are mainly responsible for the adsorption of the dye onto the surface of the biochar. As shown in Table 4, the elemental analysis revealed that there was no general augmentation of the elemental composition of the biochar samples through the treatment with H₂O₂, which suggests that the bulk property of biochar remains unchanged through the treatment.

TABLE 3
Assay results of H₂O₂-treated and untreated biochar samples
for CEC (cmol/Kg biochar), Field Capacity (grams water
retained per gram biochar), pH, and Methylene blue adsorption
(mg dye adsorbed per gram biochar).

| | | Field | | Methylene |
|---|---|---|---|---|
| | CEC | Capacity | | Blue |
| Treatment | (cmol/Kg | (g H₂O/ | | Adsorption |
| (% H₂O₂) | biochar) | g biochar) | pH | (mg/g) |
| 0 (Untreated) | 17.95 ± 3.53 | 4.69 ± 0.09 | 7.16 ± 0.04 | 7.14 ± 0.28 |
| 1 | 23.75 ± 5.12 | 4.77 ± 0.44 | 7.14 ± 0.02 | 7.71 ± 0.33 |
| 3 | 23.30 ± 5.09 | 4.33 ± 0.76 | 7.05 ± 0.01 | 7.41 ± 0.38 |
| 10 | 25.58 ± 5.40 | 4.24 ± 0.57 | 6.70 ± 0.06 | 6.56 ± 0.34 |
| 20 | 25.43 ± 4.13 | 4.62 ± 0.45 | 6.34 ± 0.04 | 6.57 ± 0.07 |
| 30 | 31.37 ± 6.17 | 4.76 ± 0.35 | 5.66 ± 0.03 | 5.50 ± 0.37 |

TABLE 4
Elemental analysis of H₂O₂-treated and untreated biochar
samples by percentage of C, H, N and balance by mass.

| Treatment | C | H | N | Balance |
|---|---|---|---|---|
| (% H₂O₂) | (wt %) | (wt %) | (wt %) | (wt %) |
| 1 | 72.59 ± 1.62 | 3.63 ± 0.17 | <0.5 | 23.78 |
| 3 | 71.38 ± 1.22 | 3.61 ± 0.04 | <0.5 | 25.01 |
| 10 | 68.73 ± 1.16 | 3.32 ± 0.38 | <0.5 | 27.95 |
| 20 | 72.18 ± 0.43 | 3.83 ± 0.10 | <0.5 | 23.99 |
| 30 | 71.43 ± 1.70 | 3.94 ± 0.12 | <0.5 | 24.63 |
| 0 (Untreated) | 72.59 ± 0.17 | 3.86 ± 0.01 | <0.5 | 23.55 |

### Example 6: Biochar FTIR-ATR Spectroscopy Showing Reaction of Ozone Selectively with Biochar C═C Double Bonds

The FTIR-ATR spectra as shown in FIG. 9 reveals information about the functional group changes brought about by ozone treatment. Two peaks appearing at 1590 cm⁻¹ and 1440 cm⁻¹ correspond to elastic and inelastic stretching of carbon-carbon double bonds in an aromatic ring structure. These two peaks primarily appear only in the untreated sample, and are greatly reduced in the ozone treated samples, revealing that the ozone selectively reacts with the double bonded carbon throughout the biochar substrate. Furthermore, a peak at 875 cm⁻¹ on the untreated sample spectra corresponding to C—H out of plane stretching from an aromatic carbon ring is also greatly reduced with ozone treatment, showing further evidence of the reaction of ozone selectively with carbon-carbon double bonds.

### Example 7: Biochar Raman Spectroscopy Showing Ozone-Enabled Biochar-Surface Oxygenation

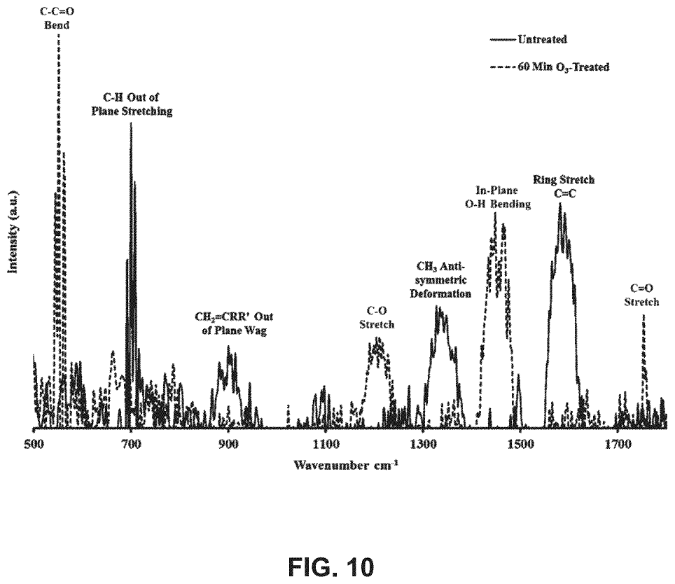

The Raman spectra as shown in FIG. 10 reveals dramatic differences in functionality between biochar samples that have been treated with ozone versus the untreated sample. Primarily there is an apparent loss of peaks corresponding to aromatic ring stretching as well as alkene out of plane wag functionality (1600 cm⁻¹ and 900 cm⁻¹). Concurrently, as the peaks corresponding to double-bonded carbon functionality are decreased in the ozone treated samples, there is an increase in peaks corresponding to various oxygen functionality. The peaks appearing in the treated samples are consistent with C═O and C—O stretching as well as in plane O—H and C—C═O bending (1720 cm⁻¹, 1220 cm⁻¹, 1480 cm⁻¹, and 550 cm⁻¹, respectively). Overall this spectra provides further evidence of an intense change in functionality brought about by ozone treatment on the surface of the biochar, namely the conversion of aromatic double bonded carbon functionality to different oxygen containing groups.

### Example 8: Production of Surface-Oxygenated Biochar Through Sonication in Combination with Wet Ozonization

In this example, sonication of biochar in liquid was conducted with a 750 Watt, 20 KHz Ultrasonic Processor VCX-750 and then followed by ozonization. Briefly, 9.0 g of oven dried biochar P400, which was produced by slow pyrolysis (residence time: 30 min) of pine wood at 400° C., was weighed and placed into an ozone treatment vessel and 50.0 mL of ultrapure water was added into it. The sample mixture was sonicated for 15 minutes with the Ultrasonic Processor set at 50% amplitude. The ozone generator was set to optimum condition for the generation of ozone. The ozone gas stream was bubbled into the liquid sample mixture for 90 min. After 90 min, the mixture was transferred into a Buchner funnel and the filtrate was collected in a vessel for further analysis. The biochar product was then washed with 600 mL of ultrapure water and kept in oven maintained at 105° C. for drying. The biochar was then washed with 1800 mL of ultrapure water and kept in oven maintained at 105° C. for drying. This sonicated-ozonized biochar product is designated as P400 90W+S.

In a related example, liquid sonication was done to the biochar material two times during ozonization treatment. In this double-sonication treatment in combination with wet ozonization, 9.0 g of oven dried biochar was weighed and placed into an ozone treatment vessel and 50.0 mL of ultrapure water was added to it. The sample mixture was sonicated for 15 minutes with the Ultrasonic Processor set at 50% amplitude. The ozone generator was set to optimum condition for the generation of ozone. The ozone was bubbled into the liquid sample mixture for 45 min. The sample mixture was again sonicated for 15 minutes and ozone was bubbled into the sample liquid mixture for next 45 min. The mixture was then transferred into a Buchner funnel and the filtrate was collected in a vessel for further analysis. The biochar was then washed with 1800 mL of ultrapure water and kept in oven maintained at 105° C. for drying. This double-sonicated-ozonized biochar product is designated as P400 90W+2S.

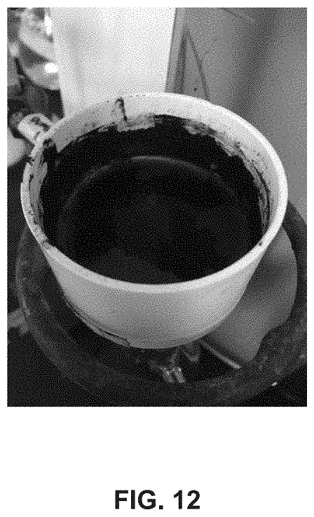

In another related example, the biochar liquid-sonication-ozonization reactor (FIG. 11) process generated a black viscos biochar paste product as shown in FIG. 12, which comprises biochar derived organic matters including humic-like substances that are selected from the group consisting of surface-oxygenated biochar particles, surface-oxygenated biochar-derived organic matters, surface-oxygenated amorphous carbon particles, surface-oxygenated graphite particles, partially oxygenated graphene, partially oxygenated graphene-like molecules, partially oxygenated graphene molecular fragments, partially oxygenated linear hydrocarbons, partially oxygenated aromatic compounds, partially oxygenated polycyclic aromatic hydrocarbons, dissolved organic carbons including organic acids, and combinations thereof.

### Example 9: Solubilization of Phosphorus from Hydroxyapatite with Surface-Oxygenated Biochar Composition

In this example, solubilization of phosphorus from hydroxyapatite using a special ozonized biochar was experimentally demonstrated for the first time. The ozonized biochar was specially made from pine wood-derived biochar through slow pyrolysis and followed by a post-production ozonization process. Briefly, pine wood biomass was converted to biochar by slow pyrolysis (residence time 30 min) at a highest treatment temperature of 400° C. The resulting biochar was treated with ozone under wet and dry conditions to add oxygen functional groups on its surface. The pH of the biochar showed a two units decrease when treated with ozone (pH 5.64 for the non-ozonized control biochar versus 3.60 and 3.96 for the wet and dry-ozonized biochar respectively). The biochar cation exchange capacity increased by 50% when the biochar is treated with ozone (14.4 cmol/kg and 13.2 cmol/kg for wet and dry-ozonized biochar respectively) compared to non-ozonized control biochar (10.4 cmol/kg). Incubation of insoluble phosphorus material in the form of hydroxyapatite, with the wet-ozonized biochar together with its filtrate for 2 days resulted in a maximum solubilized phosphate concentration (569.9 mg/L; equivalent to the P concentration of 185.9 ppm), compared to 0.1 mg/L of phosphate when hydroxyapatite was incubated with the non-ozonized control biochar and its filtrate. A similar pattern was observed for the calcium solubilized (Ca 66.0 mg/L) from the hydroxyapatite when the latter was incubated with the wet-ozonized biochar and its filtrate, in comparing to that (Ca 0.4 mg/L) of the hydroxyapatite incubation control with the non-ozonized biochar and its filtrate. These results showed that the surface-oxygenated biochar composition may be used to mix with phosphate rock powders and/or ground soft rock phosphate to make slow-releasing phosphorus and calcium fertilizers.

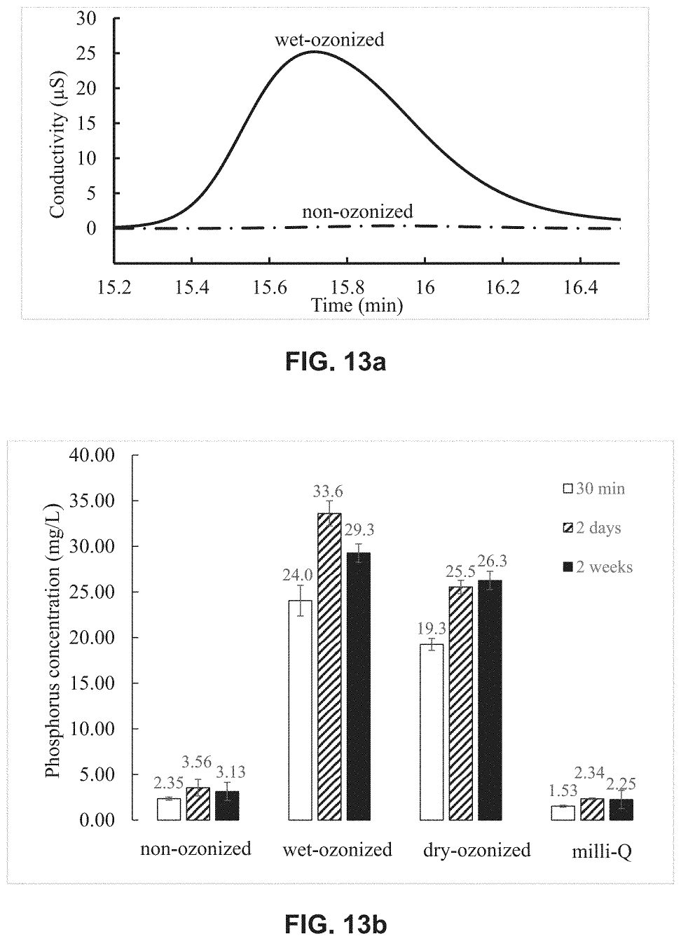

In a related example, a further experiment was conducted using both dry- and wet-ozonized biochar to incubate with hydroxyapatite in Milli-Q deionized water for periods of 30 minutes, 2 days, and 2 weeks. The phosphate concentration change in the incubation liquid was analyzed using an Ion Chromatograph IPS 5000 Dionex SP. FIG. 13a presents the ion chromatography showing the phosphate peak from the mixture of hydroxyapatite with the wet ozonized biochar and non-ozonized biochar, their respective filtrate and the hydroxyapatite. The phosphate peak appeared at 15.6-16.0 min. The height of the solubilized phosphate ion chromatography peak from the mixture with the ozonized biochar was far much higher than the curve of the non-ozonized biochar treatment which looks nearly flat in comparing with the huge phosphate peak from the mixture with the ozonized biochar. The data presented in FIG. 13a were from the sample collected after 30 minutes of incubation time. This result demonstrated that ozonized biochar (with its associated filtrate) is quite reactive with hydroxyapatite so that its dramatic phosphate solubilizing activity can be observed within 30 min (FIG. 13a).

By integrating for the phosphate peak area under the ion chromatography curve, the amount of solubilized phosphorus and its concentration was calculated according to a phosphate standard ion chromatography curve of known P concentrations. The analyzed results (FIG. 13b) demonstrate that the solubilization of phosphate calculated as the solubilized phosphorus (P) concentration from hydroxyapatite with ozonized biochar is reproducible. In all cases, the P concentrations in the liquid phase after incubation with the ozonized biochars are far much higher than those of the non-ozonized biochar control and the Milli-Q deionized water control.

### Example 10: Solubilization of Phosphorus from “Insoluble” Phosphate Materials Through the Cation Exchange and/or Protonic Effect of Surface-Oxygenated Biochar

Table 5 present the results from a 14-day hydroxyapatite solubilization assay with surface-oxygenated biochar as measured at the end of the incubation experiment. In this experiment, the biochar materials including wet-ozonized biochar and dry-ozonized biochar were washed with water to remove any dissolved organic carbon (DOC) before used in this experiment. The washed clean biochar material is designated as “biochar” to use in the experiment. The DOC liquid resulted from the washing of biochars was designated as “filtrate”. Based on the assay data, use of both the wet-ozonized biochar and the dry-ozonized biochar can significantly solubilize phosphorus from hydroxyapatite and resulted in solubilized P concentrations of 29.26±3.73 and 26.26±0.68 mg/L, which is nearly 10 times better than the control incubation using non-ozonized biochar (3.135±0.198 mg/L).

The incubation treatment of hydroxyapatite with wet-ozonized biochar with its associated filtrate (HA+Biochar+Filtrate wet-ozonized) resulted in the highest solubilized P concentration of 180.6±18.0 mg/L, which is 147 times higher than that (1.228±0.435 mg/L) of the control incubation that used non-ozonized biochar and its filtrate (Table 5). Furthermore, the incubation treatment of hydroxyapatite with the filtrate from the wet-ozonized biochar also resulted in a very high solubilized P concentration (152.0±19.0 mg/L). This result demonstrated that the filtrate including the DOC from the wet biochar ozonization process can play a major role in helping solubilizing phosphorus from phosphate rock materials such as hydroxyapatite.

From the Ca/P molar ratio data listed in Table 5, it is quite clear that the molecular mechanism of cation exchange may play a role in help solubilizing phosphate from hydroxyapatite, since all treatments with biochars and/or their filtrates resulted in a low Ca/P molar ratio in a range from 0.1 to 0.3 that is significantly lower than that of the HA+Water incubation control (1.081) which is somewhat closer to the molar ratio of calcium to phosphate (1.67/1) in the solid hydroxyapatite Ca5(PO4)3(OH). That is, some of the divalent calcium cations may be removed by interacting with the negatively charged surfaces of biochar and/or complexation with the deprotonated carboxylate groups on biochar surfaces and/or with the partially oxygenated biochar molecules and organic acids in the biochar filtrates. As a result, the concentration of Ca⁺⁺ in the liquid phase was lowered, which is favorable for P solubilization from hydroxyapatite. Alternatively, the deprotonated carboxylate groups (anions) of the partially oxygenated DOC in the biochar filtrates may exchange with phosphate (anions) out of the hydroxyapatite surfaces, which could also explain the observed low molar ratio (0.1˜0.3) of Ca/P in the incubation solutions with surface-oxygenated biochars and filtrates.

The use of ozonized biochars can apparently lowered the final pH of the incubation liquid mixture by nearly 1 pH unit, for example, from the HA+water control pH 6.68 to 5.72 with wet-ozonized biochar and filtrates. The higher solubilized P concentrations in the incubation liquid with wet ozonized biochar and its filtrate apparently correlate well with the observed lower pH. Therefore, it is quite clear that the protonic effect is also in play with the phosphorus solubilization process.

Therefore, the data listed in Table 5 indicated that the phosphorous solubilization with surface-oxygenated biochar is accomplished through at least one of the following molecular mechanisms: a) Protonic effect including the effect of protons from the organic acid groups of ozonized biochar which can kick phosphate out of the insoluble phosphate materials, resulting in solubilized phosphate; b) Cation exchange including the effect of calcium complexation with the deprotonated biochar carboxylate groups on biochar surfaces and/or biochar molecules and its associated dissolved organic acids that takes calcium away and thus thermodynamically favors the release of phosphate from the insoluble phosphate materials; c) Anion exchange including the effect of anions such as the deprotonated biochar molecular carboxylate groups and its associated dissolved organic acids in exchange with the phosphate (anion) of the insoluble phosphate materials thus thermodynamically favors its phosphorus release; and d) combinations thereof.

TABLE 5
Results of hydroxyapatite solubilization with surface-oxygenated biochar
compositions as measured at day 14 of the incubation assay.

| | Biochar | P | Ca | Ca/P | |
|---|---|---|---|---|---|
| | Treatment | mg/L | mg/L | mol ratio | pH |
| HA + Water + Biochar | non-ozonized | 3.135 ± 0.198 | 0.72 ± 0.89 | 0.177 | 6.67 ± 0.05 |
| HA + Water + Biochar | wet-ozonized | 29.26 ± 3.73 | 12.64 ± 3.39 | 0.333 | 5.71 ± 0.04 |
| HA + Water + Biochar | dry-ozonized | 26.26 ± 0.68 | 10.97 ± 0.43 | 0.322 | 5.90 ± 0.00 |
| HA + Water | no biochar | 2.250 ± 0.638 | 3.15 ± 0.65 | 1.081 | 6.68 ± 0.03 |
| HA + Biochar + Filtrate | non-ozonized | 1.228 ± 0.435 | 0.34 ± 0.14 | 0.213 | 6.79 ± 0.05 |
| HA + Biochar + Filtrate | wet-ozonized | 180.6 ± 18.0 | 33.50 ± 7.10 | 0.143 | 5.72 ± 0.01 |
| HA + Biochar + Filtrate | dry-ozonized | 45.70 ± 12.77 | 6.28 ± 8.00 | 0.106 | 6.17 ± 0.01 |
| HA + Filtrate | non-ozonized | 2.020 ± 0.187 | 1.05 ± 0.19 | 0.401 | 6.90 ± 0.02 |
| HA + Filtrate | wet-ozonized | 152.0 ± 19.0 | 51.66 ± 3.50 | 0.262 | 6.15 ± 0.09 |
| HA + Filtrate | dry-ozonized | 25.60 ± 14.38 | 6.80 ± 8.11 | 0.205 | 6.36 ± 0.03 |

### Example 11: Utilization of Surface-Oxygenated Biochar Composition for Phosphorus Solubilization from Soil Insoluble Phosphate Mineral Phases

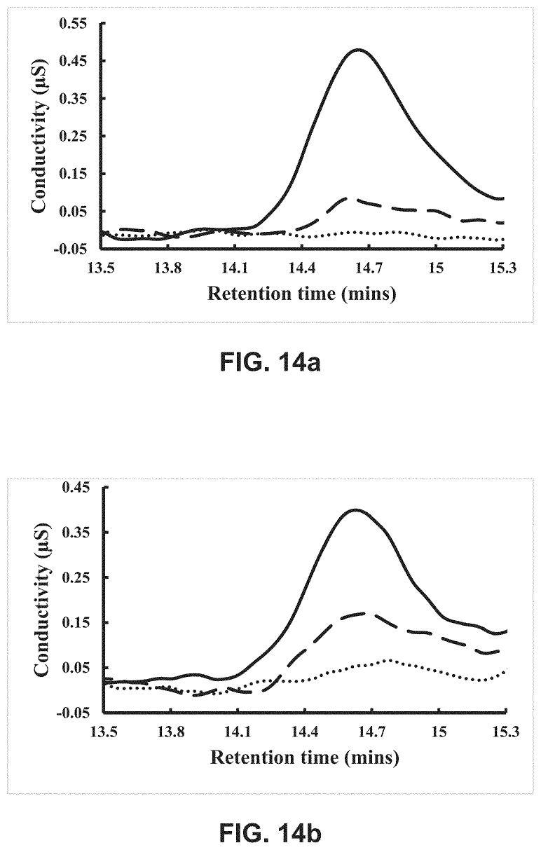

The soil samples tested included the Portneuf Soil (P-Soil) collected from South Central Idaho and the Bennett Soil (B-Soil) collected from Eastern Colorado. Tests were conducted by mixing 0.5 g of surface-oxygenated biochar with 1 g of soil plus 12 ml of water to incubate for 30 minutes, 2 days, and 14 days and then measuring the solubilized phosphate concentration in the liquid phase using an Ion Chromatograph IPS 5000 Dionex SP. As shown in the ion chromatogram of FIG. 14a, the solubilized phosphate peak from the 14-day incubation treatment of ozonized biochar+B-Soil+Water (solid line) is more than twice higher than the control peak from the non-ozonized biochar+B-Soil+Water (dashed line). The ion chromatogram curve of the B-Soil+Water (dotted line) control treatment was nearly flat as expected. A similar effect of ozonized biochar on phosphorus solubilization was observed also in the test with the P-Soil sample where significant amount of phosphate was solubilized by surface-oxygenated biochar as well (FIG. 14b).

These experimental results demonstrated that the use of surface-oxygenated biochar can result in a significantly higher concentration of solubilized phosphate in both of the Portneuf Soil and the Bennett Soil in comparing with the control treatments of these soils using non-ozonized biochar. As listed in Table 6, the concentrations of solubilized phosphorus (P) released through the liquid incubation treatment (with wet-ozonized biochar P400 90W+Water) from each of the P-Soil and the B-Soil reached as high as 4.47 and 5.61 ppm, respectively. These concentrations of solubilized P released from P-Soil and B-Soil with wet-ozonized biochar are nearly four times as high as the controls where non-ozonized biochar “P400 UN+water” was used (1.45 and 0.73 ppm). When dry-ozonized biochar “P400 90D+Water” was used, the concentrations of solubilized phosphorus (P) released from P-Soil and B-Soil were 2.05 and 2.02 ppm, respectively, which are nearly twice as high as those of the controls when non-ozonized biochar “P400 UN+water” was used (1.45 and 0.73 ppm).

TABLE 6
Phosphorus concentration released from
soils after 14 days of incubation

P concentration (ppm)

| Soil incubation treatment | P-soil | B-soil |
|---|---|---|
| P400 UN + water | 1.45 | 0.73 |
| P400 90D + water | 2.05 | 2.02 |
| P400 90W + water | 4.47 | 5.61 |
| 1M HNO₃ | 655.53 | 606.61 |

These solubilized P concentrations as elevated by the effect of surface-oxygenated biochar in the tested P-Soil and B-Soil water solutions are all well above the critical P concentration of 0.15 ppm that is required in soil solution for crop plant growth as reported by Matula 2011 (Plant Soil and Environment, 57(7): p. 307-314). Therefore, these examples of phosphorus solubilization from soil insoluble phosphate materials with ozonized biochar demonstrated the inventive value of this embodiment.

Note, the soil incubation treatment with 1M HNO₃ resulted in the concentrations of solubilized phosphorus (P) of over 600 ppm released from both P-Soil and B-Soil. This indicated that natural soils like P-Soil and B-Soil contain large amounts of “insoluble” phosphate materials that could be potentially solubilized with this new technology using the surface-oxygenated biochar composition. For instance, the amount of phosphorus released from P-Soil with the “wet ozonized biochar P400 90W+water” treatment as demonstrated in this experiment utilized only a very small fraction (4.47/655.53=0.68%) of the total “insoluble” phosphate materials that could be potentially solubilized in the future. Therefore, the technology of phosphorus solubilization from soil insoluble phosphate mineral phases using surface-oxygenated biochar composition may be repeatedly employed in soils well into the future.

### Example 12: Flocculation of Certain Partially Oxygenated Dissolved Organic Carbons (DOC) from Liquid Biochar Ozonization Process

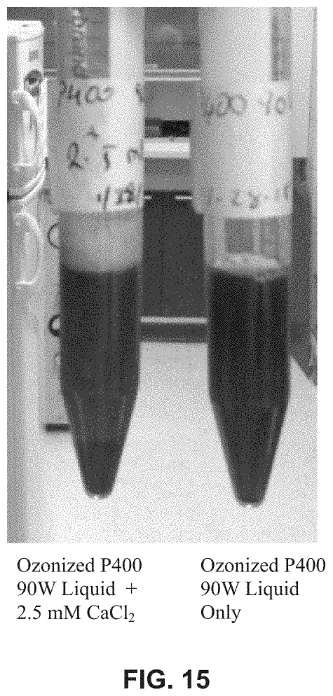

In this example, liquid filtrate samples comprising certain partially oxygenated dissolved organic carbons (DOC) were made from liquid ozonization of P400 biochar materials for 90 min. The liquid filtrate DOC concentration was determined to be about 940 ppm. As shown in FIG. 15, flocculation of the filtrate DOC from the wet-ozonized P400 90W was demonstrated by adding 2.5 mM CaCl₂ into the liquid sample. The flocculated DOC materials sink down to the bottom of the test tube likely as a result from the complexation of the wet-ozonized P400 90W DOC organic acids with divalent cation Ca⁺⁺.

### Example 13: Utilization of Surface-Oxygenated Biochar Composition for Sand Soilization

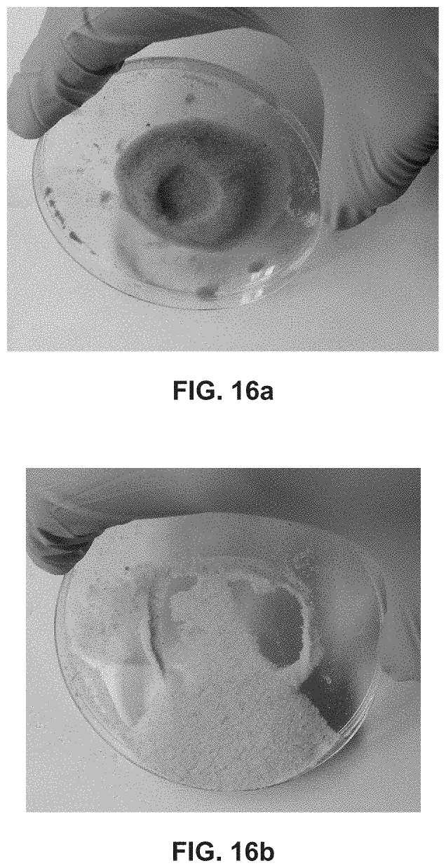

In this example, sand soilization was experimentally demonstrated by mixing 10 g of silicon dioxide sand particles with 4 ml of wet-ozonized P400 90W liquid filtrate (shown in FIG. 15, DOC concentration 940 ppm) plus 25 mM CaCl₂ in a petri dish plate. After leaving the sand piles on petri dish plates for 5 hours under room temperature and air humidity, the treated sand pile (mixed with 4 ml of the liquid filtrate+25 mM CaCl₂) remained wet while the control plate of sands (mixed with 4 ml of pure water) became dry. When the plates were then tilted at an angle greater than 45 degrees, the filtrate-treated sand pile remains intact while the control pile completely falls apart as shown in FIG. 16. This result demonstrated that the use of ozonized biochar liquid filtrate and calcium chloride may enable sand soilization by forming a type of jelly state to better retain water and nutrients and hold sand particles together.

### Example 14: Wet-Ozonized Un-Hydrolyzed Corn Stover Residue

In this example, 3 g of the solid material of un-hydrolyzed corn stover residue was mixed with 50 ml of milli-Q water. The mixture was hand shaken thoroughly. The mixture was then placed into a specialized glass vessel and treated with ozone with a Wellsbach Ozone generator for 90 minutes. The parameters of ozone treatment were as followed: 8 psi for the oxygen pressure, the ozone flow was set to 3 L per minute and the voltage was set to 116 V. The 50 mL filtrate was then collected by vacuum filtration before being stored in a refrigerator at 4° C. The filtrate was filtered through a 0.2-μm pore-size filter and its dissolved organic carbon concentration was determined with a TOC Analyzer. The solid material was further washed with an additional 600 mL of milli-Q water to get rid of the un-bound particles. The solid material was then dried in oven at 105° C.

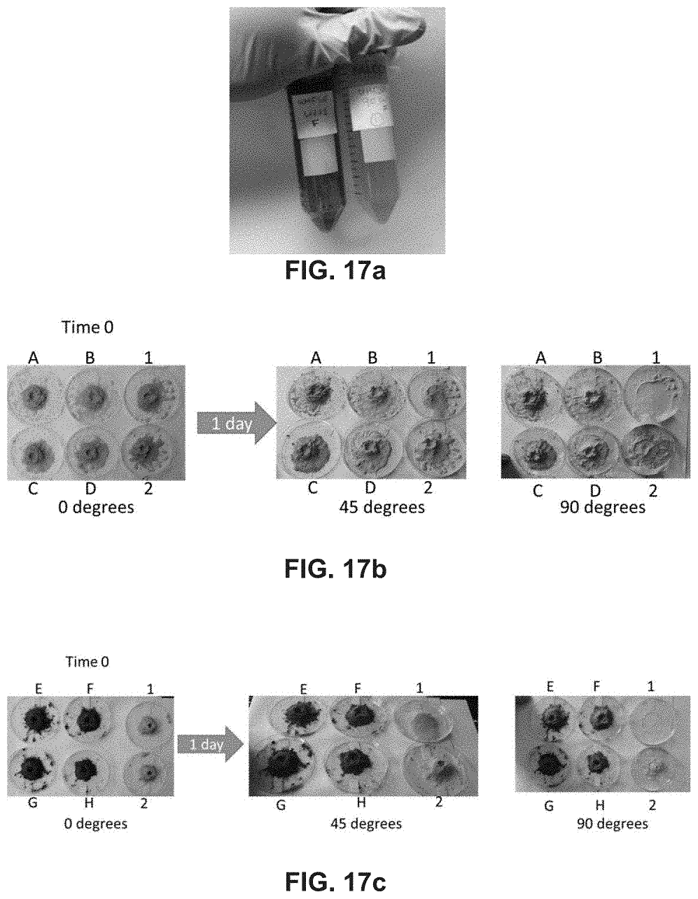

The pH of the un-hydrolyzed corn stover residue was measured. The effect of ozone treatment caused a dramatic decrease in pH from 4.81±0.0071 (non-ozonized control) to 3.12±0.14 (wet-ozonized sample). The dissolved organic carbon (DOC) was also measured and showed an increase in DOC concentration from 2440.5 mg/L to 2928.3 mg/L (Table 7) by wet ozonization. Both the decrease in pH and the increase in DOC supported the claim that ozonization reaction took effect on the un-hydrolyzed corn stover residue. The un-hydrolyzed corn stover residue, upon being ozonized had a filtrate that had a different color compared to that of the non-ozonized un-hydrolyzed corn stover residue (FIG. 17a).

TABLE 7
The pH of the un-hydrolyzed corn stover residue (non-
ozonized and wet-ozonized) was measured. The dissolved
organic carbon concentration of the filtrate collected
from each of the non-ozonized and the wet-ozonized un-
hydrolyzed corn stover residue was also measured.

| | Non-ozonized | Wet-ozonized |
|---|---|---|
| | un-hydrolyzed | un-hydrolyzed |
| | corn stover | corn stover |
| | residue | residue |
| pH | 4.81 ± 0.0071 | 3.12 ± 0.14 |
| Dissolved organic carbon | 2440.5 mg/L | 2928.3 mg/L |
| concentration of the filtrate | | |
| collected | | |

### Example 15: Utilization of Wet-Ozonized Un-Hydrolyzed Corn Stover Residue for Sand Soilization

In this example, the soilization test of silicon dioxide sands demonstrated that when the sands are mixed with pure water, the sands pile on the Petri dish plate cannot withstand its structure when being tilted at an angle greater than 45 degrees. The addition of 2.5 mM CaCl₂ to the sand pile gave a little more holding effect and enabled it to stay intact until a tilt of 90 degrees where the sand pile also falls apart (FIGS. 17b and 17c).

In the presence of the filtrate from the un-hydrolyzed corn stover residue, the sand pile is able to maintain its structure when it was tilted at 45 and 90 degrees (FIG. 17b). In the presence of both the filtrate and the respective un-hydrolyzed corn stover residue, the sand was able to maintain its structure as well when it was tilted at 45 and 90 degrees (FIG. 17c). This experimental observation indicated that the use of the filtrate from the un-hydrolyzed corn stover residue provides an increased structural strength in the silicon dioxide sand pile enabling it to maintain its structure. This data showed that the un-hydrolyzed corn stover residue filtrate can provide a stronger wet structure to hold the silicon dioxide sand pile intact so that the sands will less likely to become air borne with winds. That is, ozonized biochar composition may be used in combination with recalcitrant biomasses such as un-hydrolyzed corn stover residue and its filtrate, and in combination with divalent cations such as Ca²⁺ to enhance sand soilization to better retain water and nutrients and hold the sand particles together.

### Example 14: Utilization of Surface-Oxygenated Biochar Composition for Stimulation of Algal Culture Growth

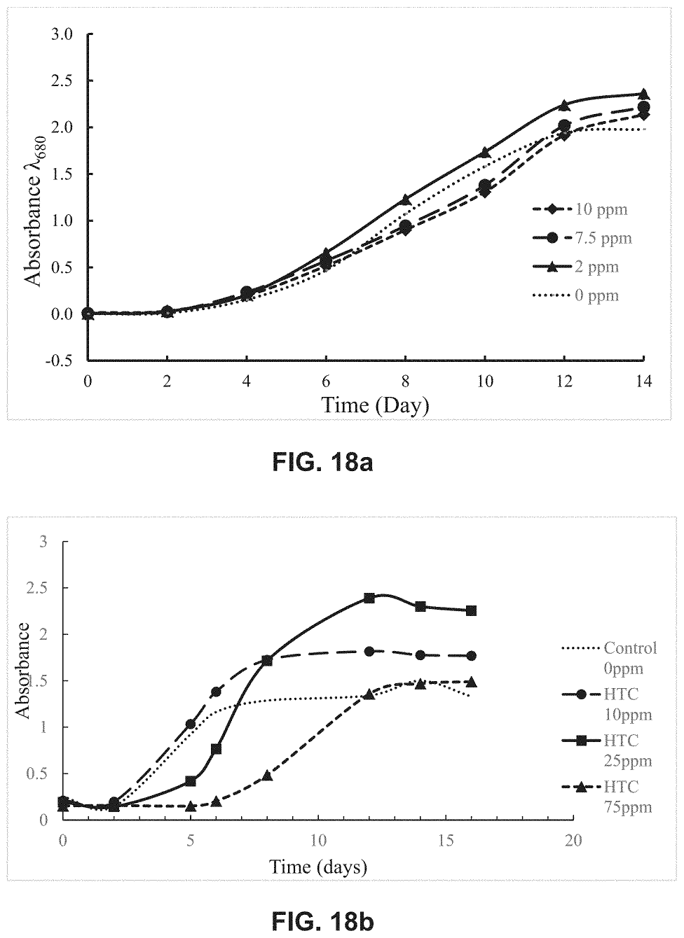

In this example, as shown in FIG. 18, the blue-green algae (cyanobacteria) growth assays demonstrated that the surface-oxygenated biochar compositions contain certain amounts of beneficial humic acids-like substances including certain partially oxygenated dissolved organic carbons (DOC) that can stimulate plant cell growth such as cyanobacteria when used in liquid culture medium such as BG-11 medium at a proper DOC concentration such as 2 ppm, 7.5 ppm, and/or 10 ppm. In this assay, the liquid culture of cyanobacteria Synechococcus elongatus PCC 7942 was incubated in multi-well bioassay plates with wet-ozonized P500 biochar filtrate at a series of DOC concentration of 0 ppm, 2 ppm, 7.5 ppm and 10 ppm. The multi-well bioassay plates were placed on a shaker platform shaking at 100 rpm at room temperature under continuous actinic illumination light intensity of 15.8 μmol/m²·s. Over the course of 14 days, the effect of incubation with wet-ozonized P500 biochar filtrate at 2 ppm of DOC seemed to show greater promotion on cyanobacterial culture growth compared to the 7.5 ppm DOC which was also better than the 10 ppm DOC. Overall, they all showed slightly better growth than the 0 ppm control.

Similarly, a 16-day bioassays of the hydrochar (HTC) liquid from a hydrothermal conversion process using un-hydrolyzed corn stover residues with Synechococcus elongatus PCC 7942 (FIG. 18b) showed that the use of HTC liquid at a DOC concentration of 10 and 25 ppm can also stimulate liquid cyanobacterial culture growth.

### Example 15: Utilization of Surface-Oxygenated Biochar Composition for Stimulation of Higher Plant Seed Germination and Growth

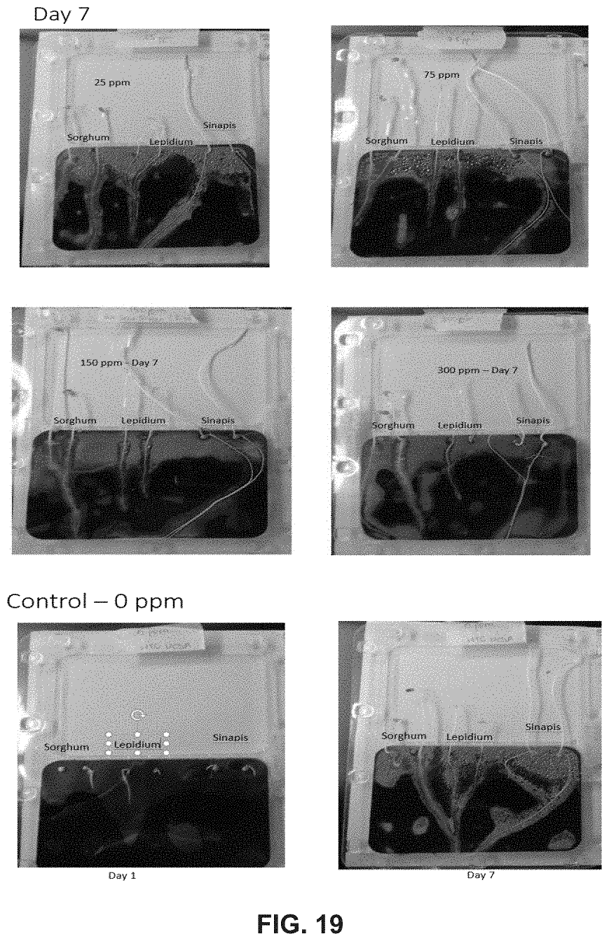

In this example, certain partially oxygenated dissolved organic carbons (DOC) from the surface-oxygenated biochar compositions were tested for its biological effect on seedlings from seed germination using commercially available phytotoxkit microbiotest plates with a standard protocol. Briefly, plate 1 contained 300 ppm of DOC material from the hydrochar (HTC) liquid of a hydrothermal conversion process using un-hydrolyzed corn stover residues (UHCSR). One half of test plate column was filled with reference soil. Soil was saturated with 35 ml of UHCSR HTC liquid (4.87 ml UHCSR HTC liquid in 200 ml volumetric flask), was then covered with black filter paper, and followed by the placement of 2 seeds per kind (Sorghum, Lepidium, and Sinapis). The plate was then incubated in the dark for germination. Protocol was repeated for plates 2 (150 ppm) consisting of 35 ml of 2nd serial dilution, plate 3 (75 ppm) consisting of 35 ml of 3rd serial dilution, plate 4 (25 ppm) consisting of 35 ml of 4th serial dilution (3rd serial dilution diluted with 70 ml deionized water), and finally plate 5 (0 ppm) which is just the Control of 35 ml deionized H₂O. The results of the assay as observed in 7 days (FIG. 19) demonstrated that the surface-oxygenated biochar compositions contain certain amounts of beneficial humic acids-like substances including certain partially oxygenated biochar dissolved organic carbons (DOC) that can stimulate higher plant seed germination and seedling elongation (growth) such as Sorghum, Lepidium, and Sinapis when used at a proper DOC concentration such as 75 ppm and 150 ppm.

### Example 16: Comparative Experiments of Dairy Manure Gasification Biochar, 815-871° C. Flash Pyrolysis Woody Biochar and Pine 400 Biochar Before and after Ozonization for CEC, pH, Methylene Blue Adsorption and its Effect on Synechococcus elongatus PCC 7942

In this example, 3 types of biochar were used to compare in the tests are: 1) Pine 400 biochar which was produced from Pinewood biomass through pyrolysis with a high pyrolysis temperature of 400 degrees Celsius (400° C. for 30 min); 2) Dairy manure gasification (>700° C.) biochar (Company biochar 1); and 3) Flash Pyrolysis woody biochar (Company biochar 2) which was produced by 815-871° C. Flash (30 seconds) Pyrolysis using chopped 2-inch chips of softwood including Douglas fir (Oregon pine) and sugar pine with 35% water content. The three different types of biochar were treated with ozone under dry condition (without water) and wet condition (with water) for 90 minutes. The biochar samples were then tested for BET surface area measurements. The Company biochar 2 had a type of “steam activation” effect from the 815-871° C. Flash (30 seconds) Pyrolysis using 35% water content of the chopped softwood (the water content in the biomass quickly turned into steam upon sudden contacting with the high pyrolysis temperature of 815-871° C.) so that its BET surface area was as high as 434.9 m²/g before ozonization. The Pine 400 biochar before ozonization had the lowest BET surface area of 0.7616 m²/g. Ozonization slightly increased the BET surface area under wet conditions for Company biochar 2 giving a BET surface area of 452.7 m²/g. Ozonization caused a drop in pH for all 3 types of biochars; a dramatic pH drop was observed in the Company biochar 2 going from pH 9.835+/−0.028 to 4.65+/−0.071 upon dry ozonization.

Similarly, the cation exchange capacity (CEC) was measured and showed a dramatic increase in the Company biochar 2 upon ozonization: from 14.314 cmol/kg for non-ozonized Company biochar 2 to 84.371 cmol/kg (equivalent to 843.71 mmol/kg), 109152 cmol/kg and as high as about 200 cmol/kg for dry ozonized Company biochar 2. Dry ozonization of Company Biochar 1 also resulted in an improved CEC value, but its improvement was not as big as in Company Biochar 2.

In order to see how efficient the biochars are in adsorbing dyes, a methylene blue adsorption assay was conducted. The results demonstrated that the Company Biochar 2 removed almost all the methylene blue (99.752 percent removal of methylene blue).

Furthermore, the dissolved organic carbon (DOC) concentration was determined for biochar filtrates. Ozonization increased the DOC content for all 3 types of biochar. The DOC production results showed that Pine 400 and Company Biochar 1 were more efficient in the wet ozonization while Company Biochar 2 worked best under dry ozonization.

In this example, bioassay study was conducted using the ozonized biochar filtrates and their respective DOC concentration. The DOC of ozonized Pine 400 biochar showed a greatest beneficial effect on the cyanobacteria Synechococcus elongatus PCC 7942 growth followed by the DOC from ozonized Company Biochar 2.

Overall, Company Biochar 2 is among the best for use with ozonization, which upon dry ozonization yielded the greatest reduction in pH, greatest increase in CEC (by a factor of nearly 5), and greater production of biochar DOC (part of the biochar-derived organic matters). Note, the commercial production capacity of Company Biochar 2 recently reached 3500 tons per year in conjunction with the operation of a 30 MW boiler-based electricity generation power plant, annually utilizing about 250,000 tons of chopped softwood with 35% moisture through 815-871° C. Flash Pyrolysis. The syngas produced from the biomass Flash Pyrolysis was utilized through its clean combustion to heat the boiler for steam turbine electricity generation.

### Example 17: Production of Dissolved Organic Carbon (DOC) Matters from Pine 400 Biochar Through Sonication, Dry Ozonization, Wet Ozonization, and Sonication Combination with Wet Ozonization

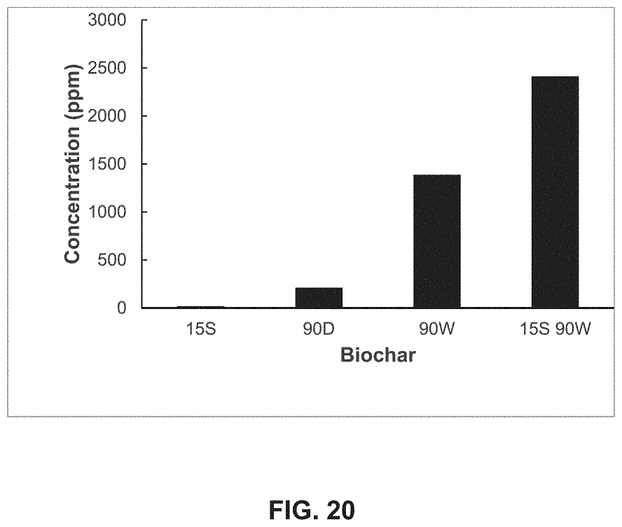

FIG. 20 presents an example for the production of surface-oxygenated biochar derived organic matters measured as the concentration (ppm) of dissolved organic carbon (DOC) produced from Pine 400 biochar through sonication (15S=15 minutes of sonication), dry ozonization (90D=dry ozone treated biochar for 90 minutes), wet ozonization (90W=wet ozone treated biochar for 90 minutes), and sonication in combination with wet ozonization (15S+90 W=15 minutes of sonication and 90 minutes wet ozone treated biochar). As shown in FIG. 20, wet biochar ozonization treatment along with sonication resulted in the highest DOC concentration (2413.3 ppm) and production yield (40.22 g/kg biochar).

As shown in the experimental data listed in Table 8, the sonication treatment of P400 biochar for 15 minutes (15S) alone resulted in 20.3 ppm of DOC produced in the biochar treatment liquid, which translates to the DOC production yield of 0.34 g per kg biochar. The dry sonication treatment of P400 biochar for 90 minutes (90D) resulted in 214.0 ppm of DOC produced in the biochar treatment liquid with a DOC production yield of 3.57 g/kg biochar. The wet ozonization of P400 biochar for 90 minutes (90W) resulted in 1389.1 ppm of DOC produced in the biochar treatment liquid, which is corresponding to the biochar-derived DOC production yield of 23.15 g/kg biochar. The biochar-derived DOC production yield from 15S+90 W (15-minutes sonication and 90-minutes wet ozonization of P400 biochar) was 40.22 g DOC/kg biochar, resulting in 2413.3 ppm of DOC which was the best in this example. These results demonstrated that the combination of sonication and ozonization is a highly effective method to produce biochar derived organic matters as measured with DOC concentration in the treatment liquid phase.

TABLE 8
Production of biochar derived organic matters from P400 biochar
through sonication and/or ozonization treatments, measured
as the yield and concentration of dissolved organic carbon
(DOC) produced in the biochar treatment liquid.

| | Concentration of | |
|---|---|---|
| | DOC produced in | DOC |
| | the biochar | Production |
| | treatment liquid | yield |
| Biochar Treatment | (ppm) | (g/kg biochar) |
| Sonicated for 15 minutes (15S) | 20.3 | 0.34 |
| Dry ozonized for 90 minutes (90D) | 214.0 | 3.57 |
| Wet ozonized for 90 minutes (90W) | 1389.1 | 23.15 |
| Sonicated for 15 minutes and wet | 2413.3 | 40.22 |
| ozonized for 90 minutes (15S + 90W) | | |

While the present invention has been illustrated by description of several embodiments and while the illustrative embodiments have been described in considerable detail, it is not the intention of the applicant to restrict or in any way limit the scope of the invention claims to such detail. Additional advantages and modifications will readily appear to those skilled in the art. Therefore, the invention in its broader aspects is not limited to the specific details, representative apparatus and methods, and illustrative examples shown and described. Accordingly, departures may be made from such details without departing from the spirit or scope of applicant's general inventive concept.

What is claimed is:

1. A systematic method for phosphorus sustainability, sand soilization and odor removal utilizing the phosphorus-unlocking and odor removing green chemistry of a surface-oxygenated biochar composition made through ozonization in combination with sonication, the method comprising:
treating a biochar source composition with sonication and an ozone-containing gas stream in a biochar sonication-ozonization treatment reactor system using a sonication-ozonization-enabled biochar-surface oxygenation operational process, wherein treating the source biochar composition comprises steps selected from the group consisting of:
a) contacting the source biochar with the ozone-containing gas stream;
b) enabling biochar-surface oxygenation;
c) destroying a potential biochar toxin;
d) producing a surface-oxygenated biochar composition having enhanced cation exchange capacity;
e) producing a special surface-oxygenated biochar composition for phosphorus solubilization from insoluble phosphate materials for producing phosphate fertilizers without using strong industrial acids;
f) producing a special surface-oxygenated biochar paste composition for sands soilization; and
g) producing a special surface-oxygenated biochar composition having an enhanced filtration property in methylene blue adsorption capability for removing at least one contaminant from a medium selected from the group consisting of water and air including odor removal.

2. The method of claim 1, wherein the biochar sonication-ozonization treatment reactor system comprises: a sonication-enhanced biochar ozonization treatment reactor system comprising
a sonication control unit which comprises an input end in contact with ultrasonic transducer and a sonication output head in contact with liquid in a biochar ozonization reactor chamber space,
a heat-conducting reactor inner wall,
a reactor outer wall,
a coolant chamber space formed between the inner wall and outer wall,
a coolant inlet connected with the coolant chamber space at the bottom part of the reactor, a hot coolant outlet connected with the coolant chamber space at the top part of the reactor,
an O₂ air inlet pump and valve,
an ozone generator system,
an ozone air inlet and tube passing through the biochar ozonization reactor out wall and inner wall near its bottom,
an ozone O₃/water space at the bottom of the reactor,
a porous metal plate,
a biochar sonication-ozonization reactor chamber space above the porous metal plate,
a biochar inlet passing through the biochar ozonization reactor double walls at the upper part of the reactor,
an O₃ bubble flowing from the O₃/water space at the bottom through the porous metal plate and the biochar materials toward the upper part of the reactor,
a tail gas vent valve and filter,
a flexible tail gas recycling tube equipped with a filter and a valve,
a pump and valve connected from the tail gas vent tube to the air inlet,
a heat-smoke-sensing sprinkler system equipped with water inlet,
a water liquid level at the upper part of the reactor,
an ozonized biochar outlet passing through the reactor double walls at the lower part of the reactor,
and a flexible water inlet and outlet valve at the bottom of the reactor.

3. The method of claim 1, wherein the sonication-ozonization-enabled biochar-surface oxygenation operational process comprises a liquid biochar sonication-ozonization treatment operational process comprises the following process steps that are operated in combination with the use of hydrogen peroxide in the reactor process:
a) loading biochar materials into a reactor through a biochar inlet;
b) monitoring and adjusting biochar temperature;
c) monitoring biochar water content and liquid level in the reactor;
d) based on a required biochar water content and liquid level, adding at least one of water, steam and vapor into the biochar materials using at least one of a heat-smoke-sensing sprinkler system with a water inlet and water spray system located at a top of the reactor and a flexible water inlet and outlet valve at a bottom of the reactor;
e) performing sonication using the sonication control unit which comprises an input end in contact with ultrasonic transducer and a sonication output head in contact with liquid in a biochar ozonization reactor chamber space;
f) pumping an oxygen-containing source gas stream through an ozone generator system to generate ozone;
g) feeding ozone-containing gas stream into a reactor chamber space through a porous metal plate above an ozone air space by controlling an air pump fan speed;
h) using a flexible inlet and outlet valve at the bottom of the reactor to introduce additional gas components into the treating gas stream to manipulate the biochar ozonization process;
i) using a flexible tail gas recycling tube having a filter and valve and pump and valve to re-use at least part of tail gas;
j) allowing sufficient time for the ozone-containing stream to diffuse through and interact with biochar particles while controlling and monitoring treatment conditions to oxygenate biochar surfaces and destroy potential biochar toxins by using ozone to react with C═C double bonds of biochar and its potential toxins;
k) discharging residual ozonized liquid at the bottom of the reactor through a flexible water inlet and outlet;
l) harvesting the ozonized biochar products through an ozonized biochar outlet using gravity.

4. The method of claim 1, wherein the biochar source comprises a carbon product or recalcitrant biomass material selected from the group consisting of charcoals from a slow biomass pyrolysis process, charcoals from a fast biomass pyrolysis process, biochar from flash pyrolysis of biomass including softwood chips with 35% water content, charcoals from a biomass gasification process, hydrochars from a biomass hydrothermal carbonization process, a material acquired from a biochar deposit, natural coal materials, lignin residues, lignin cellulosic materials, carboxymethyl cellulose, un-hydrolyzed biomass residues including un-hydrolyzed corn stover residues, recalcitrant biomass residues, and a combination thereof.

5. The method of claim 1, wherein enabling biochar-surface oxygenation and destroying the potential biochar toxin are accomplished simultaneously using sonication and an O₃-containing gas stream flowing through a biochar ozonization treatment reactor at ambient pressure and temperature.

6. The method of claim 5, wherein enabling the biochar-surface oxygenation comprises using ozone reacting with the C═C double bonds of biochar materials forming carbonyl and carboxyl groups on biochar surfaces while destroying the potential biochar toxin comprises using ozone reacting with the C═C double bonds of the potential biochar toxin.

7. The method of claim 6, wherein the potential biochar toxins comprise residual pyrolysis bio-oils, small organic molecules having a molecular mass of less than or equal to 500 Dalton, polycyclic aromatic hydrocarbons, degraded lignin-like species rich in oxygen containing functionalities, phenolic type of phytotoxins with at least one carboxyl group or combinations thereof.

8. The method of claim 1, wherein the surface-oxygenated biochar composition comprises the surface-oxygenated biochar paste product liquid for use as part of irrigation into the crop root zones so that it needs less a ton of biochar carbon material per acre to help solubilizing phosphorus from the insoluble phosphate material in certain soils for crop to uptake.

9. The method of claim 1, wherein treating the source biochar composition with sonication comprises using sonication to loosen and break up the biochar composition including exfoliating graphite-type biochar materials to produce graphene-type biochar molecules, using sonication to enhance mixing and mass transfer of ozone within the volume of water and biochar composition and using ultra sonication at a frequency of above 15 kHz to produce reactive oxygen radical, hydroxyl and peroxyl radicals from sonochemistry of O₂-dissolved water to enhance biochar composition surface oxygenation.

10. The method of claim 1, wherein the surface-oxygenated biochar composition is a biochar paste product that comprises surface-oxygenated biochar derived organic matters including humic-like substances that are selected from the group consisting of surface-oxygenated biochar particles, ozonized biochar-derived organic matters, surface-oxygenated amorphous carbon particles, surface-oxygenated graphite particles, partially oxygenated graphene, partially oxygenated graphene-like molecules, partially oxygenated graphene molecular fragments, partially oxygenated linear hydrocarbons, partially oxygenated aromatic compounds, partially oxygenated polycyclic aromatic hydrocarbons, dissolved organic carbons including organic acids, and combinations thereof.

11. The method of claim 1, wherein the said phosphorus-unlocking green chemistry of the surface-oxygenated biochar composition (Biochar-COOH) may be used to solubilize phosphorous from insoluble phosphate materials including hydroxyapatite and fluorapatite for phosphorous sustainability through a phosphorous solubilization reaction:
Ca₁₀(PO₄)₆(OH)₂+Biochar-COOH→HPO₄²⁻+Ca₉(PO₄)₅(OH)₂⁺+Biochar-(COOCa)⁺;
Wherein the phosphorous solubilization is through at least one of the following green chemistry molecular mechanisms of unlocking phosphorus from insoluble phosphate materials selected from the group consisting of:
a) Protonic effect including the effect of protons from the organic acid groups of ozonized biochar which can kick phosphate out of the insoluble phosphate materials, resulting in solubilized phosphate;
b) Cation exchange including the effect of calcium complexation with the deprotonated biochar carboxylate groups on biochar surfaces and/or biochar molecules and its associated dissolved organic acids that takes calcium away and thus thermodynamically favors the release of phosphate from the insoluble phosphate materials;
c) Anion exchange including the effect of anions comprising the deprotonated biochar carboxylate groups and its associated dissolved organic acids in exchange with the phosphate of the insoluble phosphate materials thus thermodynamically favors its phosphorus release;
and d) combinations thereof.

12. The method of claim 1, wherein the surface-oxygenated biochar composition may be used to mix with phosphate rock powders to make slow-releasing phosphorus and calcium fertilizers; wherein the content of phosphate rock powders in the mixture of phosphate rock powers and surface-oxygenated biochar is 0.00001%, 0.00005%, 0.0001%, 0.0005%, 0.001%, 0.005%, 0.01%, 0.05%, 0.1%, 0.2%, 0.5%, 1%, 2%, 3%, 4%, 5%, 6%, 7%, 8%, 9%, 10%, 12%, 15%, 20%, 25%, 30%, 35%, 40%, 45%, 50%, 55%, 60%, 65%, 70%, 75%, 80%, 85%, 90%, 95%, or 99% weight percent, or within a particular range therein.

13. The method of claim 1, wherein the surface-oxygenated biochar composition is applied into the root zones of agricultural soils to help solubilize the “insoluble” phosphate material there for crop plants to uptake using an application technique selected from the group consisting of: 1) mixing surface-oxygenated biochar with soils under wet and calm non-windy conditions during plowing of a field and/or tillage practices; 2) mixing and/or coating certain seeds comprising wheat, soybean, and peanuts with certain surface-oxygenated biochar so that the seeds and surface-oxygenated biochar are co-inserted into soil during sowing; 3) placing surface-oxygenated biochar into soil during planting of seedlings; 4) using surface-oxygenated biochar paste and/or liquid as an irrigation into the crop root zones; and combinations thereof.

14. The method of claim 1, wherein the surface-oxygenated biochar composition may help to enhance phosphorus availability for crop uptake by helping phosphorus solubilization from soil insoluble phosphate mineral phases comprising at least one of the “insoluble” phosphate materials selected from the group consisting of soil phosphate rock particles and mineral minerals (mostly apatites: Ca₁₀X(PO₄)₆, where X=F⁻, Cl⁻, OH⁻ or CO₃²⁻) from parent rocks; the various precipitated Ca-phosphates including Ca(H₂PO₄)₂.H₂O (monocalcium phosphate), CaHPO₄.2H₂O (dicalcium phosphate dihydrate=brushite), CaHPO₄ (dicalcium phosphate=monetite), Ca₈H₂(PO₄)₆.5H₂O (octacalcium phosphate), Ca₅(PO₄)₃OH (hydroxyapatite), and Ca₅(PO₄)₃F (fluoroapatite); precipitated Al- and Fe-phosphates including variscite (AlPO₄.2H₂O), strengite (FePO₄.2H₂O), and vivianite [(Fe₃(PO₄)₂.8H₂O)]; and combinations thereof.

15. The method of claim 1, wherein the phosphorus solubilization is accomplished by application of the surface-oxygenated biochar composition in various soils including certain alkaline soils, pH neutral soils and acidic soils through the effect selected from the group consisting of the protonic effect, cation exchange, anion exchange and combinations thereof.

16. The method of claim 1, wherein the surface-oxygenated biochar compositions including the biochar paste product may be used for sand soilization by their liquid gel-forming activity in the spaces among sand particles that can retain water and nutrients and hold the sand particles together through at least one of the following noncovalent interactions: 1) the ionic (Coulombic) interactions that are the electrostatic interactions between charged species; 2) the hydrogen bond effects of the surface-oxygenated biochar molecular species with water and sands; 3) the π-π interactions between aromatic structures; and 4) the van der Waals interactions among sands and surface-oxygenated biochar molecular species with water.

17. The method of claim 1, wherein sand soilization is through use of surface-oxygenated biochar molecular species that have at least two carboxyl groups per molecule (⁻COO—R—COO⁻) in combination with other biomass materials selected from the group consisting of lignin cellulosic materials, carboxymethyl cellulose, un-hydrolyzed biomass residues comprising un-hydrolyzed cornstover residues, lignin residues, recalcitrant biomass residues, humic substances, and combinations thereof; and in combination with certain cations selected from the group consisting of Ca²⁺, Mg²⁺, Fe²⁺, and Fe³⁺ can form the following type of ionic cross-linking structures that may create a type of jelly state to better retain water and nutrients and hold sands together:
2Sand-SiO⁻+⁻COO—R-COO⁻+Ca²⁺→Sand-SiO.Ca.COO—R—COO.Ca.SiO-Sand

18. The method of claim 1, wherein the surface-oxygenated biochar compositions contain certain amounts of beneficial humic acids-like substances including certain partially oxygenated dissolved organic carbons (DOC) that stimulate crop plant growth when used at a proper DOC concentration selected from the group consisting of: 0.1 ppm, 0.2 ppm, 0.5 ppm, 1 ppm, 2 ppm, 3 ppm, 5 ppm, 8 ppm 10 ppm, 12 ppm, 15 ppm, 20 ppm, 25 ppm, 30 ppm, 40 ppm, 50 ppm, 100 ppm, 200 ppm, 500 ppm, and 1000 ppm.

19. The method of claim 1, wherein the said phosphorus sustainability is enabled by utilization of surface-oxygenated biochar composition for phosphorus solubilization from soil insoluble phosphate mineral phases and by the use of surface-oxygenated biochar composition to mix with phosphate rock powders and ground soft rock phosphate to make slow-releasing phosphorus and calcium fertilizers with surface-oxygenated biochar.

20. The method of claim 1, wherein the said surface-oxygenated biochar compositions absorb the offensive odor from manures significantly better than conventional biochar, using a green chemistry where surface-oxygenated biochar absorbs the ammonia (NH₃) gas odor through its reaction with the biochar molecular carboxylic acid (Biochar-COOH) to form ammonium carboxylate on ozonized biochar surface (Biochar-COONH₄).
